(19) United States
(12) Patent Application Publication
(10) Pub. No.: US 2013/0244019 A1
(43) Pub. Date: Sep. 19, 2013

(54) CNT AGGREGATE AND LAYERED PRODUCT

(71) Applicant: NATIONAL INSTITUTE OF ADVANCED INDUSTRIAL SCIENCE AND TECHNOLOGY, Tokyo (JP)

(72) Inventors: Kenji HATA, Tsukuba-shi Ibaraki (JP); Don N. FUTABA, Tsukuba-shi Ibaraki (JP); Ming XU, Tsukuba-shi Ibaraki (JP)

(73) Assignee: National Institute of Advanced Industrial Science Technology, Tokyo (JP)

(21) Appl. No.: 13/759,211

(22) Filed: Feb. 5, 2013

Related U.S. Application Data
(63) Continuation of application No. PCT/JP2011/067958, filed on Aug. 5, 2011.

(30) Foreign Application Priority Data
Aug. 5, 2010 (JP) 2010-175976

(51) Int. Cl. F16F 7/01

(52) U.S. Cl. CPC F16F 7/01
USPC 428/312.2; 423/447.2

(57) ABSTRACT

A CNT aggregate formed from a plurality of CNT's is provided, the CNT aggregate having a storage modulus (G_{25° C.}′) at 25° C. obtained by a dynamic mechanical analysis in a 1 Hz frequency in shear-mode of 10⁴ Pa or more and 10⁹ Pa or less, a loss modulus (G_{25° C.}″) at 25° C. obtained by a dynamic mechanical analysis in a 1 Hz frequency in shear-mode of 10³ Pa or more and 10⁸ Pa or less, a damping ratio (tan δ(=G_{25° C.}″/G_{25° C.}′)) at 25° C. obtained by a dynamic mechanical analysis in a 1 Hz frequency in shear-mode of 10⁻³ or more and 1 or less, and a distribution maximum of a pore diameter calculated using a BJH method from an adsorption isotherm of liquid nitrogen of the CNT aggregate being 50 nm or less.

### CROSS REFERENCE TO RELATED APPLICATIONS

This application is based upon and claims the benefit of priority from the prior Japanese Patent Application No. 2010-175976, filed on Aug. 5, 2010 and PCT Application No. PCT/JP2011/067958, filed on Aug. 5, 2011, the entire contents of which are incorporated herein by reference.

### FIELD

The present invention is related to a viscoelastic material with excellent impact absorbing properties. In particular, the present invention is related to a CNT aggregate and a layered product which includes a carbon nanotube (referred to below as CNT) aggregate which shows stable viscoelasticity over a wide range of temperatures, a layered product and a method of manufacturing the same.

### BACKGROUND

A viscoelastic material is a component arranged with viscosity which dissipates energy and elasticity which reversibly deform. Generally, elasticity is generated by the binding of constituent elements of components and viscosity is generated by thermal motion of constituent elements. As an example, in the case of rubber which is a viscoelastic material, elasticity is generated from a linked chain macromolecules which form the rubber and viscosity is generated when chain parts between the linking points can move freely.

Movement of the chain parts in rubber which is formed from chain macromolecules becomes slow when at a low temperature and the viscoelasticity properties change. In particular, at a glass transition temperature or less all the parts change to a glass state where only thermal vibration is performed at that position and viscoelastic properties are lost. In addition, at a high temperature, molecule chains slide at linking points, the positions of molecule pairs move freely, fluidity increases and at higher temperatures the rubber melts. In this way, viscoelastic properties of a conventional viscoelastic material show a very large dependency on temperature, viscoelastic properties are lost at low and high temperatures. As a result, realization of a viscoelastic material which includes stability at higher temperatures and/or which shows viscoelastic properties at lower and higher temperatures is desired.

Silicon rubber is known to show comparatively stable viscoelasticity even at low and high temperatures with respect to general resin rubbers. For example, in Japanese Laid Open Patent H7-41603, a silica containing high damping rubber compound demonstrating high damping properties with a low elasticity temperature dependency is disclosed. In addition, in Japanese Laid Open Patent 2009-30016, a high damping rubber is disclosed with a low elasticity temperature dependency and demonstrating high damping performance even under large transformation by containing a certain amount of one or more types of softener selected from a group comprised of liquid rubber, paraffin oil and naphthene oil, carbon black, silica and silane compound.

In addition, in order to prevent a rapid drop in elasticity at high temperatures, a tire rubber composition is disclosed in Japanese Laid Open Patent 2009-46547 containing a large amount of CNTs in a diene rubber component and in which CNT dispersion is improved. In addition, in Japanese Laid Open Patent 2010-59303, a rubber composition is disclosed containing carbon nanofiber with a fiber diameter of 5˜40 nm, an aspect ratio of 150 or more and a graphitization degree of 8 or more with respect to the rubber component as a rubber composition having excellent thermal, electrical conductive properties, good reinforcement and destruction properties and good grip where used in a tire.

### SUMMARY

However, a rubber containing a silica rubber or CNTs as described above is only disclosed with respect to viscoelasticity in a range of −10° C. to 230° C. Viscoelasticity in a rubber which contains silica rubber or CNTs changes for the reasons described above at a low temperature below room temperature or a high temperature above room temperature and at lower and higher temperatures, the rubber melts, a glass phase transition is caused and viscoelastic properties significantly deteriorate.

The present invention provides a viscoelastic material which includes a CNT aggregate having the same properties of rubber or an elastomer. Furthermore, as another subject of the present invention, the present invention provides a CNT aggregate including a CNT aggregate showing similar properties as room temperatures even at higher and/or lower temperatures and excellent shock adsorption compared to a conventional silicon rubber or rubber containing CNTs.

According to one embodiment of the present invention, a CNT aggregate formed from a plurality of CNT's is provided, the CNT aggregate having (1) a storage modulus (G_{25° C.}′) at 25° C. obtained by a dynamic mechanical analysis in a 1 Hz frequency in shear-mode of 10⁴ Pa or more and 10⁹ Pa or less, (2) a loss modulus (G_{25° C.}″) at 25° C. obtained by a dynamic mechanical analysis in a 1 Hz frequency in shear-mode of 10³ Pa or more and 10⁸ Pa or less, (3) a damping ratio (tan δ(=G_{25° C.}″/G_{25° C.}′)) at 25° C. obtained by a dynamic mechanical analysis in a 1 Hz frequency in shear-mode of 10⁻³ or more and 1 or less, and (4) a distribution maximum of a pore diameter calculated using a BJH method from an adsorption isotherm of liquid nitrogen of the CNT aggregate being 50 nm or less.

In the CNT aggregate, a Herman orientation coefficient under a 100% shearing strain which may increase by 20% or more compared to a Herman orientation coefficient when no shearing strain is added.

In the CNT aggregate, a strain may have a roughly constant HOF in a shear strain region of 50% or more and 500% or less.

In the CNT aggregate, a part may have a Herman orientation coefficient of 0.01 or more and 0.4 or less.

In addition, according to one embodiment of the present invention a CNT aggregate formed from a plurality of CNT's is provided, the CNT aggregate including a pore diameter calculated using a BJH method from an adsorption isotherm of liquid nitrogen with a distribution maximum of 50 nm or less. the CNT aggregate including a storage modulus (G_{x° C.}′) existing in a temperature range of 100° C. or more and 1000° C. or less arranged with a ratio (G_{x° C.}′/G_{25° C.}′) of 0.75 or more and 1.5 or less between a storage modulus (G_{25° C.}′) at 25° C. obtained by a dynamic mechanical analysis in a 1 Hz frequency in shear-mode and a storage modulus (G_{x° C.}′) in a temperature range of 100° C. or more and 1000° C. or less, and a loss modulus (G_{x° C.}″) existing in a temperature range of 100° C. or more and 1000° C. or less arranged with a ratio (G_{x° C.}″/G_{25° C.}″) of 0.75 or more and 1.5 or less between a loss modulus (G_{25° C.}″) at 25° C. obtained by a dynamic mechanical analysis in a 1 Hz frequency in shear-mode and a loss modulus (G_{x° C.}″) in a temperature range of 100° C. or more and 1000° C. or less.

In the CNT aggregate, the ratio (G_{x° C.}′/G_{25° C.}′) and the ratio (G_{x° C.}″/G_{25° C.}″) may be 0.8 or more and 1.2 or less.

In the CNT aggregate, the ratio (G_{x° C.}′/G_{25° C.}′) and the ratio (G_{x° C.}″/G_{25° C.}″) may be 0.85 or more and 1.1 or less.

In the CNT aggregate, the storage modulus (G_{25° C.}′) at 25° C. obtained by a dynamic mechanical analysis in a 1 Hz frequency in shear-mode may be 10⁴ Pa or more and 10⁹ Pa or less.

In the CNT aggregate, the loss modulus (G_{25° C.}″) at 25° C. obtained by a dynamic mechanical analysis in a 1 Hz frequency in shear-mode may be 10³ Pa or more and 10⁸ Pa or less.

In the CNT aggregate, a part may have a Herman orientation coefficient of 0.01 or more and 0.4 or less.

In addition, according to an embodiment of the present invention, a CNT aggregate formed from a plurality of CNT's is provided, the CNT aggregate including a pore diameter calculated using a BJH method from an adsorption isotherm of liquid nitrogen with a distribution maximum of 50 nm or less, the CNT aggregate including a storage modulus (G_{x° C.}′) existing in a temperature range of −200° C. to 0° C. arranged with a ratio (G_{x° C.}′/G_{25° C.}′); 0.75 to 1.5 between a storage modulus (G_{25° C.}′) at 25° C. obtained by a dynamic mechanical analysis in a 1 Hz frequency in shear-mode and a storage modulus (G_{x° C.}′) in a temperature range of −200° C. to 0° C., and a loss modulus (G_{x° C.}″) existing in a temperature range of −200° C. to 0° C. arranged with a ratio (G_{x° C.}″/G_{25° C.}″); 0.75 to 1.5 between a loss modulus (G_{25° C.}″) at 25° C. obtained by a dynamic mechanical analysis in a 1 Hz frequency in shear-mode and a loss modulus (G_{x° C.}″) in a temperature range of −200° C. to 0° C.

In the CNT aggregate, the ratio (G_{x° C.}′/G_{25° C.}′) and the ratio (G_{x° C.}″/G_{25° C.}″) may be 0.8 or more and 1.2 or less.

In the CNT aggregate, the ratio (G_{x° C.}′/G_{25° C.}′) and the ratio (G_{x° C.}″/G_{25° C.}″) may be 0.85 or more and 1.1 or less.

In the CNT aggregate, the storage modulus (G_{25° C.}′) at 25° C. obtained by a dynamic mechanical analysis in a 1 Hz frequency in shear-mode may be 10⁴ Pa or more and 10⁹ Pa or less.

In the CNT aggregate, the loss modulus (G_{25° C.}″) at 25° C. obtained by a dynamic mechanical analysis in a 1 Hz frequency in shear-mode may be 10³ Pa or more and 10⁸ Pa or less.

The CNT aggregate, a part may have a Herman orientation coefficient of 0.01 or more and 0.4 or less.

In addition, it is possible to form a CNT aggregate by stacking a plurality of the CNT aggregates.

In addition, a layered product may include the CNT aggregate.

In addition, the layered product may be formed by arranging the CNT aggregate on a substrate.

The layered product may be formed by arranging the CNT aggregate on and below a substrate.

### BRIEF DESCRIPTION OF THE DRAWINGS

FIG. 1 (a) is an exemplary diagram showing an example of a CNT aggregate 100 related to the present invention and shows the CNT aggregate 100;

FIG. 1 (b) is an exemplary diagram showing an example of a CNT aggregate 100 related to the present invention and shows the CNT aggregate 100 formed by stacking the CNT aggregate 100 in a horizontal direction;

FIG. 1 (c) is an exemplary diagram showing an example of a CNT aggregate 100 related to the present invention and shows the CNT aggregate 100 formed by stacking the CNT aggregate 100 in a perpendicular direction;

FIG. 2 (a) is an exemplary diagram showing a layered product 200 related to the present invention and shows the layered product 200 formed by adhering the CNT aggregate 100 to a substrate 210;

FIG. 2 (b) is an exemplary diagram showing a layered product 200 related to the present invention and shows the layered product 200 formed by stacking the CNT aggregate 100 in a horizontal direction;

FIG. 2 (c) is an exemplary diagram showing a layered product 200 related to the present invention and shows the layered product 200 formed by arranging the CNT aggregate 100 on top of the substrate 210;

FIG. 2 (d) is an exemplary diagram showing a layered product 200 related to the present invention and shows the layered product 200 formed by arranging the CNT aggregate 100 on the top and bottom of the substrate 210;

FIG. 3 is a diagram which shows the preferred range of a ratio between a storage modulus G_{x° C.}′ existing at a certain temperature and a storage modulus G_{25° C.}′ at 25° C. of a CNT aggregate related to the present invention;

FIG. 4 is a diagram which shows the preferred range of a ratio between a loss modulus G_{x° C.}″ existing at a certain temperature and a loss modulus G_{25° C.}″ at 25° C. of a CNT aggregate related to the present invention;

FIG. 5 is a diagram which shows the preferred range of a ratio between a damping ratio tan δₓ(=G_{xC}″/G_{xC}′) existing at a certain temperature and a damping ratio tan δ_{25° C.} (=G_{25° C.}″/G_{25° C.}′) at 25° C. of a CNT aggregate related to the present invention;

FIG. 6 is a diagram which shows the preferred range of a ratio between a storage modulus G_{x° C.}′ existing at a certain temperature and a storage modulus G_{25° C.}′ at 25° C. of a CNT aggregate related to the present invention;

FIG. 7 is a diagram which shows the preferred range of a ratio between a loss modulus G_{x° C.}″ existing at a certain temperature and a loss modulus G_{25° C.}″ at 25° C. of a CNT aggregate related to the present invention;

FIG. 8 is a diagram which shows the preferred range of a ratio between a damping ratio tan δₓ(=G_{xC}″/G_{xC}′) existing at a certain temperature and a damping ratio tan δ_{25° C.} (=G_{25° C.}″/G_{25° C.}′) at 25° C. of a CNT aggregate related to the present invention;

FIG. 9 is a diagram which shows the preferred range of a ratio between a storage modulus G_{x° C.}′ existing at a certain temperature and a storage modulus G_{25° C.}′ at 25° C. of a CNT aggregate related to the present invention;

FIG. 10 is a diagram which shows the preferred range of a ratio between a loss modulus G_{x° C.}″ existing at a certain temperature and a loss modulus G_{25° C.}″ at 25° C. of a CNT aggregate related to the present invention;

FIG. 11 is a diagram which shows the preferred range of a ratio between a damping ratio tan δₓ(=G_{xC}″/G_{xC}′) existing at a certain temperature and a damping ratio tan δ_{25° C.} (=G_{25° C.}″/G_{25° C.}′) at 25° C. of a CNT aggregate related to the present invention;

FIG. 12 is a diagram which shows the preferred range of a ratio between a storage modulus G_{x° C.}′ existing at a certain temperature and a storage modulus G_{25° C.}′ at 25° C. of a CNT aggregate related to the present invention;

FIG. 13 is a diagram which shows the preferred range of a ratio between a loss modulus G_{x° C.}″ existing at a certain temperature and a loss modulus G_{25° C.}″ at 25° C. of a CNT aggregate related to the present invention;

FIG. 14 is a diagram which shows the preferred range of a ratio between a damping ratio tan δₓ(=G_{xC}″/G_{xC}′) existing at a certain temperature and a damping ratio tan δ_{25° C.} (=G_{25° C.}″/G_{25° C.}′) at 25° C. of a CNT aggregate related to the present invention;

FIG. 15 is a diagram which shows the preferred range of a ratio between a storage modulus G_{x Hz}′ existing at a certain temperature and a certain frequency range and a storage modulus G_{1 Hz}′ at 1 Hz of a CNT aggregate related to the present invention;

FIG. 16 is a diagram which shows the preferred range of a ratio between a loss modulus G_{x Hz}″ existing at a certain temperature and a certain frequency range and a loss modulus G_{1 Hz}″ at 1 Hz of a CNT aggregate related to the present invention;

FIG. 17 is a diagram which shows the preferred range of a ratio between a damping ratio tan δ_{x Hz}(=G_{x Hz}″/G_{x Hz}′) existing at a certain temperature and a certain frequency range and a damping ratio tan δ_{1 Hz} (=G_{1 Hz}″/G_{1 Hz}′) at 1 Hz of a CNT aggregate related to the present invention;

FIG. 18 is an exemplary diagram of a CNT aggregate 100 related to the present invention;

FIG. 19 is a scanning electron microscope (SEM) image of the CNT aggregate 100 related to the present invention;

FIG. 20 (a) is an SEM image when shear strain is added to the CNT aggregate 100;

FIG. 20 (b) is a diagram showing a Herman orientation coefficient;

FIG. 20 (c) is an exemplary diagram showing a change in structure between CNT's 30 due to each shear;

FIG. 20 (d) is a transmission electron microscope (TEM) image of the CNT 30 at 1000% shear strain;

FIG. 21 is a SEM image of the CNT aggregate 100 related to the present invention;

FIG. 22 is a 2-D Fast Fourier Transform (FFT) image of the CNT aggregate 100 related to the present invention;

FIG. 23 is a profile of an azimuth angle and diffraction strength with respect to the length of the CNT aggregate 100 related to the present invention;

FIG. 24 (a) is a TEM image of the CNT aggregate 100 related to the present embodiment of the present invention;

FIG. 24 (b) is an exemplary diagram showing an energy dissipation process which passes through an opening and closing of a contact region 35;

FIG. 24 (c) is an exemplary diagram showing an energy dissipation process;

FIG. 25 is an exemplary diagram of a CNT aggregate related to the present invention formed on a substrate;

FIG. 26 (a) is a diagram showing a TEM image of a CNT aggregate;

FIG. 26 (b) is a histogram of a diameter distribution of a CNT;

FIG. 26 (c) is a diagram showing relative figures between average diameter and the type of CNT;

FIG. 27 (a) is a diagram showing a photograph of a DMA test device;

FIG. 27 (b) is an exemplary diagram;

FIG. 28 is a diagram showing viscoelasticity properties calculated from a stress—strain relationship;

FIG. 29 (a) is a diagram showing quantity results of viscoelasticity properties of the CNT aggregate 100 and showing frequency dependence of a storage modulus, a loss modulus and a damping ratio of the CNT aggregate 100 at room temperature;

FIG. 29 (b) is a diagram showing strain dependence between the CNT aggregate 100 and silicon rubber at room temperature;

FIG. 29 (c) is a diagram showing a fatigue test of the CNT aggregate 100;

FIG. 29 (d) is a stress—strain curve of the fatigue test;

FIG. 30 (a) is a diagram showing invariance properties across an extremely wide temperature range and showing temperature dependence of a storage modulus, a loss modulus and a damping ratio of the CNT aggregate 100;

FIG. 30 (b) is an exemplary diagram of a shock test;

FIG. 30 (c) is a split image of a ball trajectory performed at −196° C., 25° C. and 1000° C., the upper part shows a SEM and the lower part shows a 3-D mapping of a laser microscope;

FIG. 31 (a) is a diagram showing viscoelasticity properties of a CNT aggregate 100 at temperature conditions of −140° C. or more and 600° C. or less and a frequency of 0.1 Hz or more and 100 Hz or less and shows a storage modulus;

FIG. 31 (b) is a diagram showing viscoelasticity properties of a CNT aggregate 100 at temperature conditions of −140° C. or more and 600° C. or less and a frequency of 0.1 Hz or more and 100 Hz or less and shows a loss modulus;

FIG. 31 (c) is a diagram showing viscoelasticity properties of a CNT aggregate 100 at temperature conditions of −140° C. or more and 600° C. or less and a frequency of 0.1 Hz or more and 100 Hz or less and shows a damping ratio;

FIG. 32 (a) is a diagram showing viscoelasticity properties of a CNT aggregate 100 at temperature conditions of −140° C. or more and 600° C. or less and a strain of 1% or more and 1000% or less and shows a storage modulus;

FIG. 32 (b) is a diagram showing viscoelasticity properties of a CNT aggregate 100 at temperature conditions of −140° C. or more and 600° C. or less and a strain of 1% or more and 1000% or less and shows a loss modulus;

FIG. 32 (c) is a diagram showing viscoelasticity properties of a CNT aggregate 100 at temperature conditions of −140° C. or more and 600° C. or less and a strain of 1% or more and 1000% or less and shows a damping ratio;

FIG. 33 (a) is a diagram showing a vibration insulation device;

FIG. 33 (b) is a diagram showing a testing device of the CNT aggregate 100;

FIG. 34 (a) is a diagram showing the appearance of a vibration experiment and shows the appearance of the vibration insulation device when double sided tape is used;

FIG. 34 (b) is a diagram showing the appearance of a vibration experiment and shows the appearance of the vibration insulation device when the CNT aggregate 100 is used;

FIG. 34 (c) is a diagram showing the appearance of a vibration experiment and shows the appearance of the vibration insulation device when silicon rubber is used;

FIG. 35 (a) shows the appearance of a vibration experiment and shows experiment results at −190° C.;

FIG. 35 (b) shows the appearance of a vibration experiment and shows experiment results at 900° C.;

FIG. 36 is a diagram showing a storage modulus and stress;

FIG. 37 (a) is a diagram showing a cyclic test and structure observation at a large strain vibration and showing viscoelasticity properties of the CNT aggregate 100 at 20% strain and a stress—strain curve at variant cycles;

FIG. 37 (b) is a diagram showing viscoelasticity properties of the CNT aggregate 100 at 100% strain and a stress—strain curve at variant cycles;

FIG. 37 (c) shows viscoelasticity of the CNT aggregate 100 at a strain of 100%;

FIG. 37 (d) shows a stress—strain curve of a the CNT aggregate at different cycles at a strain of 100%;

FIG. 38 (a) is a diagram showing a cyclic test and structure observation at a large strain vibration and showing a SEM image of the CNT aggregate 100 at the first cycle and 1000^{th} cycle at 20% strain;

FIG. 38 (b) is a SEM image of the CNT aggregate 100 at the first cycle and 1000^{th} cycle at 100% strain;

FIG. 39 (a) is a diagram showing the results of repeated testing at 1% strain, 100 Hz and 10⁶ cycles and shows the results at −140° C.;

FIG. 39 (b) is a diagram showing the results of repeated testing at 1% strain, 100 Hz and 10⁶ cycles and shows the results at 25° C.;

FIG. 39 (c) is a diagram showing the results of repeated testing at 1% strain, 100 Hz and 10⁶ cycles and shows the results at 600° C.;

FIG. 39 (d) is a diagram showing the results of repeated testing at 1% strain, 100 Hz and 10⁶ cycles and shows a stress-strain curve of a fatigue durability test at the 10^{2th} cycle, 10^{4th} cycleand 10^{6th} cycle at −140° C.;

FIG. 39 (e) is a diagram showing the results of repeated testing at 1% strain, 100 Hz and 10⁶ cycles and shows a stress-strain curve of a fatigue durability test at the 10²th cycle, 10^{4th} cycle and 10^{6th} cycle at 25° C.;

FIG. 39 (f) is a diagram showing the results of repeated testing at 1% strain, 100 Hz and 10⁶ cycles and shows a stress-strain curve of a fatigue durability test at the 10²th cycle, 10^{4th} cycle and 10^{6th} cycle at 600° C.;

FIG. 40 (a) is a diagram showing a microstructure of the CNT aggregate 100 before a fatigue durability test and after 10⁶ cycles and shows an SEM image of the CNT aggregate 100 before the fatigue durability test;

FIG. 40 (b) is a diagram showing a microstructure of the CNT aggregate 100 before a fatigue durability test and after 10⁶ cycles and shows an SEM image of the CNT aggregate 100 after 10⁶ cycles at −140° C.;

FIG. 40 (c) is a diagram showing a microstructure of the CNT aggregate 100 before a fatigue durability test and after 10⁶ cycles and shows an SEM image of the CNT aggregate 100 after 10⁶ cycles at 25° C.;

FIG. 40 (d) is a diagram showing a microstructure of the CNT aggregate 100 before a fatigue durability test and after 10⁶ cycles and shows an SEM image of the CNT aggregate 100 after 10⁶ cycles at 600° C.;

FIG. 40 (e) is a diagram showing a microstructure of the CNT aggregate 100 before a fatigue durability test and after 10⁶ cycles and shows a calculation value of a Herman orientation coefficient before the fatigue durability test and after 10⁶ cycles at each temperature;

FIG. 41 (a) is a diagram showing a removable contact region measured from a TEM observation of a structure and shows a TEM image of the CNT aggregate 100 showing the removable contact region;

FIG. 41 (b) is an exemplary diagram showing an alignment relationship between a contact region and strain;

FIG. 41 (c) is a photograph of a CNT assembly in a grown state;

FIG. 41 (d) is an exemplary diagram of each CNT structure;

FIG. 42 is a diagram showing a Raman spectrum of the CNT aggregate 100;

FIG. 43 (a) is a diagram showing stress/strain behavior of the CNT aggregate 100 related to the present embodiment;

FIG. 43 (b) is a diagram showing stress/strain behavior of a CNT aligned aggregate;

FIG. 43 (c) is a diagram showing stress/strain behavior of a CNT aggregate 100 related to the present embodiment; and

FIG. 44 is a diagram showing stress/strain behavior of a CNT aggregate 100 and silicon rubber related to the present embodiment.

### DESCRIPTION OF EMBODIMENTS

The present invention realizes a viscoelastic material including the same properties as a rubber or an elastomer at room temperature even at a high and/or low temperature using a CNT aggregate or more preferably a CNT aggregate having viscoelasticity. Viscoelasticity in the present invention indicates properties having both viscosity and elasticity. Viscoelasticity can be evaluated by dynamic mechanical analysis (DMA) for example. A measurement of viscoelasticity by dynamic mechanical analysis (DMA) includes providing strain which vibrates at a certain frequency such as expressed by a trigonometric function or sine wave and measuring the response (stress). In the case of a completely elastic material, stress is generated immediately (without a phase misalignment) with respect to a vibrating strain. In the case of a viscous material (Newtonian fluid), misaligned (phase angle of 90 degrees) stress is generated with respect to a vibrating strain. A viscoelastic material displays behavior between a completely elasticity material and a viscous material whereby stress is generated with a phase misalignment of δ (0<δ<90). It is possible to evaluate the size of elasticity and viscosity of a viscoelastic material from this phase δ. Viscoelasticity in the present invention has a more preferable phase of δ (5<δ<85).

A storage modulus G′ is defined from stress equivalent to an ideal elastic material and a loss modulus G″ is defined from stress equivalent to a viscous material. A damping ratio tan δ is provided by a ratio (G″/G′) between a loss modulus G″ and a storage modulus G′. In the present specification, unless otherwise noted, storage modulus G′, viscosity, loss modulus G″ and damping ratio tan δ are measured by dynamic mechanical analysis providing 0.5N or stress in a vertical direction with a strain amount of 1% at a shear strain mode (twisted shear strain) of 1 Hz frequency. In addition, it is possible to measure temperature dependency and frequency dependency of each of these.

Tension, compression, dual cantilever bending, three point bending or shearing are examples of a DMA modified mode and any can be selected according to the shape of the test sample or elastic modulus or the aim of the measurement. A shear mode, in particular a twist shear mode is preferably used.

In the present specification, a CNT aggregate includes a plurality of CNT's, at least one or more contact points (contact regions) between different CNT's, and pores for allowing the contact points (contact regions) and CNT's to move and transform. The CNT aggregate related to the present invention may be formed just from CNT's. However, the CNT aggregate may contain an inorganic material such as metal, ceramic or a porous material or an organic material depending on the purpose. However, a certain amount of leeway or space for contact points (contact regions) to move or transform between different CNT's is required as described below in order to provide the CNT aggregate of the present invention with viscoelasticity. That is, it is preferred that the CNTS aggregate includes pores. It is preferred that a material which compounds with the CNTs includes heat resistance in order to use the CNT aggregate at a high and/or low temperature. Providing heat resistance means that a material does not melt, evaporate or cause glass phase transition at a desired temperature. The CNT aggregate of the present invention may be in a powder state or a composite state such as a compound. A film or membrane state is preferred for ease of adhesion.

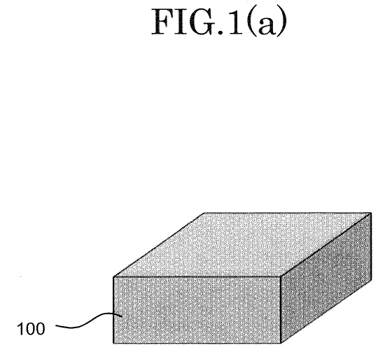

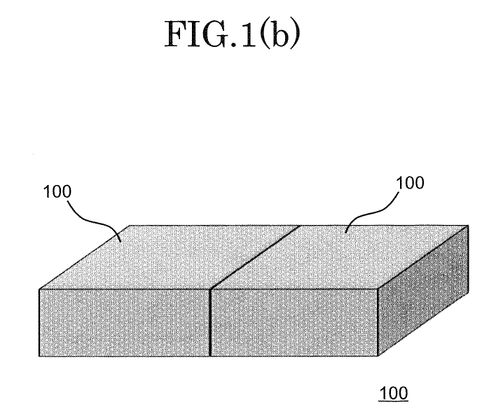

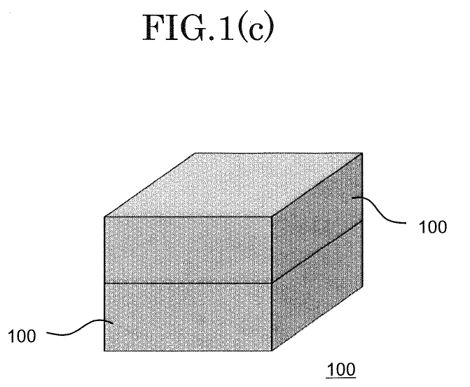

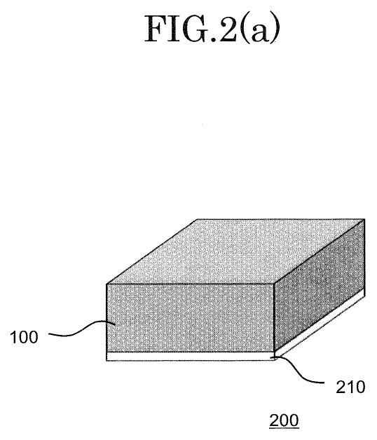

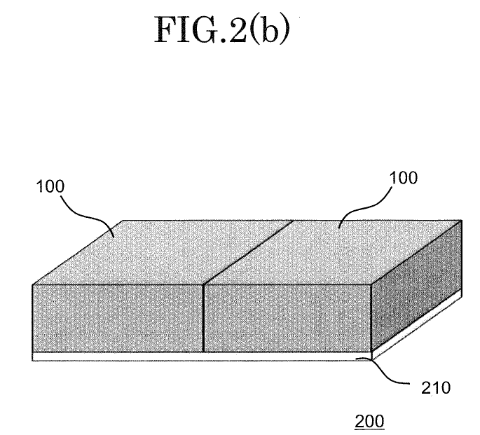

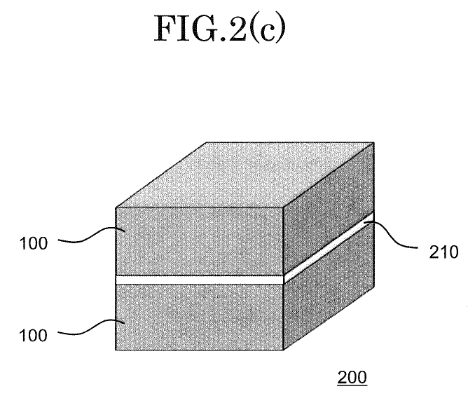

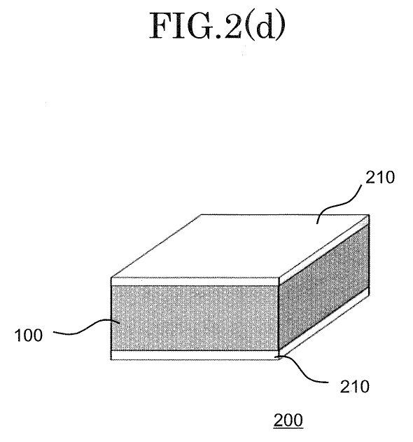

In the present specification, the CNT aggregate (referred to below as CNT aggregate 100) may be formed just by the CNT aggregate itself or by stacking CNT aggregates. The shape, materials and adhesion method of the CNT aggregate may be any appropriate form as long as at least one part of the CNT aggregate demonstrates viscoelasticity. As is shown in FIG. 1, the CNT aggregate may be formed by stacking a plurality of CNT aggregates in a horizontal direction (FIG. 1 (b)) or perpendicular direction (FIG. 1 (c)). In addition, as is shown in FIG. 2, the CNT aggregate 100 may be used as a layered product 200 by arranging on a substrate 210, for example, by arranging the CNT aggregate 100 on the upper part surface of the substrate 210 (FIG. 2 (a)) or by inserting the CNT aggregate 100 between the two substrates 210 (FIG. 2 (d)). One or a plurality of CNT aggregates 100 may be adhered to the substrate 210. A plurality of CNT aggregates 100 may also be arranged on the substrate 210 (FIG. 2 (b)) or on the top and bottom of the substrate 210 (FIG. 2 (c)). The substrate 210 may be curved or flexible in addition to a planar shape and may be any thickness. The material of the substrate 210 may be various metals, ceramics, silicon, resin or inorganic material.

A CNT has a cylindrical shape by winding one sheet surface of graphite and one wound layer is called a single layer CNT, two wound layers is called a double layer CNT and multiple wound layers is called a multi-layer CNT. However, it is preferred that the CNT aggregate of the present invention includes a one to three layered CNT. A CNT having one to three layers is preferred since there are less defects, there is better mechanical strength in a diameter direction and excellent elastic properties can be obtained compared to a CNT having more than layers than this. In addition, since a CNT with one two three layers has a comparatively small diameter it is possible to easily form a contact region and provide the CNT with excellent viscosity. The CNT aggregate related to the present invention is not limited to a CNT having one to three layers and may have four or more layers as long as viscoelastic properties are obtained.

### (Viscoelasticity at Room Temperature)

A storage modulus G′ of the CNT aggregate of the present invention can be within various ranges according to necessity. For example, a storage modulus G′ of the CNT of the present invention measured at 25° C. using a dynamic mechanical analysis with a shear mode of 1 Hz frequency may take a value between 10⁴ Pa or more and 10⁹ Pa or less. The storage modulus G′ of the CNT aggregate is preferred to be 5×10⁴ Pa or more and 5×10⁸ Pa or less, more preferably 10⁵ Pa or more and 10⁸ Pa or less and still more preferably 2×10⁵ Pa or more and 5×10⁷ Pa or less. A CNT aggregate having this storage modulus includes the same rigidity as rubber or an elastomer and is suited for use as a viscoelastic material.

A loss modulus G″ of the mass CNT aggregate of the present invention can be within various ranges according to necessity. For example, a loss modulus G″ of the mass CNT of the present invention measured at 25° C. using a dynamic mechanical analysis with a shear mode of 1 Hz frequency may take a value between 10³ Pa or more and 10⁸ Pa or less. The loss modulus G″ of the CNT aggregate is preferred to be 5×10³ Pa or more and 5×10⁷ Pa or less, more preferably 10⁴ Pa or more and 10⁷ Pa or less and still more preferably 2×10⁴ Pa or more and 5×10⁶ Pa or less. A CNT aggregate having this loss modulus includes the same flexibility as rubber or an elastomer and is suited for use as a viscoelastic material.

A damping ratio tan δ (=G″/G′) of the mass CNT aggregate of the present invention which is ratio between a storage modulus G′ and a loss modulus G″ can be within various ranges according to necessity. For example, the damping ratio tan δ (=G″/G′) of the mass CNT of the present invention measured at 25° C. using a dynamic mechanical analysis with a shear mode of 1 Hz frequency may take a value between 10⁻³ or more and 1 or less. The damping ratio tan δ (=G″/G′) of the CNT aggregate is preferred to be 2×10⁻³ or more and 0.9 or less, more preferably 5×10⁻³ or more and 0.8 or less and still more preferably 1×10⁻² or more and 0.7 or less or more preferably 2×10⁻² or more and 0.6 or less. A CNT aggregate having this damping ratio includes the same energy dissipation capability as rubber or an elastomer and is suited for use as a viscoelastic material.

### (Viscoelasticity at High Temperature)

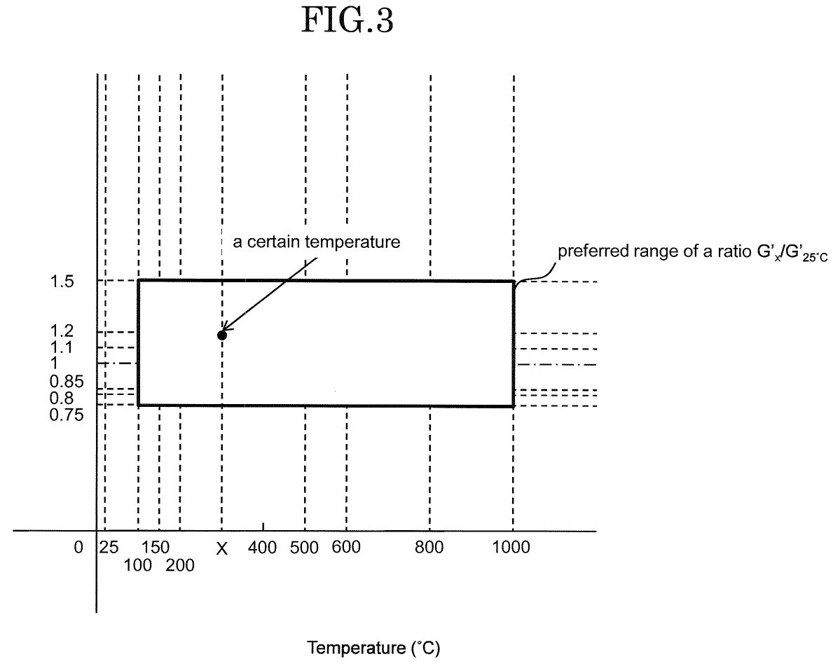

The CNT aggregate of the present invention includes the same properties as rubber or an elastomer even at a high temperature and displays excellent viscoelasticity. That is, in the CNT aggregate of the present invention, a ratio between a storage modulus G_{x° C.}′ at a certain temperature higher than 25° C. and a storage modulus G_{25° C.}′ at 25° C. measured using a dynamic mechanical analysis with a shear mode, is preferred to take a value in a range of 0.75 or more and 1.5 or less, more preferably 0.8 or more and 1.2 or less and still more preferably 0.85 or more and 1.1 or less. Here, a certain temperature is preferred to exist in a temperature range of 100° C. or more and 1000° C. or less, more preferably 150° C. or more and 800° C. or less, still more preferably 200° C. or more and 600° C. or less and still more preferably 200° C. or more and 500° C. or less. A CNT aggregate having this storage modulus at a high temperature includes the same rigidity as a rubber or an elastomer at room temperature and is suited for use as a viscoelastic material at a high temperature. All of the above is summarized in FIG. 3. FIG. 3 is a diagram which shows a desired range of a ratio between a storage modulus G_{x° C.′ at a certain temperature and a storage modulus G}_{25° C.}′ at 25° C. of the CNT aggregate related to the present invention. In FIG. 3, the desired range of the CNT aggregate related to the present invention is shown by a rectangle.

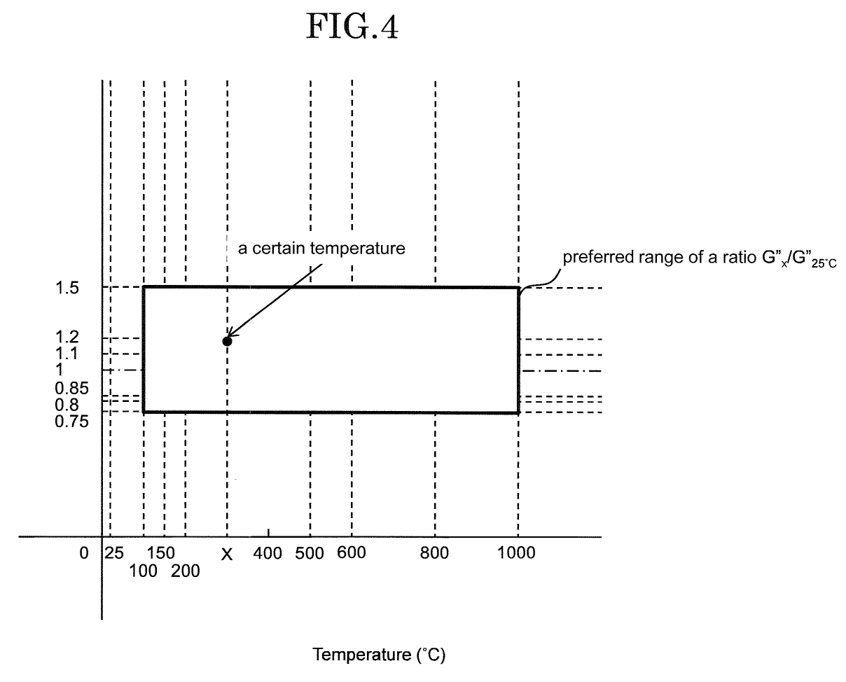

In the CNT aggregate of the present invention, a ratio between a loss modulus G_{x° C.}″ at a certain temperature higher than 25° C. and a loss modulus G_{25° C.}″ at 25° C. measured using a dynamic mechanical analysis with a shear mode, is preferred to take a value in a range of 0.75 or more and 1.5 or less, more preferably 0.8 or more and 1.2 or less and still more preferably 0.85 or more and 1.1 or less. Here, a certain temperature is preferred to exist in a temperature range of 100° C. or more and 1000° C. or less, more preferably 150° C. or more and 800° C. or less, still more preferably 200° C. or more and 600° C. or less and still more preferably 200° C. or more and 500° C. or less. A CNT aggregate having this loss modulus at a high temperature includes the same flexibility as a rubber or an elastomer at room temperature and is suited for use as a viscoelastic material at a high temperature. All of the above is summarized in FIG. 4. FIG. 4 is a diagram which shows a desired range of a ratio between a loss modulus G_{x° C.}″ at a certain temperature and a loss modulus G_{25° C.}″ at 25° C. of the CNT aggregate related to the present invention. In FIG. 4, the desired range of the CNT aggregate related to the present invention is shown by a rectangle.

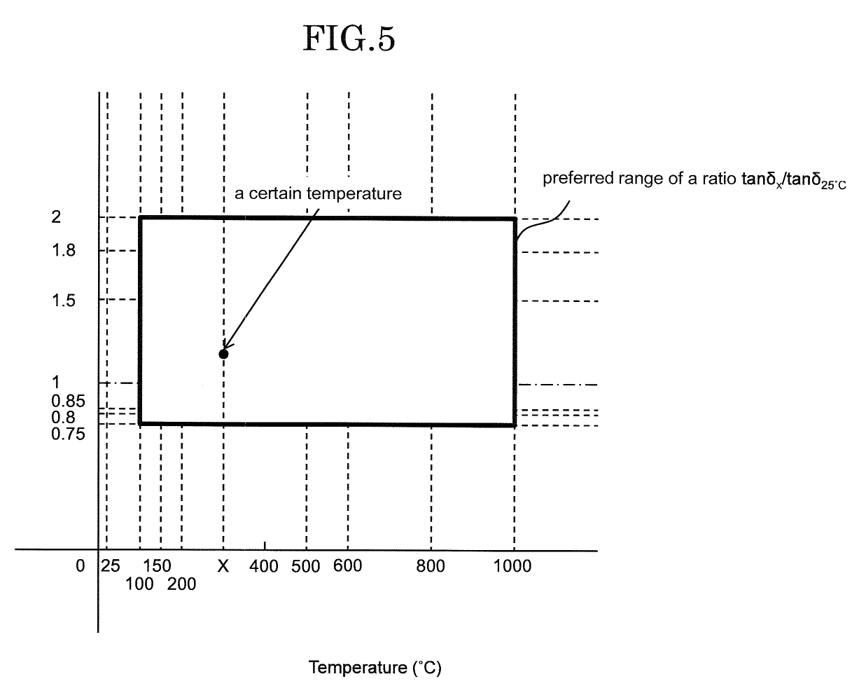

In the CNT aggregate of the present invention, a ratio between a damping ratio tan δ_{x° C.} (=G_{x° C.}″/G_{x° C.}′) at a certain temperature higher than 25° C. and a damping ratio tan δ_{25° C.} (=G_{25° C.}″/G_{25° C.}′) at 25° C. measured using a dynamic mechanical analysis with a shear mode, is preferred to take a value in a range of 0.75 or more and 2 or less, more preferably 0.8 or more and 1.8 or less and still more preferably 0.85 or more and 1.5 or less. Here, a certain temperature is preferred to exist in a temperature range of 100° C. or more and 1000° C. or less, more preferably 150° C. or more and 800° C. or less, still more preferably 200° C. or more and 600° C. or less and still more preferably 200° C. or more and 500° C. or less. A CNT aggregate having this damping ratio includes the same energy dissipation capacity as a rubber or an elastomer at room temperature and is suited for use as a viscoelastic material at a high temperature. All of the above is summarized in FIG. 5. FIG. 5 is a diagram which shows a desired range of a ratio between a damping ratio tan δ_{x° C.} (=G_{x° C.}″/G_{x° C.}′) at a certain temperature and a damping ratio tan δ_{25° C.} (=G_{25° C.}″/G_{25° C.}′) at 25° C. of the CNT aggregate related to the present invention. In FIG. 5, the desired range of the CNT aggregate related to the present invention is shown by a rectangle.

In this way, a CNT aggregate having a storage modulus G′, a loss modulus G″ and a damping ratio tan δ the same as a rubber or an elastomer at a high temperature has not existed until now and is first obtained in the present invention. A CNT aggregate which includes the same properties as a rubber or an elastomer at a high temperature and displays excellent viscoelasticity can be favorably used as a viscoelastic material at a high temperature.

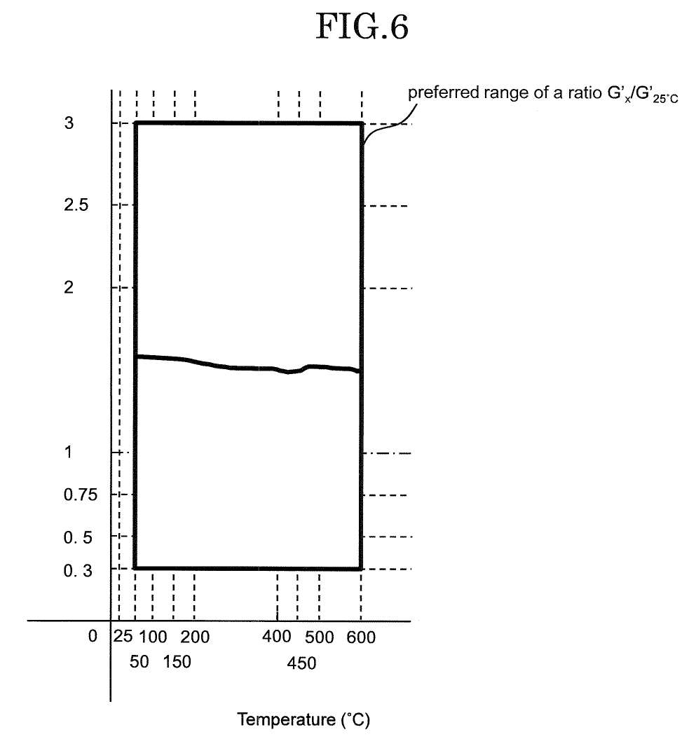

In the CNT aggregate of the present invention, a ratio between a storage modulus G_{x° C.} in a certain temperature range higher than 25° C. and a storage modulus G_{25° C.}′ at 25° C. measured using a dynamic mechanical analysis with a shear mode, is preferred to take a value in a range of 0.3 or more and 3 or less, more preferably 0.5 or more and 2.5 or less and still more preferably 0.75 or more and 2 or less. Here, a certain temperature is preferred to exist in a temperature range of 200° C. or more and 400° C. or less, more preferably 150° C. or more and 450° C. or less, still more preferably 100° C. or more and 500° C. or less and still more preferably 50° C. or more and 600° C. or less. A CNT aggregate having a storage modulus the same as room temperature at a high temperature range includes the same rigidity as at room temperature and is suited for use as a viscoelastic material at a high temperature. All of the above is summarized in FIG. 6. FIG. 6 is a diagram which shows a desired range of a ratio between a storage modulus G_{x° C.}′ at a certain temperature and a storage modulus G_{25° C.}′ at 25° C. of the CNT aggregate related to the present invention. In FIG. 6, the desired range of the CNT aggregate related to the present invention is shown by a rectangle.

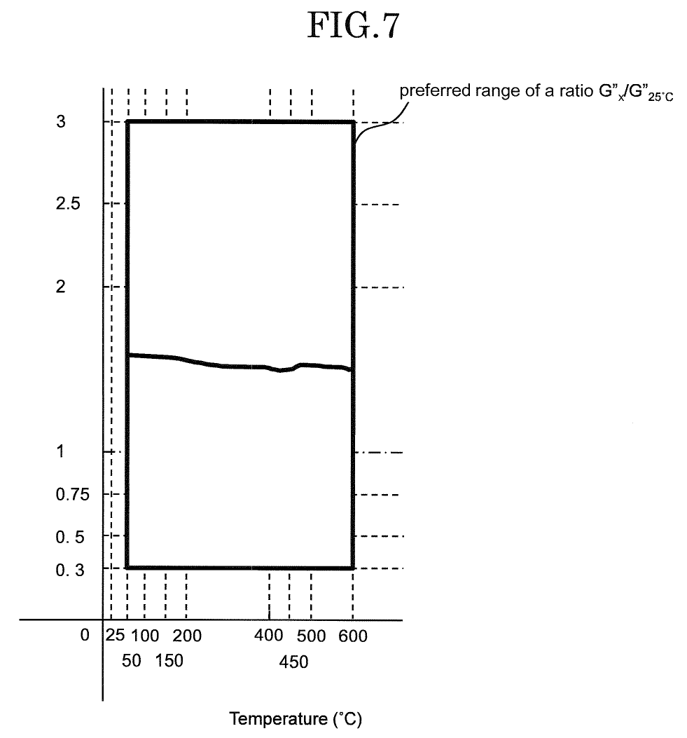

In the CNT aggregate of the present invention, a ratio between a loss modulus G_{x° C.}″ in a certain temperature range higher than 25° C. and a loss modulus G_{25° C.}″ at 25° C. measured using a dynamic mechanical analysis with a shear mode, is preferred to take a value in a range of 0.3 or more and 3 or less, more preferably 0.5 or more and 2.5 or less and still more preferably 0.75 or more and 2 or less. Here, a certain temperature is preferred to exist in a temperature range of 200° C. or more and 400° C. or less, more preferably 150° C. or more and 450° C. or less, still more preferably 100° C. or more and 500° C. or less and still more preferably 50° C. or more and 600° C. or less. A CNT aggregate having a loss modulus the same as room temperature at a high temperature range includes the same flexibility as at room temperature and is suited for use as a viscoelastic material at a high temperature. All of the above is summarized in FIG. 7. FIG. 7 is a diagram which shows a desired range of a ratio between a loss modulus G_{x° C.}″ at a certain temperature and a loss modulus G_{25° C.}″ at 25° C. of the CNT aggregate related to the present invention. In FIG. 7, the desired range of the CNT aggregate related to the present invention is shown by a rectangle.

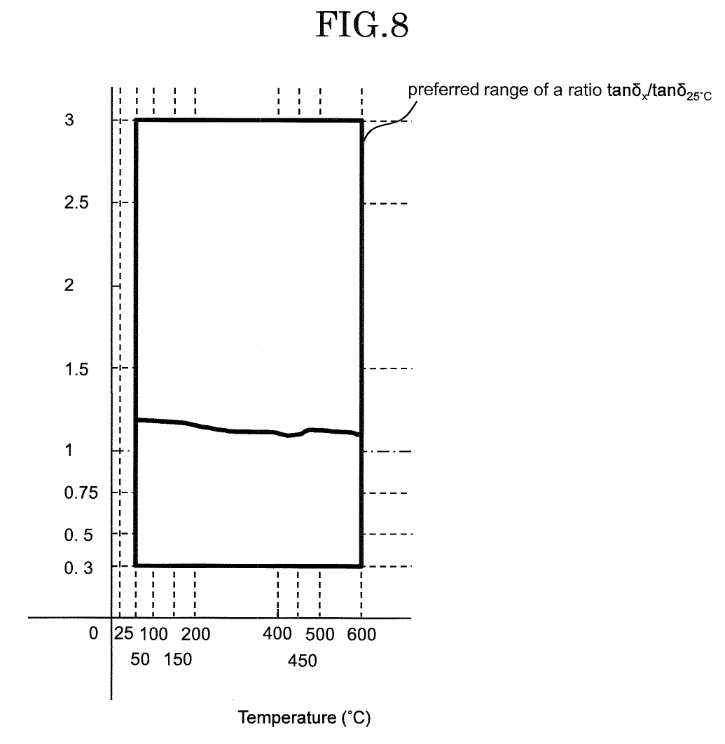

In the CNT aggregate of the present invention, a ratio between a damping ratio tan δ_{x° C.} (=G_{x° C.}″/G_{x° C.}′) in a certain temperature range higher than 25° C. and a damping ratio tan δ_{25° C.} (=G_{25° C.}″/G_{25° C.}′) at 25° C. measured using a dynamic mechanical analysis with a shear mode, is preferred to take a value in a range of 0.3 or more and 3 or less, more preferably 0.5 or more and 2.5 or less and still more preferably 0.75 or more and 1.5 or less. Here, a certain temperature is preferred to exist in a temperature range of 200° C. or more and 400° C. or less, more preferably 150° C. or more and 450° C. or less, still more preferably 100° C. or more and 500° C. or less and still more preferably 50° C. or more and 600° C. or less. A CNT aggregate having this damping ratio the same as room temperature at a high temperature range includes the same energy dissipation capacity at room temperature and is suited for use as a viscoelastic material at a high temperature. All of the above is summarized in FIG. 8. FIG. 8 is a diagram which shows a desired range of a ratio between a damping ratio tan δ_{x° C.} (=G_{x° C.}″/G_{x° C.}′) at a certain temperature and a damping ratio tan δ_{25° C.} (=G_{25° C.}″/G_{25° C.}′) at 25° C. of the CNT aggregate related to the present invention. In FIG. 8, the desired range of the CNT aggregate related to the present invention is shown by a rectangle.

In this way, a CNT aggregate having a storage modulus G′, a loss modulus G″ and a damping ratio tan δ the same as room temperature at a high temperature has not existed until now and is first obtained in the present invention. A viscoelastic material CNT aggregate which displays the same viscoelasticity as room temperature at a high temperature can be favorably used as a viscoelastic material at a high temperature.

### (Viscoelasticity at Low Temperature)

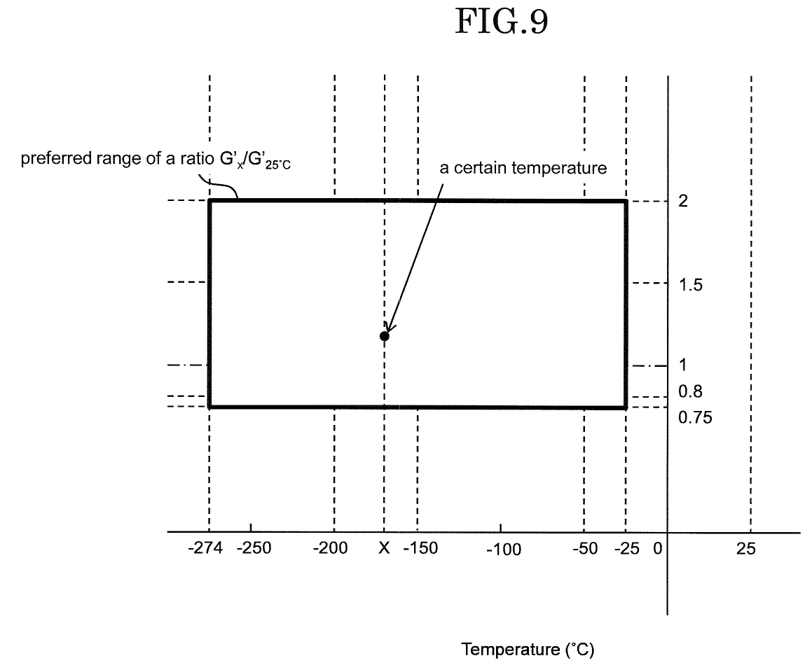

The CNT aggregate of the present invention includes the same properties as rubber or an elastomer even at a temperature lower than room temperature and displays excellent viscoelasticity. That is, in the CNT aggregate of the present invention, a ratio between a storage modulus G_{x° C.}′ at a certain temperature lower than 25° C. and a storage modulus G_{25° C.}′ at 25° C. measured using a dynamic mechanical analysis with a shear mode, is preferred to take a value in a range of 0.75 or more and 2 or less and more preferably 0.8 or more and 1.5 or less. Here, a certain temperature is preferred to exist in a temperature range of −274° C. or more and −25° C. or less, more preferably −200° C. or more and −25° C. or less and still more preferably −150° C. or more and −50° C. or less. A CNT aggregate having this storage modulus at a low temperature includes the same rigidity as a rubber or an elastomer at room temperature and is suited for use as a viscoelastic material at a low temperature. All of the above is summarized in FIG. 9. FIG. 9 is a diagram which shows a desired range of a ratio between a storage modulus G_{x° C.}′ at a certain temperature and a storage modulus G_{25° C.′ at} 25° C. of the CNT aggregate related to the present invention. In FIG. 9, the desired range of the CNT aggregate related to the present invention is shown by a rectangle.

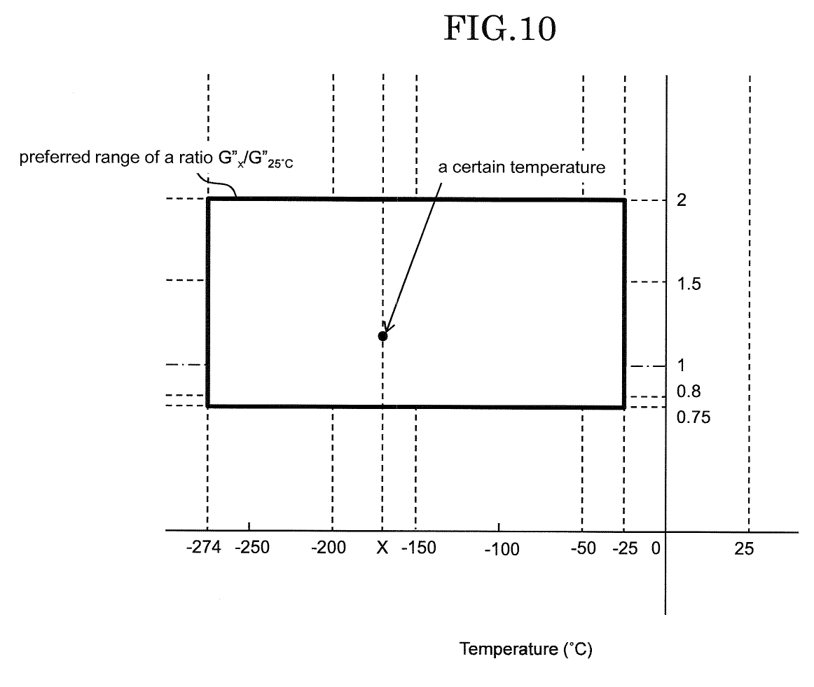

In the CNT aggregate of the present invention, a ratio between a loss modulus G_{x° C.}″ at a certain temperature lower than 25° C. and a loss modulus G_{25° C.}″ at 25° C. measured using a dynamic mechanical analysis with a shear mode, is preferred to take a value in a range of 0.75 or more and 2 or less and more preferably 0.8 or more and 1.5 or less. Here, a certain temperature is preferred to exist in a temperature range of −274° C. or more and −25° C. or less, more preferably −200° C. or more and −25° C. or less and still more preferably −150° C. or more and −50° C. or less. A CNT aggregate having this loss modulus at a low temperature includes the same flexibility as a rubber or an elastomer at room temperature and is suited for use as a viscoelastic material at a low temperature. All of the above is summarized in FIG. 10. FIG. 10 is a diagram which shows a desired range of a ratio between a loss modulus G_{x° C.}″ at a certain temperature and a loss modulus G_{25° C.}″ at 25° C. of the CNT aggregate related to the present invention. In FIG. 10, the desired range of the CNT aggregate related to the present invention is shown by a rectangle.

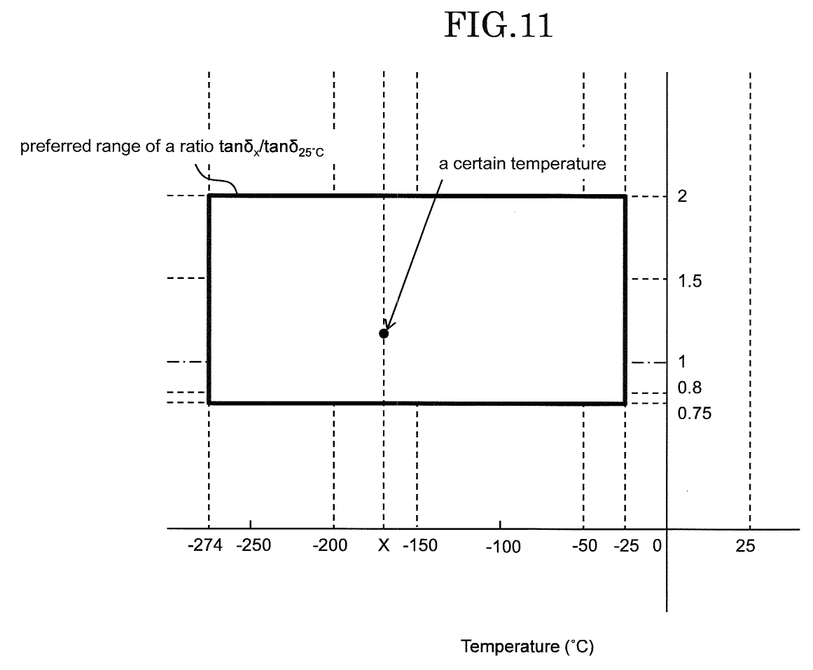

In the CNT aggregate of the present invention, a ratio between a damping ratio tan δ_{x° C.} (=G_{x° C.}″/G_{x° C.}′) at a certain temperature lower than 25° C. and a damping ratio tan δ_{25° C.} (=G_{25° C.}″/G_{25° C.}′) at 25° C. measured using a dynamic mechanical analysis with a shear mode, is preferred to take a value in a range of 0.75 or more and 2 or less and more preferably 0.8 or more and 1.5. Here, a certain temperature is preferred to exist in a temperature range of −274° C. or more and −25° C. or less, more preferably −200° C. or more and −25° C. or less and still more preferably −150° C. or more and −50° C. or less. A CNT aggregate having this damping ratio at a low temperature includes the same energy dissipation capacity as a rubber or an elastomer at room temperature and is suited for use as a viscoelastic material at a high temperature. All of the above is summarized in FIG. 11. FIG. 11 is a diagram which shows a desired range of a ratio between a damping ratio tan δ_{x° C.} (=G_{x° C.}″/G_{x° C.}′) at a certain temperature and a damping ratio tan δ_{25° C.} (=G_{25° C.}″/G_{25° C.}′) at 25° C. of the CNT aggregate related to the present invention. In FIG. 11, the desired range of the CNT aggregate related to the present invention is shown by a rectangle.

In this way, a CNT aggregate having a storage modulus G′, a loss modulus G″ and a damping ratio/tan tan δ the same as a rubber or an elastomer at a low temperature has not existed until now and is first obtained in the present invention. A CNT aggregate which includes the same properties as a rubber or an elastomer at a low temperature and displays excellent viscoelasticity can be favorably used as a viscoelastic material at a low temperature.

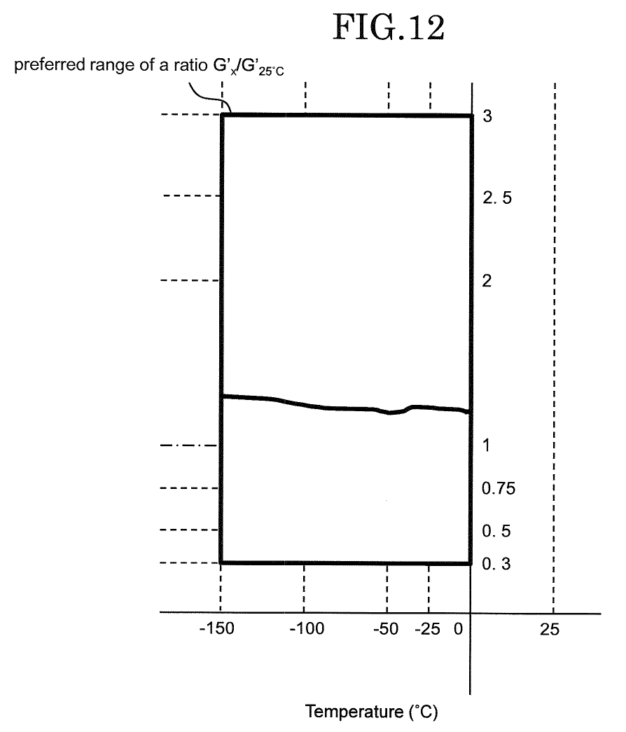

In the CNT aggregate of the present invention, a ratio between a storage modulus G_{x° C.} in a certain temperature range lower than 25° C. and a storage modulus G_{25° C.}′ at 25° C. measured using a dynamic mechanical analysis with a shear mode, is preferred to take a value in a range of 0.3 or more and 3 or less, more preferably 0.5 or more and 2.5 or less and still more preferably 0.75 or more and 2 or less. Here, a certain temperature is preferred to exist in a temperature range of −100° C. or more and −50° C. or less, more preferably −150° C. or more and −25° C. or less, still more preferably −150° C. or more and 0° C. or less. A CNT aggregate having a storage modulus the same as room temperature at a low temperature range includes the same rigidity as at room temperature and is suited for use as a viscoelastic material at a low temperature. All of the above is summarized in FIG. 12. FIG. 12 is a diagram which shows a desired range of a ratio between a storage modulus G_{x° C.}′ at a certain temperature and a storage modulus G_{25° C.}′ at 25° C. of the CNT aggregate related to the present invention. In FIG. 12, the desired range of the CNT aggregate related to the present invention is shown by a rectangle.

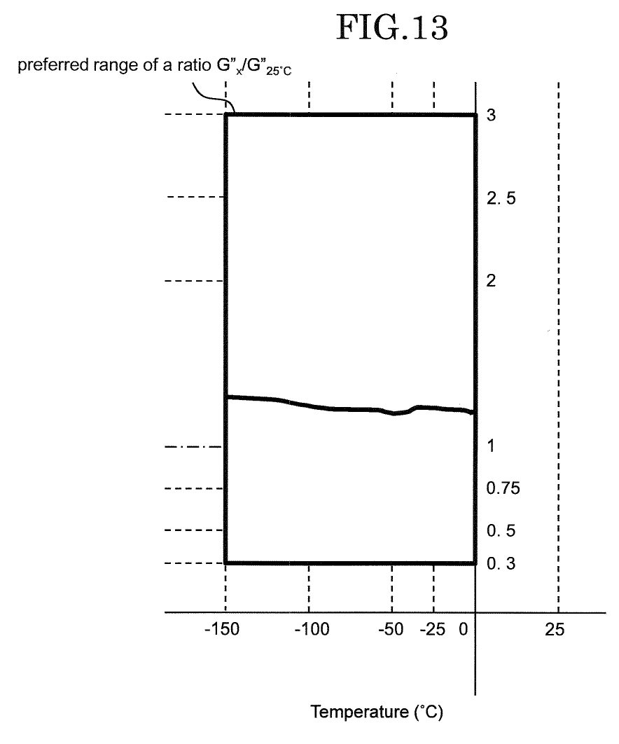

In the CNT aggregate of the present invention, a ratio between a loss modulus G_{x° C.}″ in a certain temperature range lower than 25° C. and a loss modulus G_{25° C.}″ at 25° C. measured using a dynamic mechanical analysis with a shear mode, is preferred to take a value in a range of 0.3 or more and 3 or less, more preferably 0.5 or more and 2.5 or less and still more preferably 0.75 or more and 2 or less. Here, a certain temperature is preferred to exist in a temperature range of −100° C. or more and −50° C. or less, more preferably −150° C. or more and −25° C. or less, still more preferably −150° C. or more and 0° C. A CNT aggregate having a loss modulus the same as room temperature at a low temperature range includes the same flexibility as at room temperature and is suited for use as a viscoelastic material at a low temperature. All of the above is summarized in FIG. 13. FIG. 13 is a diagram which shows a desired range of a ratio between a loss modulus G_{x° C.}″ at a certain temperature and a loss modulus G_{25° C.}″ at 25° C. of the CNT aggregate related to the present invention. In FIG. 13, the desired range of the CNT aggregate related to the present invention is shown by a rectangle.

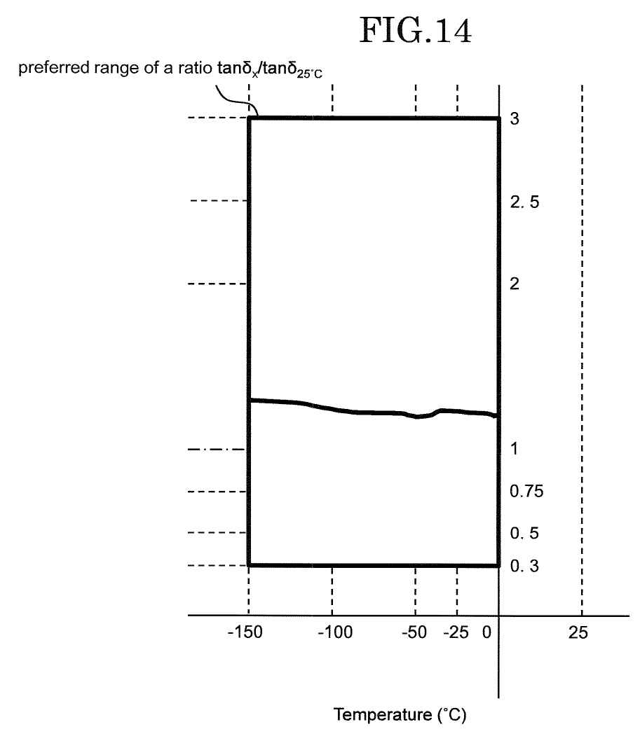

In the CNT aggregate of the present invention, a ratio between a damping ratio tan δ_{x° C.} (=G_{x° C.}″/G_{x° C.}′) in a certain temperature range lower than 25° C. and a damping ratio tan δ_{25° C.} (=G_{25° C.}″/G_{25° C.}′) at 25° C. measured using a dynamic mechanical analysis with a shear mode, is preferred to take a value in a range of 0.3 or more and 3 or less, more preferably 0.5 or more and 2.5 or less and still more preferably 0.75 or more and 2 or less. Here, a certain temperature is preferred to exist in a temperature range of −100° C. or more and −50° C. or less, more preferably −150° C. or more and −25° C. or less, still more preferably −150° C. or more and 0° C. or less. A CNT aggregate having this damping ratio the same as room temperature at a low temperature range includes the same energy dissipation capacity at room temperature and is suited for use as a viscoelastic material at a low temperature. All of the above is summarized in FIG. 14. FIG. 14 is a diagram which shows a desired range of a ratio between a damping ratio tan δ_{x° C.} (=G_{x° C.}″/G_{x° C.}′) at a certain temperature and a damping ratio/tan tan δ_{25° C.} (=G_{25° C.}″/G_{25° C.}′) at 25° C. of the CNT aggregate related to the present invention. In FIG. 14, the desired range of the CNT aggregate related to the present invention is shown by a rectangle.

In this way, a CNT aggregate having a storage modulus G′, a loss modulus G″ and a damping ratio/tan tan δ the same as room temperature at a low temperature has not existed until now and is first obtained in the present invention. A viscoelastic material CNT aggregate which displays the same viscoelasticity as room temperature at a low temperature can be favorably used as a viscoelastic material at a high temperature.

### (Frequency Dependency of Viscoelasticity)

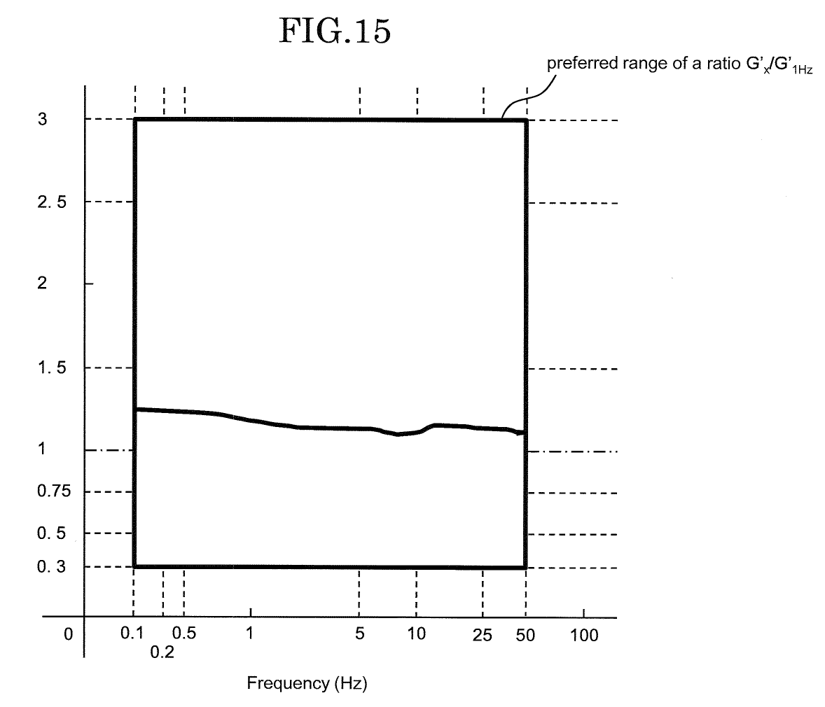

Viscoelastic properties of the CNT aggregate of the present invention at room temperature and/or a high temperature and/or a low temperature is extremely stable with respect to a frequency of a dynamic mechanical analysis. That is, a ratio of the CNT aggregate of the present invention between a storage modulus G_{x Hz}′ obtained in a certain temperature range and frequency range and a storage modulus G_{1 Hz}′ at 1 Hz measured using a dynamic mechanical analysis with a shear mode, takes a value in a range of 0.3 or more and 3 or less, more preferably 0.5 or more and 2.5 or less and still more preferably 0.75 or more and 1.5 or less. Here, a certain frequency range is 0.5 Hz or more and 5 Hz or less, more preferably 0.2 Hz or more and 10 Hz or less, and more preferably 0.1 Hz or more and 25 Hz or less and still more preferably 0.1 Hz and 50 Hz or less. Here, a certain temperature is an arbitrary temperature in a range from −140° C. to 600° C. All of the above is summarized in FIG. 15. FIG. 15 is a diagram which shows a desired range of a ratio between a storage modulus G_{1 Hz}′ at a certain temperature and a certain frequency and a storage modulus G_{1 Hz}′ at 1 Hz of the CNT aggregate related to the present invention. In FIG. 15, the desired range of the CNT aggregate related to the present invention is shown by a rectangle.

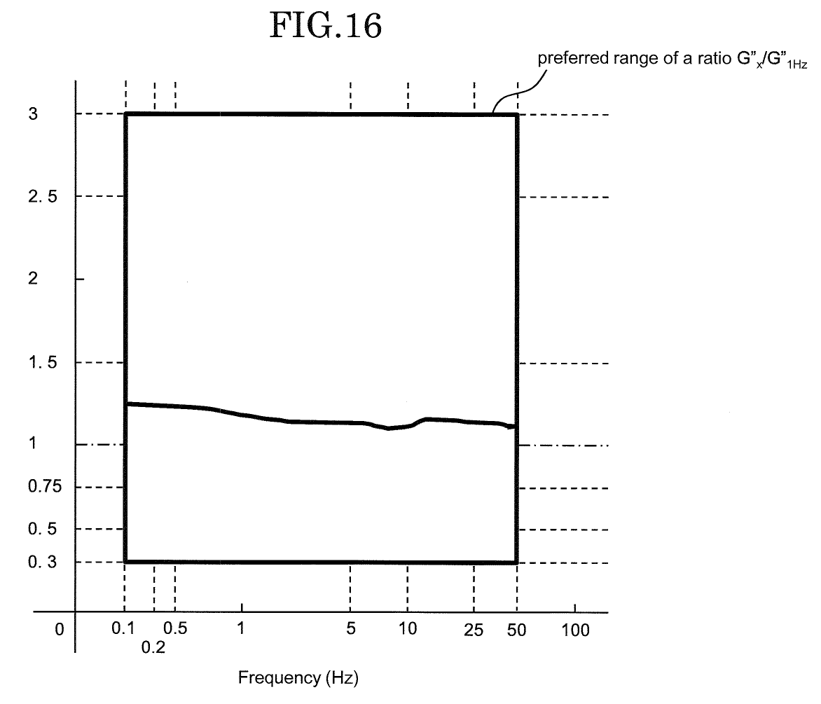

A ratio of the CNT aggregate of the present invention between a loss modulus G_{x Hz}″ obtained in a certain temperature range and frequency range and a loss modulus G_{1 Hz}″ at 1 Hz measured using a dynamic mechanical analysis with a shear mode, takes a value in a range of 0.3 or more and 3 or less, more preferably 0.5 or more and 2.5 or less and still more preferably 0.75 or more and 1.5 or less. Here, a certain frequency range is 0.5 Hz or more and 5 Hz or less, more preferably 0.2 Hz or more and 10 Hz or less, and more preferably 0.1 Hz or more and 25 Hz or less and still more preferably 0.1 Hz and 50 Hz or less. Here, a certain temperature is an arbitrary temperature in a range from −140° C. to 600° C. All of the above is summarized in FIG. 16. FIG. 16 is a diagram which shows a desired range of a ratio between a loss modulus G_{x Hz}″ at a certain temperature and a certain frequency and a loss modulus G_{1 Hz}′ at 1 Hz of the CNT aggregate related to the present invention. In FIG. 16, the desired range of the CNT aggregate related to the present invention is shown by a rectangle.

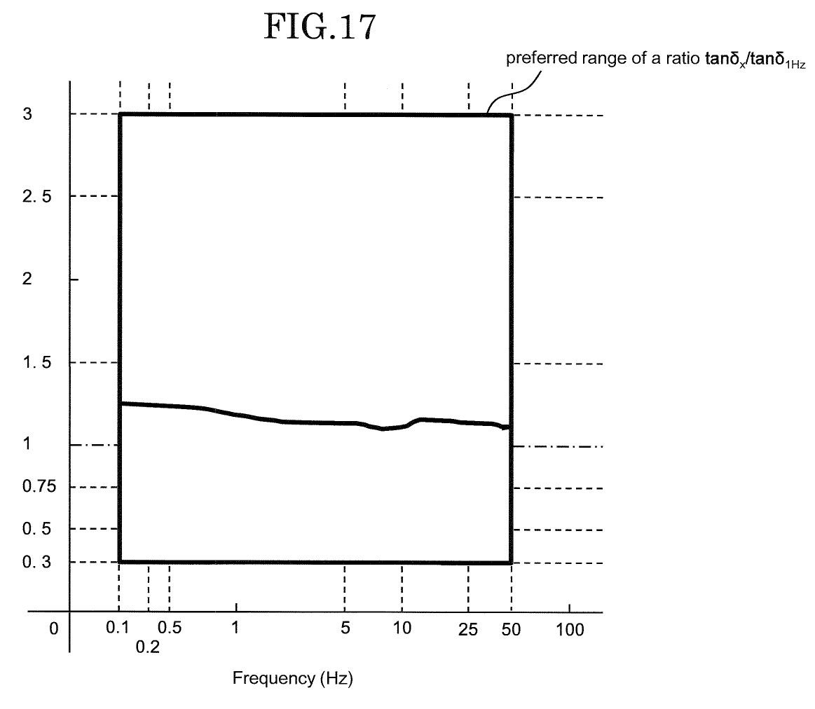

A ratio of the CNT aggregate of the present invention between a damping ratio tan δ_{x Hz} (=G_{x Hz}″/G_{x Hz}′) obtained in a certain temperature range and frequency range and a damping ratio tan δ_{1 Hz} (G=_{1 Hz}″/G_{1 Hz}′) at 1 Hz measured using a dynamic mechanical analysis with a shear mode, takes a value in a range of 0.3 or more and 3 or less, more preferably 0.5 or more and 2.5 or less and still more preferably 0.75 or more and 1.5 or less. Here, a certain frequency range is 0.5 Hz or more and 5 Hz or less, more preferably 0.2 Hz or more and 10 Hz or less, and more preferably 0.1 Hz or more and 25 Hz or less and still more preferably 0.1 Hz and 50 Hz or less. In addition, a certain temperature is an arbitrary temperature in a range from −140° C. to 600° C. All of the above is summarized in FIG. 17. FIG. 17 is a diagram which shows a desired range of a ratio between a damping ratio tan δ_{x Hz} (=G_{x Hz}″/G_{x Hz}′) at a certain temperature and a certain frequency and a tan δ_{1 Hz} (=G_{1 Hz}″/G_{1 Hz}′) at 1 Hz of the CNT aggregate related to the present invention. In FIG. 17, the desired range of the CNT aggregate related to the present invention is shown by a rectangle.

A CNT aggregate having a low fluctuation range with a wide range of frequencies, that is, a constant storage modulus is suited for use as a stable viscoelastic material at a low temperature and/or room temperature and/or high temperature.

The structure of the CNT aggregate related to the present invention, the mechanism of the CNT aggregate and manufacturing method thereof is explained below while referring to the diagrams. However, the CNT aggregate and manufacturing method thereof of the present invention should not be interpreted as being limited by the contents of the embodiments and examples described below. Furthermore, in the diagrams referenced in the embodiments and examples, the same parts or parts having the same function are attached with the same reference symbol and repeating explanations are omitted.

Conventional silicon rubber or rubber containing CNT's described above show excellent viscoelasticity due to the network of cross linked chain macromolecules. However, because these chain macromolecules are organic, stable viscoelastic properties cannot be demonstrated under extremely high or low temperature conditions. On the other hand, a CNT itself contains very flexible elasticity, is difficult to break and also includes excellent strength. However, in a conventional method of mixing CNTs with a rubber component, because heat resistance is affected by the rubber component, it is considered to be difficult to realize the same viscoelasticity under high or low temperature conditions as at room temperature.

The inventors of the present invention considered that it may be possible to realize a CNT aggregate which can demonstrate the same viscoelasticity under high and/or low temperature conditions as at room temperature with a low temperature dependency if a CNT aggregate can be formed by forming a random network of long CNTs with very flexible elasticity and excellent strength. Thus, the inventors keenly examined a manufacturing method of a CNT aggregate with excellent viscoelastic properties having the same viscoelastic properties under high and/or low temperature conditions as at room temperature, including the same properties as rubber or an elastomer even under high or low temperature conditions using a CVD which can manufacture a CNT aggregate including excellent properties.

The structural features of the CNT aggregate related to the present invention are explained.

### (Structure of a CNT Aggregate)

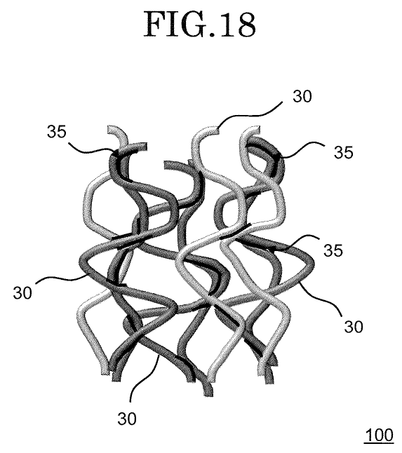

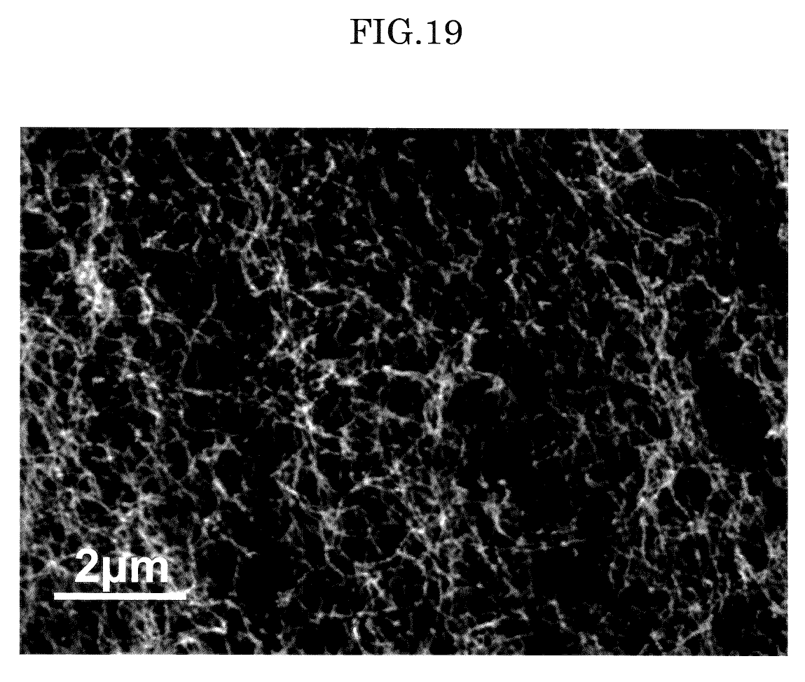

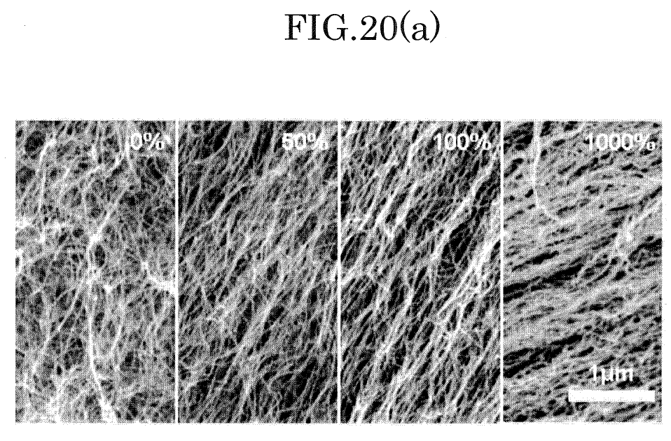

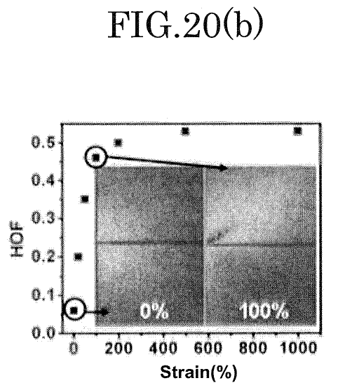

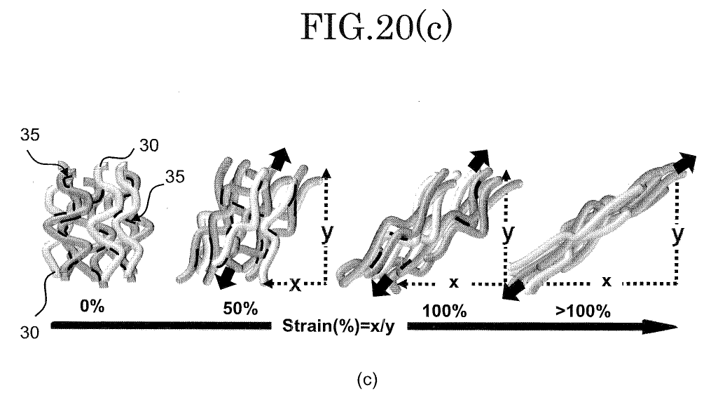

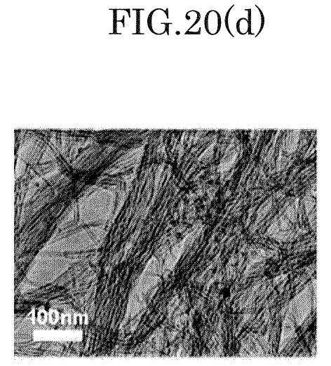

FIG. 18 is an exemplary diagram of a CNT aggregate 100 related to the present embodiment of the present invention. The CNT aggregate 100 is formed using long winding CNT aggregates 30. The CNT aggregates 30 have a structure similar to the chain macromolecules of rubber and form a CNT network having contact regions 35 where pairs of long CNTs 30 contact each other instead of the cross linking chain macromolecules included in rubber. FIG. 19 is a scanning electron microscope (SEM) image taken from a thickness direction of the CNT aggregate 100 related to the present embodiment of the present invention. FIG. 20 (a) is a SEM image when shear strain by 1000% is added to the CNT aggregate 100. FIG. 20 (b) is a diagram showing a Herman orientation coefficient (HOF) calculated as a function of the shear strain and the inset diagram shows a 2-D Fast Fourier Transform (FFT) of the SEM image at a shear of 0% and 100%. FIG. 20 (c) is an exemplary diagram showing a change in structure between CNT's 30 due do each shear. FIG. 20 (d) is a transmission electron microscope (TEM) image of the CNT 30 at 1000% shear strain.

The CNT aggregate 100 of the present invention is arranged with either a part which is essentially non-orientated or includes only a low level of orientation as is shown in the SEM image taken from a thickness direction in FIG. 19. An evaluation of the orientation of a single layer CNT aggregate is performed based on a Herman orientation coefficient for example. In order to quantitatively determine the direction of the orientation, a SEM image etc of the CNT aggregate is fast fourier transformed and a Herman orientation coefficient (0: non-orientation state, 1: orientated state) is calculated using a strength profile obtained from the resulting FFT image.

The direction of orientation takes an average of a direction vector of each CNT single layer which forms the CNT aggregate. As a result, there is a possibility that the direction of orientation is different due to the size of regions for evaluating the area and orientation of the CNT aggregate.

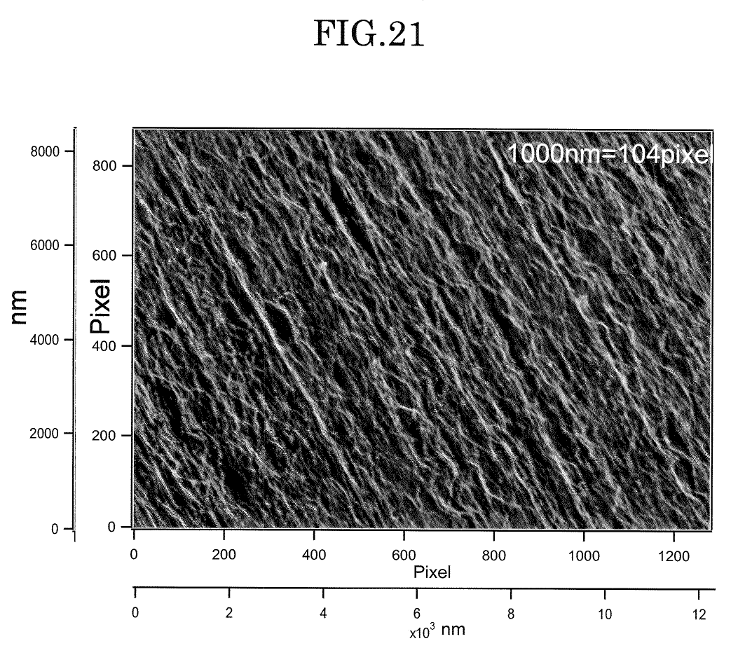

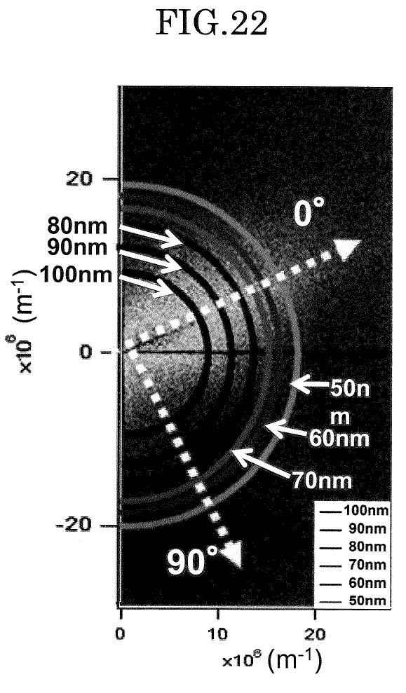

Here, the method of calculating a Herman orientation coefficient (HOF) uses a scanning electron microscope image (FIG. 21) observed from a horizontal direction (thickness direction) of the CNT aggregate at a magnification of ten thousand. Because it is possible that the orientation of the upper end and lower end of the CNT aggregate is different to the orientation of the aggregate as a whole, it is preferred that an observation using a scanning electron microscope image is performed at a center part of the thick section of the CNT aggregate. Specifically, an observation is performed in a region within ±30% of the thickness center of the CNT aggregate. The FTT image is FIG. 22 is obtained by a 2-D fast fourier transformation (FFT) of the scanning electron microscope image.

Next, a reference direction (φ=0) for calculating a Herman coefficient is determined. The FFT image of the CNT aggregate including orientation has a higher orientation the flatter the ellipse. The long axis direction of the ellipse is the direction where the periodicity of the single layer CNT is at its largest due to orientation and the short axis direction of the ellipse has am orientation direction in the field of view of the original FFT image. A reference direction for calculating a Herman orientation coefficient is the long axis direction of the ellipse (or the direction where the Herman coefficient is largest). However, in the case where orientation is low or essentially non-existent, the FFT image has a circular shape and it is not easy to determine a reference direction (φ=0). As a result, a Herman coefficient is calculated at an arbitrary direction X and X+15 degrees, X+30 degrees, X+45 degrees, X+60 degrees, X+75 degrees, and the direction where the Herman coefficient is largest may be used as the reference direction.

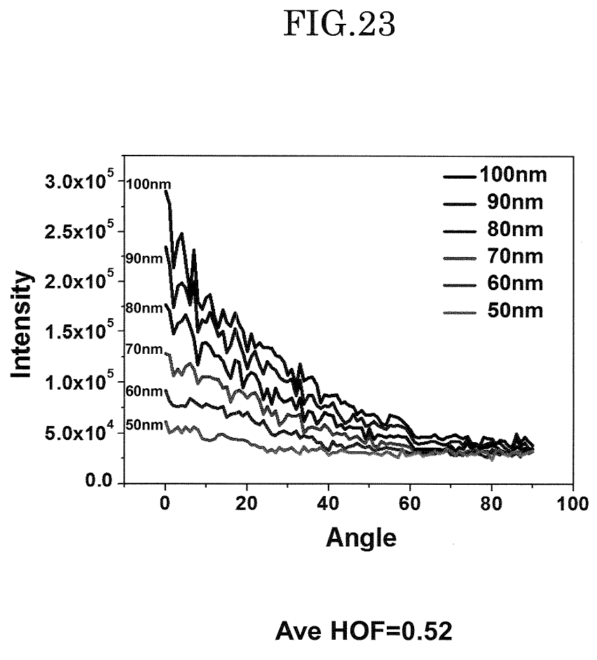

Conversion strength is calculated from the reference direction (φ=0) to φ=π/2 in a radial direction while maintaining an equal distance from a start point of the FFT image and this is used as a diffraction intensity function I(φ) (FIG. 22 and FIG. 23). The distance from the start point for calculating the diffraction intensity function is between the distance (10×10⁶(m⁻¹)) corresponding to a real space distance of 100 nm and a frequency Hz corresponding to a real space distance of 50 nm. The diffraction intensity function I(φ) is calculated from at last 10 different distances within this range.

$$F ≡ \frac{1}{2} ( 3 〈 {cos}^{2} φ 〉 - 1 )$$

$$〈 {cos}^{2} φ 〉 = \frac{{\int }_{0}^{π / 2} I ( φ ) {cos}^{2} φ sin φ d φ}{{\int }_{0}^{π / 2} I ( φ ) sin φ d φ}$$

The formula above is calculated from at least 10 different distances with this diffraction intensity function as a variable, and an average value calculated from at least 6 distances minus the largest two values and the smallest two values is used as the Herman orientation coefficient of the SEM image. This calculation is performed using 5 or more SEM images taken of at least different observation points and the average value is specified as the Herman orientation coefficient of the CNT aggregate. However, F is an Herman orientation coefficient and φ is an azimuthal angle which φ=0 are given as a reference direction and I(φ) is a refraction intensity function. In the Herman orientation coefficient, if φ=0 is a complete orientation then F=1 and if it a non-orientation then F=0.

A Herman orientation coefficient of a part of the CNT aggregate 100 of the present invention which is essentially non-orientated or has a low level of orientation is 0.01 or more and 0.4 or less and more preferably 0.05 or more and 0.3 or less. A Herman orientation coefficient of a generally orientated CNT aggregate is 0.5 or more and 0.8 or less and it is found that the orientation of the CNT aggregate 100 of the present invention is low. In the present specification, being essentially non-orientated or has a low level of orientation indicates that a Herman orientation coefficient is 0.01 or more and 0.4 or less and more preferably 0.05 or more and 0.3 or less. In this way, the CNT aggregate 100 of the present invention includes a part in which a Herman orientation coefficient is 0.01 or more and 0.4 or less.

As is shown in FIG. 20 (a), when shear strain is added to the CNT aggregate 100 of the present invention, the CNTs which form the CNT aggregate 100 stretch and spread out causing the CNT aggregate 100 to transform and absorb the shear strain. At this time, because each CNT stretches and becomes straight, the orientation of the CNT aggregate increases. As is shown in FIG. 20 (b), as the shear strain added to the CNT aggregate 100 becomes larger, the HOF gradually increases.

The CNT aggregate 100 of the present invention is arranged with a part in which the HOF when 100% shear strain is added increases 20% or more, more preferably 50% or more and still more preferably 100% or more compared to the initial state when shear strain is not added. Although there is no particular limit to the an upper limit width, because the Herman orientation coefficient takes a value of 1 or less, it is difficult to increase by 2000% or more. When strain is added in this way, the CNT aggregate 100 with an increased HOF does not break due to the straight stretching of the CNTs and it is possible to absorb the strain. Furthermore, when the strain is released, because the CNTs which include elasticity return their original state the aggregate returns to its original state. That is, because it is possible for the CNT aggregate 100 to reversibly absorb strain, it is possible to favorably use the CNT aggregate 100 as a viscoelastic material.

Here, when a certain amount of strain is exceeded, the orientation angle of the CNT aggregate 100 does not increase even if more strain is added and a part which has an approximately constant HOF is included. Although there is not limit the value of the strain, the range of the strain is generally 50% or more and 500% or less. In a region where the amount of strain is larger than a strain with a constant HOF, the CNT aggregate 100 transforms to absorb the strain by gradual bundling of the CNTs which intermittently contact each other. The bundled CNTs do not completely return to their original state when the strain is released and in this strain region the CNT aggregate 100 irreversibly absorbs the strain. As a result, when strain is repeatedly added, the elasticity of the CNT aggregate 100 deteriorates.

Although it is preferred that an approximately constant large HOF can reversely absorb a larger strain, a range of 0.4 to 0.95 or more preferably 0.4 to 0.8 is preferred. The CNT aggregate 100 arranged with an approximately constant HOF can reversely absorb strain even when the strain is large and can be suitably used as a viscoelastic material. A judgment as to whether a HOF is approximately constant or not is determined by the following procedure. That is, in the case where a ratio (HOF(x %+100%)/HOFx %) of a HOF obtained by a certain strain X % and a strain of X %+100% where the strain is increased by 100%, is in the range of 0.8 or more and 1.2 or less, the HOF is judged to be approximately constant in the strain x. In addition, in an extreme strain (<1000%) where a material breaks, it is possible that the HOF may increase again, however, in the present invention this type of strain region is not considered.

The CNT aggregate 100 of the present invention is arranged with a part in which the approximately constant HOF increases by 1.2 times or more, more preferably 1.5 times or more and still more preferably 2 times or more compared to a HOF having an initial state when shear strain is not added. Although there is no particular limit to the an upper limit width, because the Herman orientation coefficient takes a value of 1 or less, the value does not increase by 20 times or more. It is possible for the CNT aggregate 100 of the present invention to reversibly absorb a large strain for the reasons described above and it is possible to favorably use the CNT aggregate 100 as a viscoelastic material.

Summarizing the above, as is shown in FIG. 20 (v), the greater a CNT transforms in the direction of the force applied with a small strain, the greater a contact region of pairs of CNTs 30 which form the CNT aggregate 100 move and/or slide in the direction of release and the strain is absorbed when the CNTs reversibly stretch and spread out, and when the strain exceeds 100%, the CNTs stretch straight and the strain is absorbed by a bundling irreversible process.

That is, when shear strain is not added (0%) as a load to the CNT aggregate 100, the winding CNTs 30 contact each other and a contact region 35 is formed. When the shear strain applied to the CNT aggregate 100 is increased, the winding CNTs 30 are gradually stretched, a contact region between CNTs 30 is no longer formed and the CNTs finally stretch out straight. As is clear from FIG. 20 (d), when a strain of 1000% is added, the CNTs 30 become straight, contact with an adjacent CNT and bundle together. However, the CNT aggregate 100 displaces when a shear strain is loaded up to 100% and the displacement shows a mechanical reversible displacement when the displacement returns to its original state due to the release of a loaded shear strain.

### (Energy Dissipation Model)

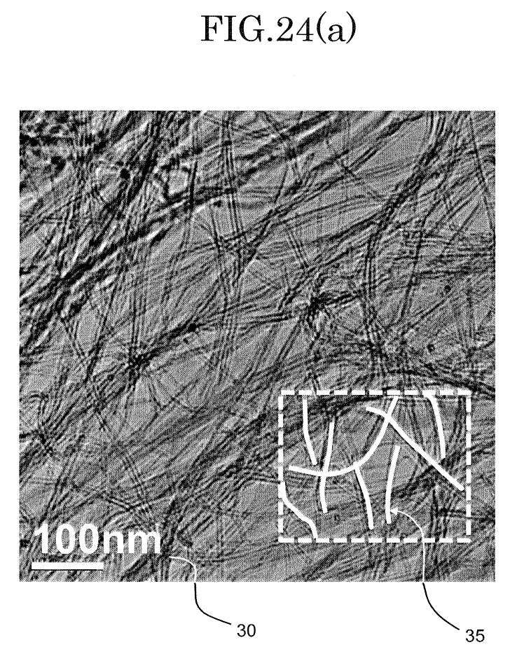

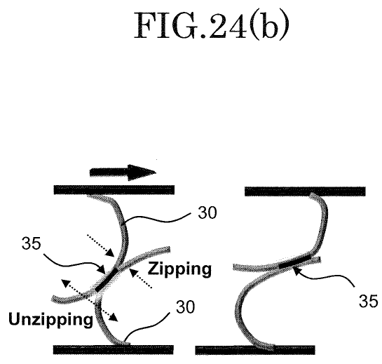

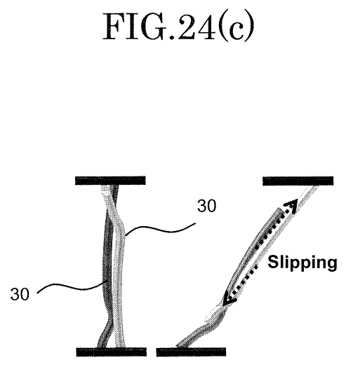

A mechanism whereby the CNT aggregate of the present invention includes excellent viscoelasticity is not definite as of the present time, however, the following is inferred. FIG. 24 (a) is a TEM image of the CNT aggregate 100 related to the present embodiment of the present invention and the section selected in the inset image shows a contact region 35. As is clear from FIG. 24 (a), the CNTs 30 of the CNT aggregate 100 include a contact region 35. FIG. 24 (b) is an exemplary diagram showing an energy dissipation process passing through an opening of the contact region 35.

As is shown in FIG. 24 (a), in the CNT aggregate 100, each CNT contacts with unlimited other CNTs. The feature of the structure of the CNTs 30 is that contact region 35 are formed from CNTs contacting each other in parallel at a high density. Here, the length of a contact region 35 is short at 150 nm or less, more preferably 500 nm or less and still more preferably 1000 nm or less. Furthermore, the contact region 35 is preferably formed by 5 or less CNTs and more preferably 10 or less. The CNT aggregate 100 which includes these contact regions 35 at a high density shows the same viscoelasticity as rubber or an elastomer due to the mechanism described below and structurally allows for large transformations.

Unlike rubber which has cross linking chain macromolecules the CNT aggregate 100 has a structure in which long CNTs 30 include a contact region 35. Although the contact region 35 is similar to the cross links fixed within the rubber, their number and position are not fixed. As is shown in FIG. 20 (b), when the CNT aggregate 100 is loaded with strain, the CNTs 30 in the contact region 35 pass through an opening and reversibly attach and detach. When a load is added, the contact between a pair of CNTs 30 in one contact region 35 is unzipped, a different pair of CNTs 30 contact each other and a new contact region 35 is formed. The energy due to the load is absorbed when the contact region moves in the direction of the load applied. Therefore, the larger the shear strain which is added as a load, the larger the movement distance of the contact region and the larger the CNT aggregate 100 transforms. In addition, the more that a load is applied in a direction in which the CNT aggregate 100 is compressed, the more contact regions 35 are formed. When a contact region is unzipped between CNTs 30, energy is consumed in order to overcome a large van der Waals' force between CNTs. However, energy is not required when a contact region 35 is formed between CNTs 30. Therefore, a high energy dissipation capability is demonstrated by including the CNT aggregate 100 with a contact region at a high density which can be attached and detached.

With this type of mechanism the CNT aggregate 100 shows excellent energy dissipation capabilities, that is, viscoelasticity, the same as rubber or an elastomer. In addition, because the van der Waals' force has an extremely low temperature dependency, the CNT aggregate 100 shows the same viscoelasticity as at room temperature even at high and/or low temperatures. Furthermore, because the contact region 35 can be unzipped very rapidly, the CNT aggregate 100 includes constant viscoelasticity at a wide range of frequencies.

In this energy dissipation model, it is possible for a contact region perpendicular in the direction of strain to be unzipped below a critical strain and dissipate energy. When the strain increases, the contact region which can be attached and detached either unzips or gradually decreases due to orientation (FIG. 20 (c)), and the ability to dissipate the energy of the CNT aggregate 100 finally decreases. When a critical strain is exceeded, this unzipping process is no longer reversible and deteriorating CNTs are produced which are closed at different positions due to a circular movement or bundle.

In order to provide the CNT aggregate of the present invention with viscoelasticity, it is preferred that a nano-sized gap (pore) exists between CNTs and/or contact regions. In order to provide a nano-sized gap (pore) between CNTs and/or contact regions, a space exists on the periphery of the CNTs and/or contact regions of the CNT aggregate of the present invention and when the CNTs and/or contact regions receive strain, it is possible to move, transform, unzip, produce and disappear. As a result, it is possible to provide a CNT aggregate with the same properties of rubber or an elastomer, demonstrate excellent viscoelasticity and structurally allow large transformations. A CNT aggregate may be combined with or immersed in a different material such as a liquid or gel which does not obstruct movement, transformation, unzipping and production disappearance of the CNTs and/or contact regions.

The diameter of a nano-sized pore between CNTs can be calculated from an adsorption isotherm with 77K of liquid nitrogen. A BJH method (refer to J. Amer. Chem. Soc Magazine, Volume 73 (1951) page 373) which assumes that a pore has a cylinder shape may be used as a logical equation for calculating a pore diameter distribution. A pore diameter defined in the present specification is calculated using a BJH method from an adsorption isotherm with 77K of liquid nitrogen.

A maximum distribution of a pore diameter calculated using BJH method of the CNT aggregate of the present invention is preferably 50 nm or less, more preferably 40 nm or less and still more preferably 30 nm less, still more preferably 1 nm or more and 50 nm or less, still more preferably 2 nm or more and 40 nm or less and yet more preferably 2 nm or more and 30 nm or less.

A CNT aggregate having this pore diameter maximum distribution includes a sufficient gap in the periphery of the CNTs and/or contact regions of the CNT aggregate and when the CNTs and/or contact regions receive strain, it is possible to move, transform, unzip, produce and disappear. As a result, it is possible to provide a CNT aggregate with the same properties of rubber or an elastomer, demonstrate excellent viscoelasticity and structurally allow large transformations. In the case where the pore diameter maximum distribution is less than 1 nm, the gap between CNTs and contact regions are reduced, the CNTs and/or contact regions can no longer move freely and viscoelasticity deteriorates. Reversely, in the case where the pore diameter maximum distribution exceeds 100 nm, gaps between CNTs increase, a coupling force between pairs of CNTs becomes weaker, integrity of the CNT aggregate is lost and falls apart when strain is received. In the case where the CNT aggregate is immersed in a liquid or gel or combined with a different material such as gel, the pore diameter of a CNT aggregate may be calculated after removing the liquid or different material.

As explained above, by providing the CNT aggregate related to the present embodiment of the present invention with a network structure in which long winding CNTs form unlimited attachable and detachable contact regions, a structure similar to the cross linking chain macromolecules of rubber is realized. By attaching and detaching unlimited contact regions and adopting an orientated and non-orientated arrangement, the CNT aggregate can demonstrate the excellent effect of generating reversible viscoelasticity. In addition, because a CNT aggregate is formed only from CNTs and does not include a rubber component, it is possible to realize stable viscoelasticity under extreme temperature conditions as is explained in the following examples.

### (Manufacturing Method)

As described above, in order to manufacture the CNT aggregate 100 related to the present invention, because it is necessary to grow CNTs which are long and winding, have a low orientation and unlimited contact regions, a manufacturing process of a CNT with high orientation cannot be used.

A promoter layer comprised from alumina (Al₂O₃) is formed on an upper surface of a silicon substrate 10 which includes an oxide layer using a radio frequency sputtering (RF sputtering) method. Next, a catalyst layer comprised from iron (Fe) is formed on the alumina later using RF sputtering.

The catalyst layer is converted to catalyst particles 20 by a formation process. However, in order to widen an interval for forming CNTs, reactive ion etching (referred to as RIE herein) is performed in the promoter later and catalyst layer in the present embodiment. The catalyst density of the catalyst particles 20 formed using a formation process decreases by performing RIE and CNT intervals which are formed become scattered. The catalyst density of the catalyst particles 20 can be adjusted by the thickness of the promoter layer and catalyst layer which are formed and by RIE. These can be arbitrarily changed according to the viscoelasticity demanded by the CNT aggregate to be manufactured.

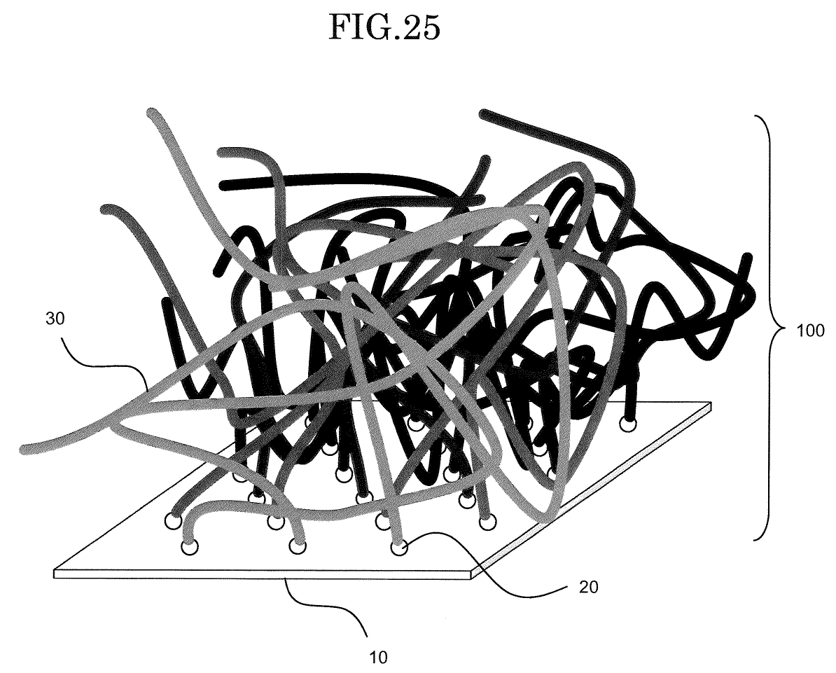

CNTs 30 are formed using the silicon substrate 10 on which the catalyst particles 20 are formed. The growth process of the CNTs 30 is performed by a CVD method (herein referred to as super growth method) while adding water as reported by the inventor of the present invention. By using a super growth method, very long CNTs are grown in a short period of time from the catalyst particles 20 at high efficiency and because intervals between the catalyst particles 20 are wide, the long CNTs wind with no orientation, the CNTs contact each other and contact regions 35 are increased (FIG. 25).

The CNTs which are formed increase the density of the CNT aggregate 100 by being compressed. This compression not only increases the density of the CNT aggregate 100 but also increases the mutual contact between CNTs and increases contact regions 35. As a result, a CNT aggregate 100 with greater viscoelasticity can be obtained.

As explained above, in the manufacturing method of the CNT aggregate related to the present embodiment of the present invention, a catalyst layer is processed using RIE, intervals between catalyst particles are widened and long CNTs are grown using a super growth method to form long winding CNTs, and by providing a network structure in which long winding CNTs form unlimited attachable and detachable contact regions, a structure similar to the cross linking chain macromolecules of rubber can be realized. Furthermore, it is possible to increase mutual contact between CNTs and increase contact regions by compressing the CNT aggregate. In the manufacturing method of the CNT aggregate related to the present embodiment of the present invention, by attaching and detaching unlimited contact regions and adopting an orientated and non-orientated arrangement, a CNT aggregate can be manufactured which demonstrates the excellent effect of generating reversible viscoelasticity. In addition, in the manufacturing method of the CNT aggregate related to the present embodiment of the present invention, because a CNT aggregate is formed by including CNTs and does not include a rubber component, it is possible to realize stable viscoelasticity under extreme temperature conditions as is explained in the following examples.

An example of the CNT aggregate related to the present invention described above is explained in detail below. Furthermore, the present invention is not limited to the examples below.

### (Manufacturing Method of a CNT Aggregate)

The CNT aggregate related to the present example of the present invention was formed using a 1 centimeter square silicon substrate including an oxide layer (600 nm), and a 30 nm promoter layer comprised from alumina (Al₂O₃) was formed on the upper surface of the substrate 10 using a high frequency sputtering (RF sputtering) method. Next, a 2 nm catalyst layer comprised from iron (Fe) is formed on the alumina later using RF sputtering.

The substrate 10 formed with the promoter layer and catalyst layer was processed using RIE. Pressure was set at 10 Pa while flowing 10 sccm of argon in a back pressure 5×10⁻³ Pa RIE device, and the substrate 10 formed with the promoter layer and catalyst layer was processed at 20 W for 15˜20 minutes.

A formation process was performed for forming metal particles 20 in a synthetic furnace of a CNT manufacturing device. In the formation process, the substrate 10 formed with the promoter layer and catalyst layer which was RIE processed was transported and set in a synthetic furnace of a CVD device maintained at a furnace pressure of 1.02×10⁵ Pa, 100 sccm of He as an atmosphere gas and 900 sccm of H₂ as a reduction gas was introduced so that the total amount of gas within the furnace became 1000 sccm, and the temperature was increased to 750° C. from room temperature over 15 minutes. Next, 100 sccm of He as an atmosphere gas and 900 sccm of H₂ as a reduction gas was introduced for 6 minutes at 750° C. The formation process is for converting the catalyst (Fe) into fine particles and the furnace temperature, amount of introduced reduction gas, type of gas, reduction time, size of catalyst particle and number density are adjusted.

Next, 885 sccm of He (atmosphere gas), 75 sccm of C₂H₄ (raw material gas), 40 sccm of He containing H₂O (relative humidity 23%) (catalyst activator material mixed with a carrier gas) was supplied from a gas supply conduit for 22 to 35 minutes to the synthetic furnace in a state maintained at a furnace temperature of 750° C. and furnace pressure of 1.02×10⁵ Pa, so that the total amount of introduced gas becomes 1000 sccm, and a CNT aggregate with a density of 0.007 g/cm³ was grown to a height of 4 mm.

Next, the CNT aggregate which was grown was compressed using a compression process. The upper surface and lower surface of the grown CNT aggregate was attached to a measurement bed of a dynamic mechanical analysis machine (DMA), an interval between two measurement beds was adjusted in order to fix the CNT aggregate and the initial value of the height of the CNT aggregate was recorded. Here, an interval between measurement beds is equivalent to the initial value of the height of the CNT aggregate. Next, a desired CNT aggregate height was input. The height was input as 1 mm in the case where a CNT aggregate having an initial height value of 4 mm and a density of 0.07 g/cm³ is compressed to 0.028 g/cm³. In this way, in the DMA pressure was added to the CNT aggregate and the height was compressed to ¼ and the density was compressed by a factor of 4 to 0.028 g/cm³. In this compression process, there is no change in the contact area between the measurement bed and CNT aggregate. The CNT aggregate is maintained in a pressured state for 5 to 10 minutes in order to balance the compression state. In this way, a 1 centimeter square CNT aggregate with a density of 0.028 g/cm³ was obtained.

A plurality of CNT aggregates formed in this way were peeled from the substrate and an adsorption isotherm of liquid nitrogen with respect to 20 mg of CNT aggregates at 77K using a BELSORP MINI (manufactured by Nihon Bel Ltd) was measured (the adsorption equilibrium time was set at 600 seconds). The distribution maximum of a pore diameter was measured at 13 nm using a BJH method from the adsorption isotherm of liquid nitrogen.

### (Structure of a CNT Aggregate)

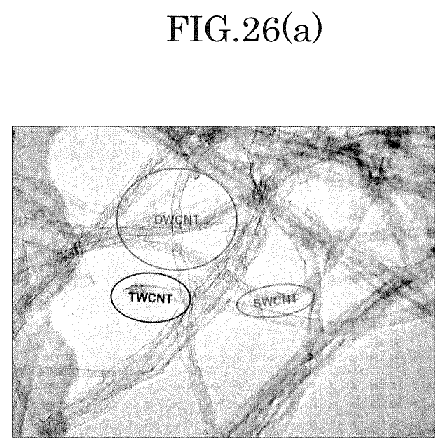

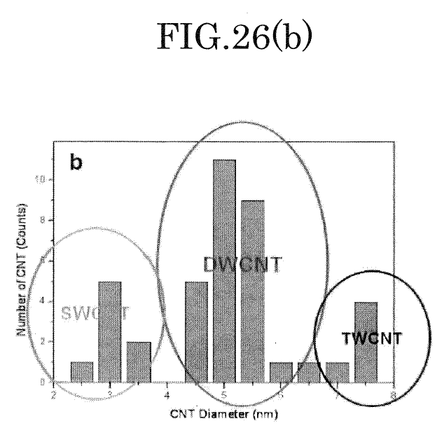

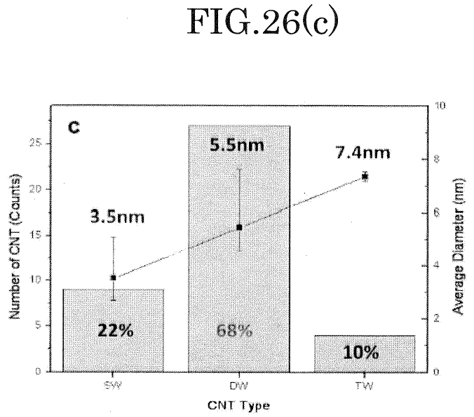

The CNT aggregate 100 of the present example related to the present invention was manufacture using the manufacturing processes described above. A SEM image taken using a Hitachi S-4800 of the manufactured CNT aggregate 100 from a horizontal direction (thickness direction) is shown in FIG. 19. The SEM image shows that the CNT aggregate 100 is essentially non-orientated or has a low level of orientation and that the CNTs are mutually connected at a high density. As is shown in FIG. 24 (a), the CNT aggregate 100 contains a high density of contact regions 35 comprised from CNTs in contact with each other in parallel. A TEM image of the CNT aggregate 100 taken using a JEOL JEM-2000FX is shown in FIG. 26 (a), a histogram of the diameter distribution of a CNT is shown using SWCNT, DWCNT and TWCNT (three layer CNT) in FIG. 26 (b) and an average diameter, type of CNT and relative number are shown in FIG. 26 (c).

As is clear from FIG. 26 (a), the CNT aggregate 100 of the present example is comprised from SWCNT, DWCNT and TWCNT (three layer CNT). As is shown in FIG. 26 (b) and FIG. 26 (c), the CNT aggregate 100 of the present example has an average external diameter of 5.5 nm, an average internal diameter of 4.5 nm, and includes mainly DWCNTs with a ratio of 68%.

### (Dynamic Viscoelasticity Measurement (DMA))

Viscoelasticity was measured using a twisted type dynamic viscoelasticity measurement device, AR-2000ex and ARES-G2 by TA instruments. Unless otherwise noted, the measurement temperature is a room temperature of 25° C. A sample of CNTs 30 was fixed between two stainless steel parallel plates having antislip jagged surface. Stainless steel is selected for its resistance in high temperature tests and thermal expansion was corrected during a test. A cyclic test was performed with a vibration mode using a stress/strain pattern of a sine function. For the DMA a heating and cooling device was prepared which can perform a test at temperatures from 150° C. to 600° C.

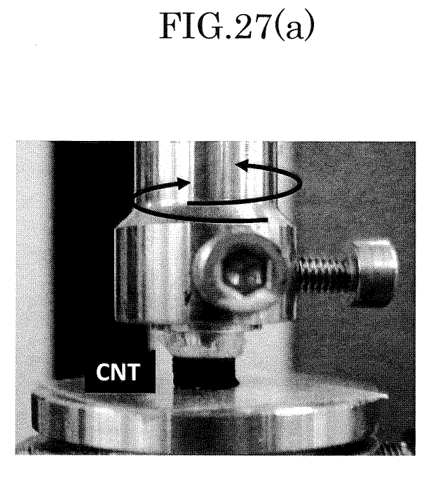

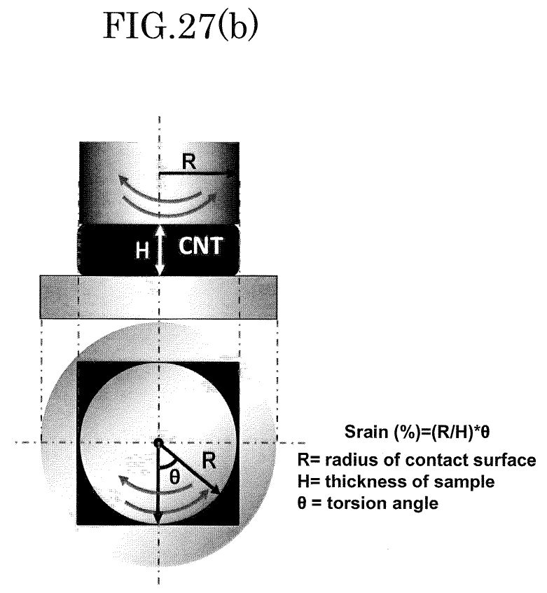

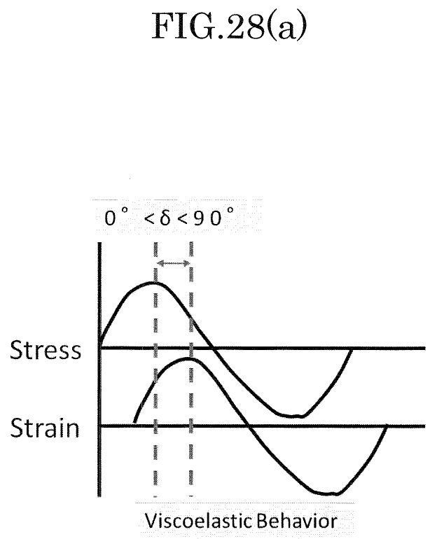

FIG. 27 and FIG. 28 show a viscoelasticity twisted shear mode DMA test. FIG. 27 is an exemplary diagram of a twisted mode (shear) DMA test of stress or strain with different sine functions. FIG. 28 shows viscoelasticity calculated from a stress-shear relationship.

As is shown in FIG. 27 (a) and FIG. 27 (b), a dynamic vibration test in a twisted mode was performed in which stress of a sine function is added to a sample and strain of a net force since function are measured. An intermediate phase angle δ exits between two sine functions equivalent to a loop of a stress-strain loop. A storage modulus G′ is an elasticity element and shows the rigidity of a sample. A loss modulus G″ is a viscosity element and shows the energy dissipation capability of a sample (FIG. 28).

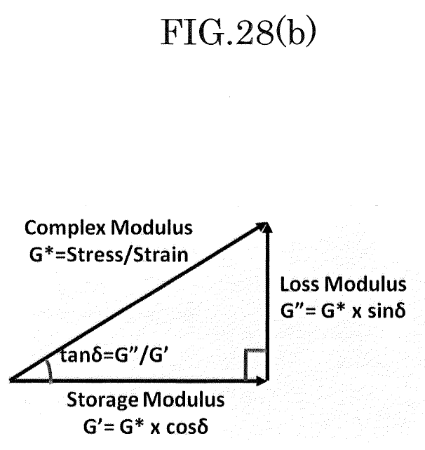

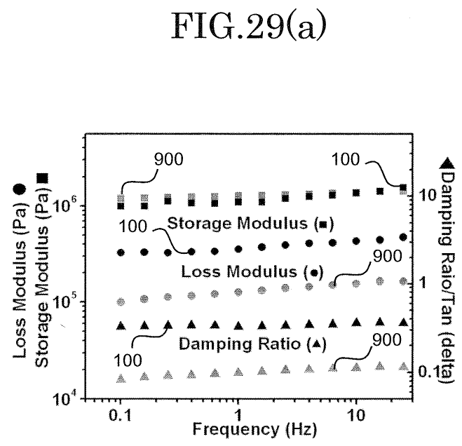

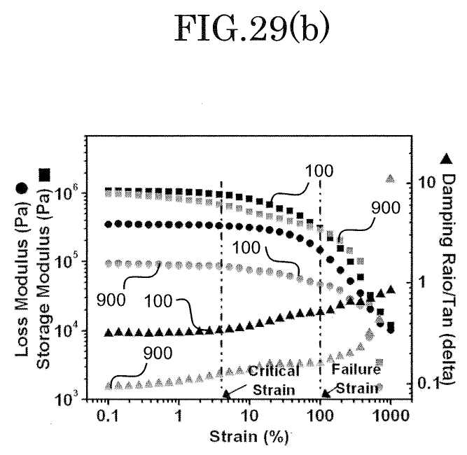

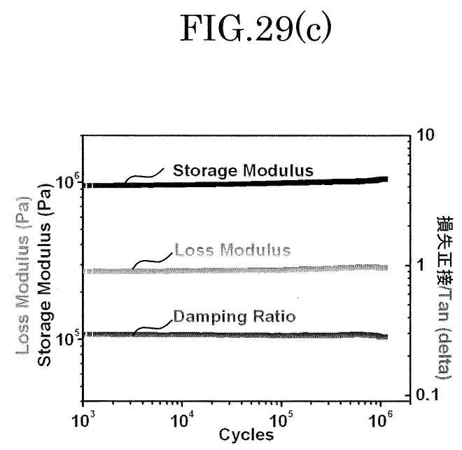

Quantitative results of viscoelasticity of the CNT aggregate 100 are shown in Table 1 and FIG. 29. FIG. 29 (a) shows the test results of frequency dependence of a storage modulus, loss modulus and damping ratio of the CNT aggregate 100 at room temperature, and table 1 shows a storage modulus, loss modulus and damping ratio at a typical frequency. Silicon rubber 900 is shown as a comparative example.

TABLE 1

| frequency (Hz) | 0.1 | 0.15849 | 0.25119 | 0.39811 | 0.63096 | 1 | 1.58489 |
|---|---|---|---|---|---|---|---|
| G_{xHz}′ (MPa) | 0.99661 | 0.99661 | 1.12124 | 1.07431 | 1.06089 | 1.08791 | 1.09626 |
| G_{xHz}″ (Mpa) | 0.32397 | 0.32817 | 0.32443 | 0.33413 | 0.33702 | 0.356132 | 0.37263 |
| Damping | 0.32757 | 0.33162 | 0.33554 | 0.33861 | 0.33616 | 0.32757 | 0.33162 |

| frequency | 2.51188 | 3.98107 | 6.30957 | 10 | 15.84892 | 25.11877 |
|---|---|---|---|---|---|---|
| G_{xHz}′ (MPa) | 1.19661 | 1.24311 | 1.29092 | 1.35327 | 1.41329 | 1.55019 |
| G_{xHz}″ (Mpa) | 0.39253 | 0.40885 | 0.41444 | 0.431676 | 0.44281 | 0.47312 |
| Damping | 0.33554 | 0.34228 | 0.34691 | 0.35937 | 0.3621 | 0.35715 |

As is shown in FIG. 29 (a) and table 1, it is clear that the CNT aggregate 100 has the behavior of viscoelasticity the same as silicon rubber (storage modulus, loss modulus and damping ratio). The CNT aggregate 100 showed constant viscoelasticity with a small variation band in a frequency range of 0.1 or more and 25 Hz or less. The storage modulus (1 MPa) of the CNT aggregate 100 was the same as silicon rubber (1 MPa). However, the loss modulus (0.3 MPa) and damping ratio (0.3 MPa) increased by a factor of 2 and energy dissipation capabilities were excellent across the entire range of frequencies.

Here, the relationship between strain and a Herman orientation coefficient (HOF) of the CNT aggregate 100 related to the present example of the present invention is explained while referring to FIG. 20 (b). HOF is calculated from an FFT image calculated from a scanning electron microscope image observed from a horizontal direction (thickness direction) of the CNT aggregate 100 at a magnification of 10,000 times. The scanning electron microscope image was taken at the center section of the thickness of the CNT aggregate and 5 images were obtained at a magnification of 10,000 from 5 different positions. The HOF is an average value of each HOF obtained from the 5 images.

In addition, a HOF with respect to each strain is shown in table 2. The HOF was 0.06 in an initial state with no strain and shows that the CNT aggregate 100 is essentially non-orientated or has a low level of orientation. In addition, the HOF was monotonically increased up to a strain of 100% together with the strain. The HOF was not increased above a 100% strain and an approximately constant value of 0.5 was obtained.

TABLE 2

| Strain (%) | 0 | 25 | 50 | 100 | 200 | 500 | 1000 |
|---|---|---|---|---|---|---|---|
| HOF | 0.06 | 0.2 | 0.35 | 0.46 | 0.5 | 0.53 | 0.53 |

Note)
It is subsidiary fractured at 100% strain and HOF became constant.

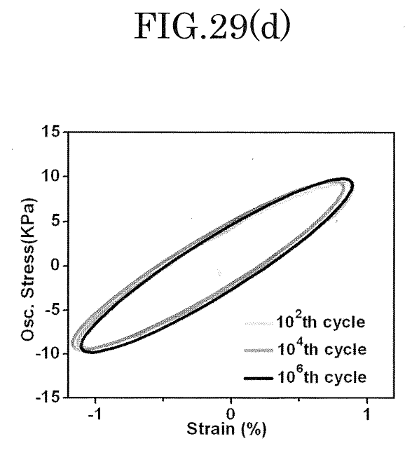

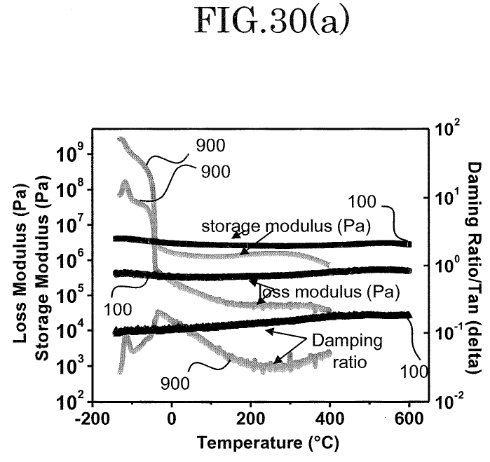

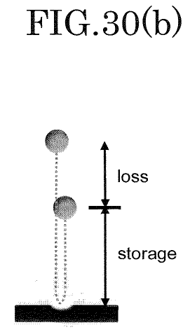

FIG. 30 shows viscoelasticity of the CNT aggregate 100 at a wide temperature range from a low temperature to a high temperature range and a conventional silicon rubber 900 as a comparative example. FIG. 30 (a) shows the temperature dependency of a storage modulus, loss modulus and damping ratio of the CNT aggregate 100 (black line) and silicon rubber 900 (brown line). Table 3 shows a storage modulus, loss modulus and damping ratio of the CNT aggregate 100 at a typical temperature. In addition, table 4 shows a storage modulus, loss modulus and damping ratio of a conventional silicon rubber 900 at a typical temperature. Because the silicon rubber 900 melts when 400° C. is exceeded, measurement results under temperature conditions above this are not shown in FIG. 30 (a) and table 4. As is shown in FIG. 30 (a), table 3 and table 4, as a result of measuring the viscoelasticity properties using DMA under a N₂ environment, while the silicon rubber 900 showed large changes, the CNT aggregate 100 was largely constant over a wide temperature range (−140° C. or more and 600° C. or less).

TABLE 3

| Temp. x (° C.) | −150 | −100 | −50 | −20 | 0 | 25 | 50 | 100 | 150 |
|---|---|---|---|---|---|---|---|---|---|
| G′x (MPa) | 4.04338 | 3.92576 | 3.40106 | 3.18428 | 3.05099 | 2.93813 | 2.83413 | 2.71835 | 2.67111 |
| G′x/G′25 | 1.38 | 1.33 | 1.16 | 1.08 | 1.03 | 1 | 0.96 | 0.93 | 0.91 |
| G″x (Mpa) | 0.41877 | 0.40772 | 0.36592 | 0.35099 | 0.34176 | 0.34253 | 0.3328 | 0.32008 | 0.34738 |
| G″x/G′25 | 1.22 | 1.19 | 1.06 | 1.02 | 1 | 1 | 0.97 | 0.93 | 1.01 |
| Damping | 0.10357 | 0.1074 | 0.10607 | 0.11023 | 0.11202 | 0.1158 | 0.11706 | 0.11775 | 0.13005 |
| Tanδx/Tanδ | 0.89438 | 0.89687 | 0.91599 | 0.95187 | 0.96733 | 1 | 1.01 | 1.02 | 1.11 |

| Temp. x (° C.) | 200 | 250 | 300 | 350 | 400 | 450 | 500 | 550 | 600 |
|---|---|---|---|---|---|---|---|---|---|
| G′x (MPa) | 2.61484 | 2.5739 | 2.56311 | 2.59932 | 2.68087 | 2.80672 | 2.97368 | 3.07321 | 2.78388 |
| G′x/G′25 | 0.89 | 0.88 | 0.87 | 0.88 | 0.91 | 0.96 | 1.01 | 1.05 | 0.95 |
| G″x (Mpa) | 0.3535 | 360413 | 0.3853 | 0.41796 | 0.46658 | 0.49709 | 0.5319 | 0.54021 | 0.4996 |
| G″x/G′25 | 1.03 | 1.05 | 1.12 | 1.22 | 1.36 | 1.45 | 1.55 | 1.58 | 1.46 |
| Damping | 0.13519 | 0.14003 | 0.15033 | 0.1608 | 0.17404 | 0.17711 | 0.17887 | 0.17578 | 0.17946 |
| Tanδx/Tanδ | 1.16 | 1.21 | 1.3 | 1.39 | 1.5 | 1.53 | 1.54 | 1.52 | 1.55 |

TABLE 4

| Temp. x (° C.) | −130 | −100 | −50 | −20 | 0 | 25 | 50 |
|---|---|---|---|---|---|---|---|
| G′x (MPa) | 2607.78 | 1005.77 | 166.135 | 1.98103 | 1.61954 | 1.43118 | 1.3519 |
| G′x/G′25 | 1822.121 | 702.7539 | 116.0826 | 1.38419 | 1.13161 | 1 | 0.94461 |
| G″x (Mpa) | 68.7025 | 54.7201 | 15.7272 | 0.381694 | 0.244827 | 0.182098 | 0.133271 |
| G″x/G′25 | 377.2829 | 300.4982 | 86.36655 | 1.98736 | 1.34448 | 1 | 0.73187 |
| Damping Ratio | 0.02635 | 0.05441 | 0.09466 | 0.18268 | 0.15117 | 0.12724 | 0.09858 |
| Tanδx/Tanδ25 | 0.20705 | 0.42759 | 0.74399 | 1.43571 | 1.18808 | 1 | 0.75317 |

| Temp. x (° C.) | 100 | 150 | 200 | 250 | 300 | 350 | 400 |
|---|---|---|---|---|---|---|---|
| G′x (MPa) | 1.25873 | 1.31525 | 1.0259 | 1.56338 | 1.49733 | 1.17319 | 0.734218 |
| G′x/G′25 | 0.87951 | 0.919 | 0.89 | 1.09237 | 1.04622 | 0.81974 | 0.51302 |
| G″x (Mpa) | 0.0819 | 0.057352 | 0.27948 | 0.047088 | 0.043693 | 0.050165 | 0.39388 |
| G″x/G′25 | 0.44976 | 0.31496 | 1.03 | 0.25859 | 0.23994 | 0.27549 | 0.216302 |
| Damping Ratio | 0.06507 | 0.04361 | 0.03466 | 0.03012 | 0.02918 | 0.04276 | 0.05365 |
| Tanδx/Tanδ25 | 0.51136 | 0.34271 | 0.27242 | 0.23672 | 0.22934 | 0.33606 | 0.42162 |

As is shown in FIG. 30 (b), in order to increase a temperature range, an impact test was performed using an iron ball at −196° C., 25° C. and 1000° C. and the trajectory of the ball was analyzed. The trajectory of the ball was observed using a SEM and 3-D mapping which was the same for all the examples. As is shown in FIG. 30 (c), when the results of a DMA, vibration insulation and an impact test are combined, the same viscoelasticity was demonstrated across the entire temperature range from −196° C. to 1000° C.

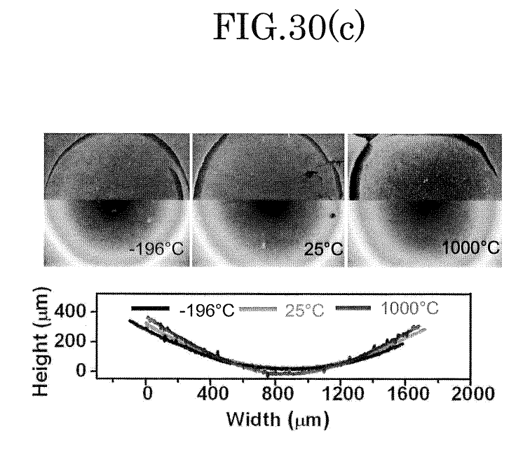

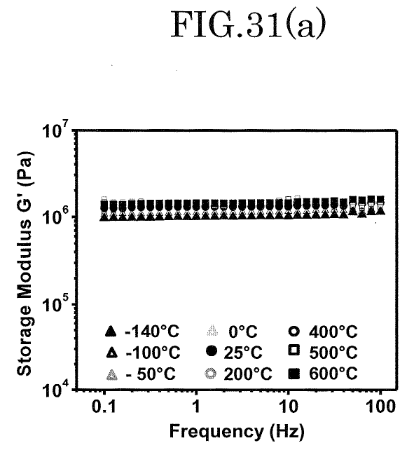

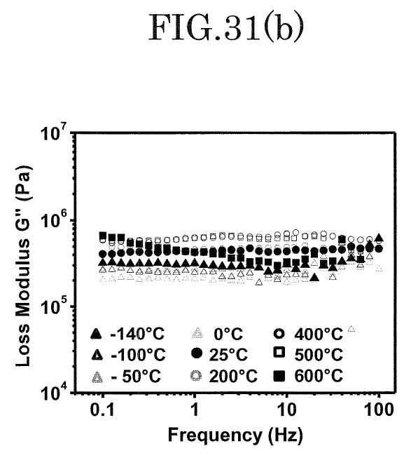

Next, with respect to viscoelasticity, the relationship between frequency and thermal stability were examined. FIG. 31 shows viscoelasticity of the CNT aggregate 100 at a frequency of 0.1 or more and 100 Hz or less under temperature conditions of −140° C. or more and 600° C. or less, FIG. 31 (a) shows a storage modulus, FIG. 31 (b) shows a loss modulus and FIG. 31 (c) shows a damping ratio. In addition, tables 5 to 7 show a storage modulus, loss modulus and damping ratio/tan at a typical frequency at each temperature.

TABLE 5

| frequency (Hz) | | | 0.1 | 0.12589 | 0.15849 | 0.19953 | 0.25119 | 0.31623 | 0.39811 | 0.50119 |
|---|---|---|---|---|---|---|---|---|---|---|
| G′ | −140° | C. | 0.96785 | 0.97193 | 0.97327 | 0.97675 | 0.98014 | 0.98238 | 0.98669 | 0.98991 |
| (MPa) | −100° | C. | 1.07381 | 1.0837 | 1.09594 | 1.08815 | 1.09252 | 1.09731 | 1.10227 | 1.10606 |
| | −50° | C. | 0.98428 | 0.99318 | 0.99494 | 1.00091 | 1.0023 | 1.00558 | 1.01099 | 1.01526 |
| | 0° | C. | 0.9715 | 0.97898 | 0.98767 | 0.99173 | 0.99771 | 1.00165 | 1.00279 | 1.01389 |
| | 25° | C. | 1.2625 | 1.25919 | 1.25137 | 1.28953 | 1.29251 | 1.29336 | 1.29789 | 1.29706 |
| | 200° | C. | 1.12533 | 1.211 | 1.24033 | 1.26533 | 1.27233 | 1.28 | 1.29367 | 1.3 |
| | 400° | C. | 1.59167 | 1.468 | 1.46867 | 1.49133 | 1.507 | 1.458 | 1.45433 | 1.442 |
| | 500° | C. | 1.47433 | 1.37533 | 1.41467 | 1.41633 | 1.42267 | 1.42567 | 1.417 | 1.42167 |
| | 600° | C. | 1.38876 | 1.38511 | 1.37651 | 1.41848 | 1.42176 | 1.42269 | 1.42768 | 1.42677 |
| frequency (Hz) | | | 0.63096 | 0.79433 | 1 | 1.25893 | 1.58489 | 1.99526 | 2.51189 | 3.16228 |
| G′ | −140° | C. | 0.99573 | 0.99187 | 0.99691 | 1.00254 | 1.00282 | 1.0079 | 1.00647 | 1.01178 |
| (MPa) | −100° | C. | 1.11289 | 1.11097 | 1.11266 | 1.12041 | 1.12198 | 1.12421 | 1.12807 | 1.13588 |
| | −50° | C. | 1.01905 | 1.02115 | 1.03058 | 1.0345 | 1.04399 | 1.03798 | 1.0364 | 1.04028 |
| | 0° | C. | 1.01565 | 1.02143 | 1.02569 | 1.02302 | 1.00081 | 1.00422 | 1.0112 | 1.01579 |
| | 25° | C. | 1.30252 | 1.30435 | 1.30377 | 1.30294 | 1.30765 | 1.30967 | 1.30954 | 1.30949 |
| | 200° | C. | 1.31067 | 1.31667 | 1.323 | 1.332 | 1.33833 | 1.34433 | 1.356 | 1.365 |
| | 400° | C. | 1.44733 | 1.42067 | 1.41367 | 1.38667 | 1.35233 | 1.35367 | 1.391 | 1.415 |
| | 500° | C. | 1.412 | 1.408 | 1.39733 | 1.38567 | 1.37367 | 1.38067 | 1.40633 | 1.428 |
| | 600° | C. | 1.43277 | 1.43479 | 1.43415 | 1.43323 | 1.43842 | 1.44064 | 1.4405 | 1.44044 |
| frequency (Hz) | | | 3.98107 | 5.01187 | 6.30957 | 7.94328 | 10 | 12.5893 | 15.8489 | 19.9526 |
| G′ | −140° | C. | 1.00956 | 1.01722 | 1.0157 | 1.02268 | 1.01792 | 1.03198 | 1.02693 | 1.0342 |
| (MPa) | −100° | C. | 1.14002 | 1.13553 | 1.1498 | 1.14289 | 1.16112 | 1.14822 | 1.15517 | 1.18626 |
| | −50° | C. | 1.05391 | 1.05102 | 1.05399 | 1.05889 | 1.04614 | 1.05458 | 1.06177 | 1.07592 |
| | 0° | C. | 1.01688 | 1.01972 | 1.02603 | 1.02269 | 1.0209 | 1.02982 | 1.02643 | 1.01437 |
| | 25° | C. | 1.31314 | 1.31374 | 1.31716 | 1.31738 | 1.31251 | 1.34929 | 1.34505 | 1.35526 |
| | 200° | C. | 1.37133 | 1.37733 | 1.38533 | 1.40167 | 1.41267 | 1.418 | 1.41329 | 1.38019 |
| | 400° | C. | 1.43733 | 1.44967 | 1.48333 | 1.53767 | 1.59333 | 1.64286 | 1.43933 | 1.53429 |
| | 500° | C. | 1.448 | 1.46467 | 1.489 | 1.53867 | 1.597 | 1.416 | 1.43867 | 1.53867 |
| | 600° | C. | 1.44446 | 1.44512 | 1.44887 | 1.44912 | 1.44376 | 1.48422 | 1.47955 | 1.49078 |

| frequency (Hz) | | | 25.1189 | 31.6228 | 39.8107 | 50.1187 | 63.0957 | 79.4328 | 100 |
|---|---|---|---|---|---|---|---|---|---|
| G′ | −140° | C. | 1.03826 | 1.05018 | 1.03975 | 1.1292 | 1.05884 | 1.1323 | 1.14807 |
| (MPa) | −100° | C. | 1.1815 | 1.19799 | 1.17682 | 1.21443 | 1.15771 | 1.21992 | 1.16393 |
| | −50° | C. | 1.08386 | 1.07207 | 1.06815 | 1.14906 | 1.06482 | 1.17116 | 1.16622 |
| | 0° | C. | 1.0268 | 1.07454 | 1.05543 | 1.13063 | 1.03887 | 1.15307 | 1.1987 |
| | 25° | C. | 1.35771 | 1.38172 | 1.33922 | 1.43467 | 1.41338 | 1.45687 | 1.44807 |
| | 200° | C. | 1.35019 | 1.351 | 1.35033 | 1.34533 | 1.34233 | 1.33 | 1.29367 |
| | 400° | C. | 1.53533 | 1.511 | 1.44033 | 1.39533 | 1.37233 | 1.428 | 1.39367 |
| | 500° | C. | 1.46467 | 1.311 | 1.34033 | 1.29533 | 1.27233 | 1.28 | 1.29367 |
| | 600° | C. | 1.49348 | 1.51989 | 1.47314 | 1.57814 | 1.55471 | 1.60255 | 1.59288 |

TABLE 6

| frequency (Hz) | | | 0.1 | 0.12589 | 0.15849 | 0.19953 | 0.25119 | 0.31623 | 0.39811 | 0.50119 |
|---|---|---|---|---|---|---|---|---|---|---|
| G″ | −140° | C. | 0.32031 | 0.32604 | 0.31733 | 0.31375 | 0.31386 | 0.31399 | 0.32075 | 0.31197 |
| (Mpa) | −100° | C. | 0.26448 | 0.2689 | 0.28024 | 0.26185 | 0.25089 | 0.2575 | 0.24943 | 0.25047 |
| | −50° | C. | 0.27094 | 0.26779 | 0.28308 | 0.2634 | 0.25938 | 0.26815 | 0.2611 | 0.26914 |
| | 0° | C. | 0.20459 | 0.20808 | 0.21801 | 0.2172 | 0.2053 | 0.20848 | 0.21489 | 0.20735 |
| | 25° | C. | 0.40934 | 0.40885 | 0.42038 | 0.43355 | 0.43391 | 0.42366 | 0.4304 | 0.43521 |
| | 200° | C. | 0.58652 | 0.49748 | 0.49266 | 0.46185 | 0.4527 | 0.45926 | 0.44968 | 0.45474 |
| | 400° | C. | 0.5913 | 0.55001 | 0.57156 | 0.57802 | 0.5871 | 0.55708 | 0.57313 | 0.59122 |
| | 500° | C. | 0.59946 | 0.58177 | 0.58567 | 0.58098 | 0.58415 | 0.58452 | 0.59245 | 0.5917 |
| | 600° | C. | 0.66714 | 0.63576 | 0.63567 | 0.5497 | 0.5356 | 0.51589 | 0.48291 | 0.48389 |
| frequency (Hz) | | | 0.63096 | 0.79433 | 1 | 1.25893 | 1.58489 | 1.99526 | 2.51189 | 3.16228 |
| G″ | −140° | C. | 0.3034 | 0.31207 | 0.3169 | 0.30292 | 0.29989 | 0.29051 | 0.28922 | 0.29173 |
| (Mpa) | −100° | C. | 0.24799 | 0.26105 | 0.24868 | 0.25297 | 0.25147 | 0.22133 | 0.22118 | 0.23662 |
| | −50° | C. | 0.26232 | 0.26837 | 0.27572 | 0.24929 | 0.26819 | 0.27123 | 0.27656 | 0.27096 |
| | 0° | C. | 0.20481 | 0.212 | 0.20881 | 0.21379 | 0.20095 | 0.20823 | 0.19927 | 0.19796 |
| | 25° | C. | 0.44105 | 0.43846 | 0.42708 | 0.43208 | 0.43877 | 0.44827 | 0.4543 | 0.4444 |
| | 200° | C. | 0.45008 | 0.45662 | 0.46252 | 0.46673 | 0.46601 | 0.47589 | 0.47297 | 0.47256 |
| | 400° | C. | 0.60414 | 0.62178 | 0.63144 | 0.62585 | 0.63064 | 0.64344 | 0.64728 | 0.65939 |
| | 500° | C. | 0.6001 | 0.60995 | 0.62223 | 0.6363 | 0.65414 | 0.66976 | 0.66196 | 0.63246 |
| | 600° | C. | 0.45271 | 0.4395 | 0.43099 | 0.432 | 0.41008 | 0.40672 | 0.36592 | 0.36681 |
| frequency (Hz) | | | 3.98107 | 5.01187 | 6.30957 | 7.94328 | 10 | 12.5893 | 15.8489 | 19.9526 |
| G″ | −140° | C. | 0.29709 | 0.28248 | 0.25313 | 0.26137 | 0.30694 | 0.2713 | 0.30411 | 0.21283 |
| (Mpa) | −100° | C. | 0.24622 | 0.18906 | 0.23 | 0.20611 | 0.23211 | 0.23577 | 0.2325 | 0.21739 |
| | −50° | C. | 0.28568 | 0.31781 | 0.2461 | 0.22166 | 0.26567 | 0.29702 | 0.25516 | 0.31915 |
| | 0° | C. | 0.21725 | 0.18619 | 0.21128 | 0.23033 | 0.19266 | 0.20309 | 0.20544 | 0.20295 |
| | 25° | C. | 0.47548 | 0.44293 | 0.43146 | 0.43686 | 0.4404 | 0.45689 | 0.45214 | 0.44394 |
| | 200° | C. | 0.47503 | 0.47876 | 0.4821 | 0.48357 | 0.4933 | 0.49063 | 0.51175 | 0.49227 |
| | 400° | C. | 0.6474 | 0.64256 | 0.63895 | 0.68067 | 0.69549 | 0.72367 | 0.65622 | 0.68123 |
| | 500° | C. | 0.61815 | 0.61003 | 0.60602 | 0.61916 | 0.62427 | 0.62264 | 0.65715 | 0.65715 |
| | 600° | C. | 0.33176 | 0.34072 | 0.32956 | 0.30023 | 0.3327 | 0.32642 | 0.35783 | 0.40658 |

| frequency (Hz) | | | 25.1189 | 31.6228 | 39.8107 | 50.1187 | 63.0957 | 79.4328 | 100 |
|---|---|---|---|---|---|---|---|---|---|
| G″ | −140° | C. | 0.29892 | 0.27768 | 0.33245 | 0.36206 | 0.35376 | 0.52289 | 0.61506 |
| (Mpa) | −100° | C. | 0.30282 | 0.21713 | 0.55039 | 0.3999 | 0.30112 | 0.37953 | |
| | −50° | C. | 0.38524 | 0.31369 | 0.28622 | 0.05463 | 0.35163 | −0.3883 | −2.4825 |
| | 0° | C. | 0.27623 | 0.23129 | 0.28954 | 0.32989 | 0.28543 | 0.32429 | 0.27229 |
| | 25° | C. | 0.45024 | 0.46362 | 0.45839 | 0.4977 | 0.4748 | 0.47524 | 0.47166 |
| | 200° | C. | 0.48222 | 0.45623 | 0.46241 | 0.45233 | 0.44023 | 0.46348 | 0.46204 |
| | 400° | C. | 0.69998 | 0.65698 | 0.62582 | 0.60686 | 0.59642 | 0.60275 | 0.58137 |
| | 500° | C. | 0.62311 | 0.45623 | 0.46241 | 0.45233 | 0.44023 | 0.46348 | 0.46204 |
| | 600° | C. | 0.31912 | 0.33806 | 0.60265 | −0.0549 | 0.35328 | −1.0192 | −6.232 |

TABLE 7

| frequency (Hz) | | | 0.1 | 0.12589 | 0.15849 | 0.19953 | 0.25119 | 0.31623 | 0.39811 | 0.50119 |
|---|---|---|---|---|---|---|---|---|---|---|
| Damping | −140° | C. | 0.33096 | 0.33546 | 0.32605 | 0.32121 | 0.32022 | 0.31962 | 0.32508 | 0.31515 |
| Ratio | −100° | C. | 0.2463 | 0.24813 | 0.25571 | 0.24064 | 0.22964 | 0.23467 | 0.22629 | 0.22645 |
| | −50° | C. | 0.27527 | 0.26963 | 0.28452 | 0.26316 | 0.25878 | 0.26666 | 0.25826 | 0.2651 |
| | 0° | C. | 0.21059 | 0.21255 | 0.22073 | 0.21901 | 0.20577 | 0.20813 | 0.21429 | 0.20451 |
| | 25° | C. | 0.32423 | 0.32469 | 0.33594 | 0.33621 | 0.33572 | 0.32757 | 0.33162 | 0.33554 |
| | 200° | C. | 0.5212 | 0.4108 | 0.3972 | 0.365 | 0.3558 | 0.3588 | 0.3476 | 0.3498 |
| | 400° | C. | 0.3715 | 0.37467 | 0.38917 | 0.38758 | 0.38958 | 0.38208 | 0.39408 | 0.41 |
| | 500° | C. | 0.4066 | 0.423 | 0.414 | 0.4102 | 0.4106 | 0.41 | 0.4181 | 0.4162 |
| | 600° | C. | 0.48038 | 0.459 | 0.4618 | 0.38752 | 0.37672 | 0.36262 | 0.33825 | 0.33915 |
| frequency (Hz) | | | 0.63096 | 0.79433 | 1 | 1.25893 | 1.58489 | 1.99526 | 2.51189 | 3.16228 |
| Damping | −140° | C. | 0.3047 | 0.31462 | 0.31788 | 0.30215 | 0.29905 | 0.28823 | 0.28736 | 0.28833 |
| Ratio | −100° | C. | 0.22283 | 0.23497 | 0.2235 | 0.22579 | 0.22413 | 0.19688 | 0.19607 | 0.20831 |
| | −50° | C. | 0.25741 | 0.26281 | 0.26754 | 0.24098 | 0.25689 | 0.2613 | 0.26685 | 0.26046 |
| | 0° | C. | 0.20166 | 0.20755 | 0.20358 | 0.20898 | 0.20078 | 0.20736 | 0.19707 | 0.19488 |
| | 25° | C. | 0.33861 | 0.33616 | 0.32757 | 0.33162 | 0.33554 | 0.34228 | 0.34691 | 0.33937 |
| | 200° | C. | 0.3434 | 0.3468 | 0.3496 | 0.3504 | 0.3482 | 0.354 | 0.3488 | 0.3462 |
| | 400° | C. | 0.41742 | 0.43767 | 0.44667 | 0.45133 | 0.46633 | 0.47533 | 0.46533 | 0.466 |
| | 500° | C. | 0.425 | 0.4332 | 0.4453 | 0.4492 | 0.4462 | 0.4451 | 0.4407 | 0.4429 |
| | 600° | C. | 0.31597 | 0.30632 | 0.30052 | 0.30141 | 0.28509 | 0.28232 | 0.25402 | 0.25465 |
| frequency (Hz) | | | 3.98107 | 5.01187 | 6.30957 | 7.94328 | 10 | 12.5893 | 15.8489 | 19.9526 |
| Damping | −140° | C. | 0.29428 | 0.2777 | 0.24922 | 0.25557 | 0.30153 | 0.2629 | 0.29613 | 0.20579 |
| Ratio | −100° | C. | 0.21598 | 0.1665 | 0.20003 | 0.18034 | 0.1999 | 0.20534 | 0.20127 | 0.18326 |
| | −50° | C. | 0.27106 | 0.30238 | 0.23349 | 0.20933 | 0.25396 | 0.28165 | 0.24032 | 0.29663 |
| | 0° | C. | 0.21365 | 0.18259 | 0.20592 | 0.22522 | 0.18872 | 0.19721 | 0.20016 | 0.20007 |
| | 25° | C. | 0.3621 | 0.33715 | 0.32757 | 0.33162 | 0.33554 | 0.33861 | 0.33616 | 0.32757 |
| | 200° | C. | 0.3464 | 0.3476 | 0.348 | 0.345 | 0.3492 | 0.346 | 0.3621 | 0.35715 |
| | 400° | C. | 0.45042 | 0.44325 | 0.43075 | 0.44267 | 0.4365 | 0.44049 | 0.45592 | 0.444 |
| | 500° | C. | 0.4269 | 0.4165 | 0.407 | 0.4024 | 0.3909 | 0.3853 | 0.3621 | 0.3621 |
| | 600° | C. | 0.22968 | 0.23577 | 0.22746 | 0.20718 | 0.23044 | 0.21993 | 0.24185 | 0.27273 |

| frequency (Hz) | | | 25.1189 | 31.6228 | 39.8107 | 50.1187 | 63.0957 | 79.4328 | 100 |
|---|---|---|---|---|---|---|---|---|---|
| Damping | −140° | C. | 0.28791 | 0.26442 | 0.31974 | 0.32063 | 0.33411 | 0.4618 | 0.53573 |
| Ratio | −100° | C. | 0.2563 | 0.18125 | 0.4677 | 0.32929 | 0.2601 | 0.31111 | 0.5307 |
| | −50° | C. | 0.35543 | 0.2926 | 0.26796 | 0.04755 | 0.33023 | −0.3315 | −2.1286 |
| | 0° | C. | 0.26902 | 0.21525 | 0.27434 | 0.29177 | 0.27475 | 0.28124 | 0.22715 |
| | 25° | C. | 0.33162 | 0.33554 | 0.34228 | 0.34691 | 0.33594 | 0.32621 | 0.32572 |
| | 200° | C. | 0.35715 | 0.348 | 0.345 | 0.3492 | 0.346 | 0.3621 | 0.35715 |
| | 400° | C. | 0.45592 | 0.4348 | 0.4345 | 0.43492 | 0.4346 | 0.4221 | 0.41715 |
| | 500° | C. | 0.35715 | 0.36548 | 0.3545 | 0.3492 | 0.346 | 0.3521 | 0.35715 |
| | 600° | C. | 0.21367 | 0.22243 | 0.40909 | −0.0348 | 0.22723 | −0.636 | −3.9124 |

As a result of a DMA, the storage modulus, loss modulus and damping ratio/tan of the CNT aggregate 100 at a frequency of 0.1 or more and 100 Hz or less were approximately constant the same as silicon rubber at room temperature. The CNT aggregate 100 showed the same frequency stability in a temperature range of −140° C. or more and 600° C. or less.

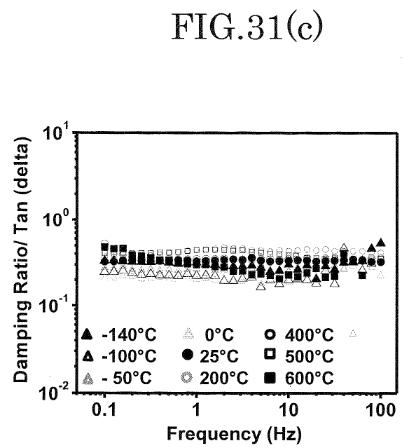

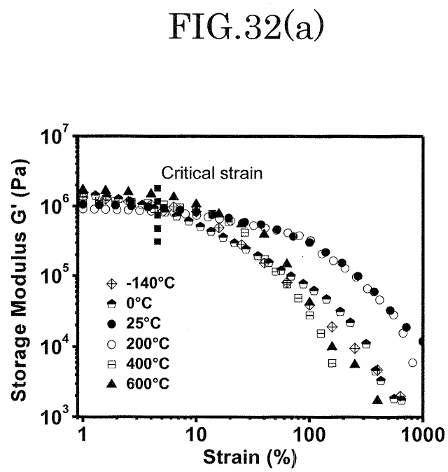

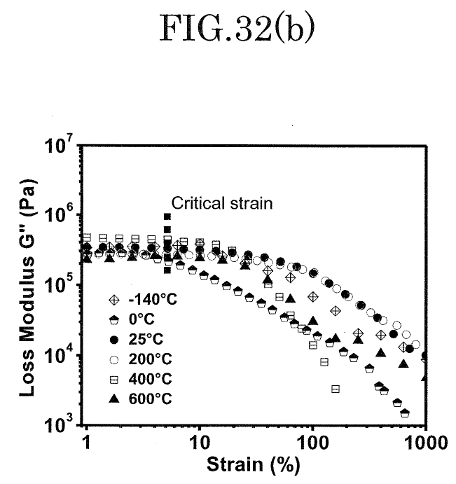

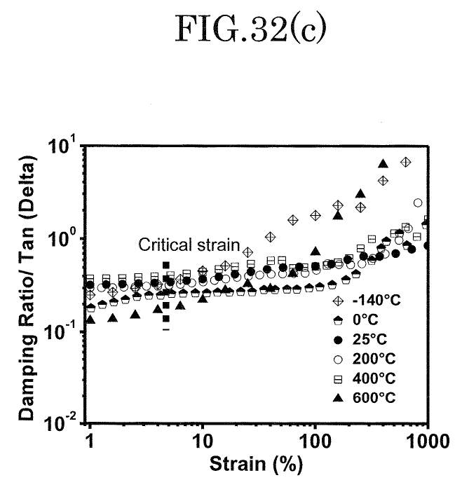

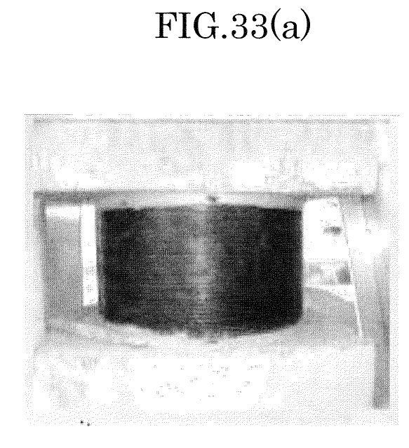

In addition, with respect to viscoelasticity and the relationship between temperature and strain were examined. FIG. 32 shows viscoelasticity of the CNT aggregate 100 at strains of 1% or more and 1000% or less under temperature conditions of −140° C. or more and 600° C. or less, FIG. 32 (a) shows a storage modulus, FIG. 33 (b) shows a loss modulus and FIG. 32 (c) shows a damping ratio. In addition, tables 8 to 10 show a storage modulus, loss modulus and damping ratio at a typical frequency at each temperature.

TABLE 8

| Strain (%) | | | 1 | 1.58723 | 2.51565 | 3.98723 | 6.31938 | 10 | 15.8756 | 25.1623 |
|---|---|---|---|---|---|---|---|---|---|---|
| G′ | −140° | C. | 1.33823 | 1.26495 | 1.16863 | 1.05486 | 0.97824 | 0.83677 | 0.49732 | 0.28124 |
| (MPa) | 0° | C. | 1.49965 | 1.35603 | 1.16685 | 0.93005 | 0.7255 | 0.51405 | 0.36045 | 0.24351 |
| | 25° | C. | 1.05309 | 1.04161 | 1.00451 | 0.93877 | 0.83038 | 0.67991 | 0.59516 | 0.55096 |
| | 200° | C. | 0.9138 | 0.91344 | 0.90228 | 0.88308 | 0.85272 | 0.80868 | 0.7446 | 0.6642 |
| | 400° | C. | 1.22983 | 1.21156 | 1.14822 | 1.10759 | 1.06083 | 0.89535 | 0.77696 | 0.4209 |
| | 600° | C. | 1.70713 | 1.66033 | 1.59378 | 1.48398 | 1.34198 | 1.06767 | 0.77573 | 0.55306 |
| Strain (%) | | | 39.8812 | 63.2096 | 100 | 158.776 | 251.639 | 398.832 | 632.106 | 1000 |
| G′ | −140° | C. | 0.15267 | 0.08036 | 0.03891 | 0.01919 | 0.00963 | 0.00471 | 0.00199 | 0.0007523 |
| (MPa) | 0° | C. | 0.15514 | 0.09807 | 0.0618 | 0.03118 | 0.01106 | 0.00334 | 0.00175 | 0.0005926 |
| | 25° | C. | 0.46665 | 0.3715 | 0.30334 | 0.21883 | 0.09866 | 0.0596 | 0.03254 | 0.01197 |
| | 200° | C. | 0.5748 | 0.49116 | 0.41892 | 0.32424 | 0.1656 | 0.09595 | 0.04594 | 0.00595 |
| | 400° | C. | 0.17481 | 0.07621 | 0.02771 | 0.0059 | −0.0007 | 5E−05 | −0.0001 | −8.743E−05 |
| | 600° | C. | 0.39487 | 0.14708 | 0.042 | 0.00998 | 0.00558 | 0.00172 | 0.0006 | −2.089E−05 |

Note)
Critical strain is 3.98723% and a strain at subsidiary fracture is 100%.

TABLE 9

| Strain (%) | | | 1 | 1.58723 | 2.51565 | 3.98723 | 6.31938 | 10 | 15.8756 | 25.1623 |
|---|---|---|---|---|---|---|---|---|---|---|
| G″ | −140° | C. | 0.3369 | 0.34125 | 0.3481 | 0.34861 | 0.36421 | 0.38161 | 0.25868 | 0.20311 |
| (Mpa) | 0° | C. | 0.2704 | 0.28504 | 0.28179 | 0.23298 | 0.19044 | 0.13648 | 0.0975 | 0.06657 |
| | 25° | C. | 0.33987 | 0.33899 | 0.33612 | 0.32637 | 0.31044 | 0.28557 | 0.26689 | 0.24399 |
| | 200° | C. | 0.27569 | 0.27495 | 0.27366 | 0.27261 | 0.26844 | 0.26573 | 0.26009 | 0.24894 |
| | 400° | C. | 0.46408 | 0.45852 | 0.44857 | 0.44218 | 0.43643 | 0.40161 | 0.37018 | 0.22977 |
| | 600° | C. | 0.22511 | 0.22836 | 0.24008 | 0.25491 | 0.25236 | 0.23778 | 0.22062 | 0.18314 |
| Strain (%) | | | 39.8812 | 63.2096 | 100 | 158.776 | 251.639 | 398.832 | 632.106 | 1000 |
| G″ | −140° | C. | 0.15923 | 0.12766 | 0.0689 | 0.04348 | 0.02083 | 0.01971 | 0.01329 | 0.00883 |
| (Mpa) | 0° | C. | 0.04476 | 0.02857 | 0.01909 | 0.01143 | 0.00655 | 0.00315 | 0.0015 | 0.00112 |
| | 25° | C. | 0.21476 | 0.18133 | 0.14512 | 0.10597 | 0.05177 | 0.03473 | 0.02039 | 0.01014 |
| | 200° | C. | 0.2321 | 0.20727 | 0.17993 | 0.15067 | 0.08909 | 0.05235 | 0.03189 | 0.01443 |
| | 400° | C. | 0.10287 | 0.03744 | 0.0141 | 0.00334 | ####### | 4.97E−05 | ####### | −1.41E−04 |
| | 600° | C. | 0.11665 | 0.06268 | 0.03042 | 0.01724 | 0.01642 | 0.01077 | 0.00744 | 0.00481 |

Note)
Critical strain is 3.98723% and a strain at subsidiary fracture is 100%.

TABLE 10

| Strain (%) | | | 1 | 1.58723 | 2.51565 | 3.98723 | 6.31938 | 10 | 15.8756 | 25.1623 |
|---|---|---|---|---|---|---|---|---|---|---|
| Damping | −140° | C. | 0.25175 | 0.26977 | 0.29787 | 0.33048 | 0.37231 | 0.45605 | 0.52014 | 0.7222 |
| Ratio | 0° | C. | 0.18031 | 0.2102 | 0.2415 | 0.2505 | 0.2625 | 0.2655 | 0.2705 | 0.2734 |
| | 25° | C. | 0.32274 | 0.32545 | 0.33462 | 0.34766 | 0.37385 | 0.42 | 0.44843 | 0.47654 |
| | 200° | C. | 0.3017 | 0.301 | 0.3033 | 0.3087 | 0.3148 | 0.3286 | 0.3493 | 0.3748 |
| | 400° | C. | 0.37735 | 0.37845 | 0.39067 | 0.39922 | 0.41141 | 0.44855 | 0.47645 | 0.54592 |
| | 600° | C. | 0.13186 | 0.13754 | 0.15063 | 0.17177 | 0.18805 | 0.22271 | 0.28441 | 0.33114 |
| Strain (%) | | | 39.8812 | 63.2096 | 100 | 158.776 | 251.639 | 398.832 | 632.106 | 1000 |
| Damping | −140° | C. | 1.04297 | 1.58853 | 1.77081 | 2.26616 | 2.16333 | 4.18443 | 6.68089 | 11.7318 |
| Ratio | 0° | C. | 0.2885 | 0.2913 | 0.3089 | 0.3665 | 0.5924 | 0.9416 | 0.8561 | 1.891 |
| | 25° | C. | 0.49556 | 0.50614 | 0.514 | 0.54042 | 0.65418 | 0.65071 | 0.69891 | 0.8473 |
| | 200° | C. | 0.4038 | 0.422 | 0.4295 | 0.4647 | 0.538 | 0.5456 | 0.6943 | 2.425 |
| | 400° | C. | 0.5885 | 0.4913 | 0.5089 | 0.5665 | 0.7924 | 0.9967 | 1.342 | 1.615 |
| | 600° | C. | 0.29541 | 0.42618 | 0.72429 | 1.72738 | 2.94431 | 6.26522 | 12.4454 | −230.39 |

Note)
Critical strain is 3.98723% and a strain at subsidiary fracture is 100%.

As a result of a DMA, the critical strain of the CNT aggregate 100, that is, the largest strain at which a reversible transformation is possible, was 5% or less the same as silicon rubber at room temperature. In addition, the CNT aggregate 100 maintained a reversible transformation at the same level in a temperature range of −140° C. or more and 600° C. or less. Because silicon rubber becomes brittle between −60° C. to −70° C. (strain resistance properties below 0.3%) and softens at a temperature higher than 350° C., a test in a temperature range of −140° C. or more and 600° C. or less is not performed. In a temperature range of −140° C. or more and 600° C. or less, breaking strain varied between 50% or more and 100% or less. It is predicted that this type of variation is produced when the interval between measurement beds becomes unstable due to a large strain caused by thermal expansion or thermal restriction.

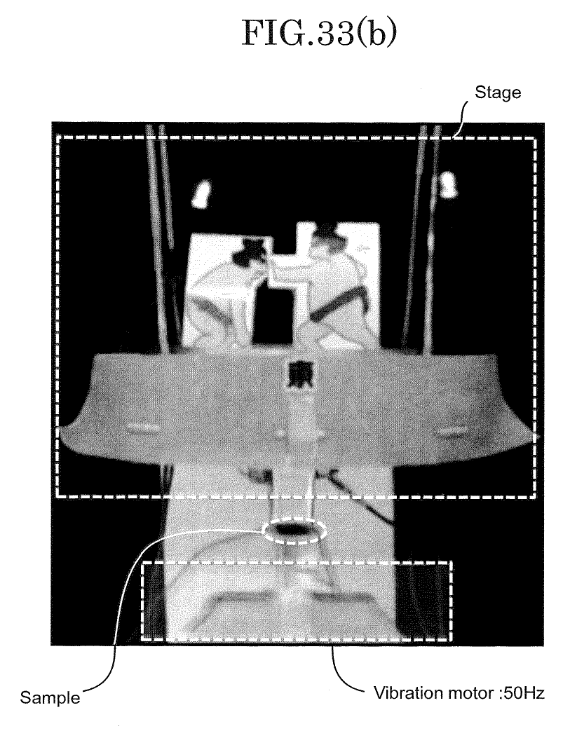

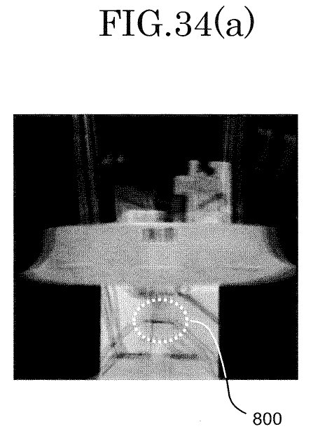

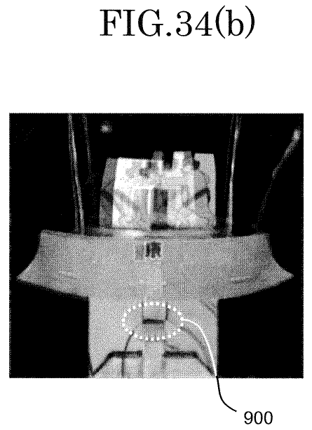

The CNT aggregate 100 was arranged between a vibration motor shown and a sumo ring shown in FIG. 33 (b) as a vibration insulation device as in FIG. 33 (a) in order to show viscoelasticity at higher and lower temperatures. An experiment was performed by producing vibrations at 50 Hz using the vibration motor. The appearance of the vibration test is shown in FIG. 34. FIG. 34 (a) shows the appearance of the vibration insulation device when double sided tape 800 is used. FIG. 34 (b) shows the appearance of the vibration insulation device when the CNT aggregate 100 is used. FIG. 34 (c) shows the appearance of the vibration insulation device when silicon rubber 900 is used. As is shown in FIG. 34 (a) to FIG. 34 (c) the CNT aggregate 100 effectively separated vibration the same as the silicon rubber 900. In addition, the conductivity of the vibration insulation device was evaluated using the emitted light of an LED arranged on the ring, and the CNT aggregate 100 showed conductivity at as constant power, and maintained a stable, mechanical and electrical connection.

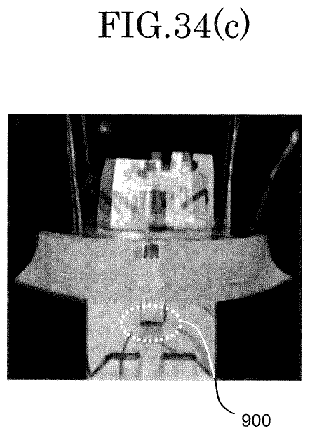

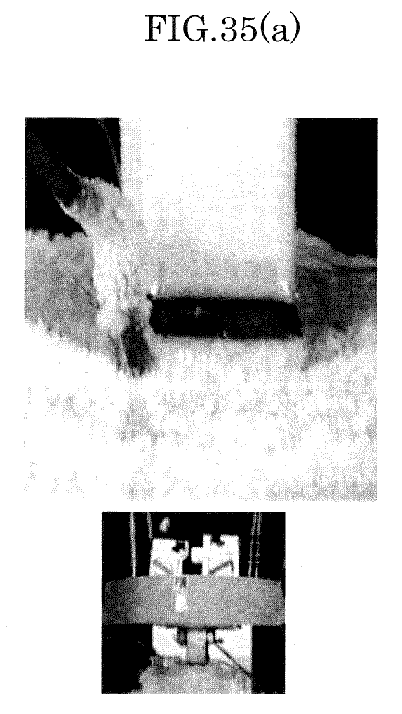

In addition, it was also examined whether the stable viscoelasticity described above was maintained under extreme temperature conditions. FIG. 35 (a) shows experiment results at −190° C., and FIG. 35 (b) shows experiment results at 900° C. As is shown in FIG. 35, the CNT aggregate showed the same stable viscoelasticity even under extreme temperatures by immersing in liquid nitrogen (−190° C.) or burning with a butane torch (900° C.) as at room temperature the same as an observation made at room temperature.

FIG. 29 (b) shows the strain dependency of a CNT aggregate 100 and silicon rubber 900 at room temperature and table 11 shows a storage modulus, loss modulus and damping ratio at a typical strain. As is shown in FIG. 29 (b) and table 11, the strain dependency of viscoelasticity was examined in order to investigate the range of strains of the CNT aggregate 100. The storage modulus of the CNT aggregate 100 was constant showing small variation up to a strain (critical strain) of 5%, the same as the silicon rubber 900.

TABLE 11

| Strain (%) | 0.1 | 0.13919 | 0.19341 | 0.26875 | 0.3734 | 0.51886 | 0.7209 | 1 | 1.392 | 1.93396 |
|---|---|---|---|---|---|---|---|---|---|---|
| G′ (MPa) | 1.0933 | 1.08767 | 1.08105 | 1.07637 | 1.07557 | 1.07118 | 1.06304 | 1.05309 | 1.04161 | 1.02689 |
| G″ (Mpa) | 0.34608 | 0.35252 | 0.34724 | 0.34375 | 0.34229 | 0.34367 | 0.34287 | 0.33987 | 0.33899 | 0.33926 |
| Damping | 0.31655 | 0.3241 | 0.32121 | 0.31936 | 0.31824 | 0.32083 | 0.32254 | 0.32274 | 0.32545 | 0.33037 |
| Strain (%) | 2.68732 | 3.73409 | 5.18851 | 7.20976 | 10 | 13.9217 | 19.3432 | 26.8768 | 37.3418 | 51.9076 |
| G′ (MPa) | 1.00451 | 0.97558 | 0.93877 | 0.89087 | 0.83038 | 0.76026 | 0.67991 | 0.59516 | 0.55096 | 0.46665 |
| G″ (Mpa) | 0.33612 | 0.33132 | 0.32637 | 0.31941 | 0.31044 | 0.30002 | 0.28557 | 0.26689 | 0.24399 | 0.21476 |
| Damping | 0.33462 | 0.33962 | 0.34766 | 0.35854 | 0.37385 | 0.39462 | 0.42 | 0.44843 | 0.47654 | 0.49556 |

| Strain (%) | 72.1393 | 100 | 139.233 | 193.33 | 268.177 | 372.106 | 516.577 | 716.676 | 1000 |
|---|---|---|---|---|---|---|---|---|---|
| G′ (MPa) | 0.3715 | 0.30334 | 0.21883 | 0.15392 | 0.09866 | 0.0596 | 0.03254 | 0.01874 | 0.01197 |
| G″ (Mpa) | 0.18133 | 0.14512 | 0.10597 | 0.07468 | 0.05177 | 0.03473 | 0.02039 | 0.01256 | 0.01014 |
| Damping | 0.50614 | 0.514 | 0.54042 | 0.6038 | 0.65418 | 0.65071 | 0.69891 | 0.7759 | 0.8473 |

Note)
Critical strain is 5.18851% and a strain at subsidiary fracture is 100%.

FIG. 29 (c) shows a fatigue test of the CNT aggregate 100 (1% strain, 20 Hz, 10⁶ cycles), and table 12 shows a storage modulus, loss modulus and damping ratio at a typical test cycle. The storage modulus, loss modulus and damping ratio/tan after 10⁶ cycles stopped at changes within 10% compared to a first cycle.

TABLE 12

| Cycle x | 1 | 100 | 500 | 1000 | 5000 | 10000 | 50000 | 100000 | 500000 | 1000000 |
|---|---|---|---|---|---|---|---|---|---|---|
| G′x (MPa) | 0.94891 | 0.94696 | 0.94696 | 0.94804 | 0.95561 | 0.95907 | 0.97292 | 0.98698 | 1.00969 | ####### |
| G′x/G′1 | 1 | 0.99795 | 0.99795 | 0.99909 | 1.00707 | 1.01071 | 1.0253 | 1.04012 | 1.06405 | 1.09893 |
| G″x (Mpa) | 0.27073 | 0.2703 | 0.27042 | 0.27085 | 0.2719 | 0.27338 | 0.27645 | 0.27712 | 0.28781 | 0.28698 |
| G″x/G′1 | 1 | 0.9984 | 0.99885 | 1.00045 | 1.00432 | 1.0098 | 1.02112 | 1.0236 | 1.06309 | 1.06004 |
| Damping | 0.29387 | 0.294 | 0.29413 | 0.29427 | 0.29307 | 0.2936 | 0.29267 | 0.2892 | 0.2936 | 0.28347 |
| Tanδx/Tanδ1 | 1 | 1.00044 | 1.0009 | 1.00135 | 0.99727 | 0.99908 | 0.99591 | 0.98411 | 0.99908 | 0.9646 |

FIG. 29 (d) is a stress—strain curve of a fatigue test (10^{2th} cycle, 10^{4th} cycle). As is clear from FIG. 29 (c), FIG. 29 (d) and table 12, the same cyclical behavior was proven even after 1,000,000 times at a strain of 1% and means that transformation is reversible under this strain.

### (Measurement of a Critical Strain and Breaking Strain)

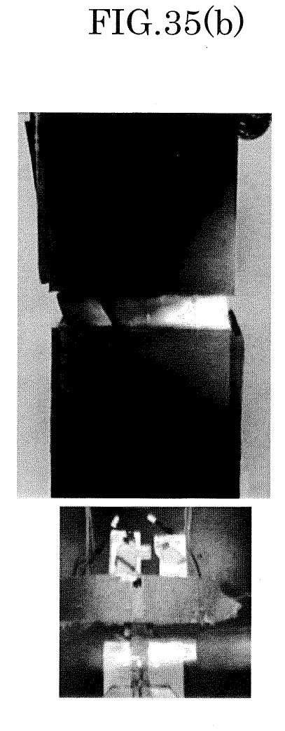

FIG. 36 shows a storage modulus and stress as a function of a strain. As is shown by γ_{c} in FIG. 36, critical strain is defined by the point at which the relationship between stress and strain becomes non-linear. According to the definition, a breaking strain is the intersection of a slope of a constant state (stress—strain region of a line) storage modulus, and is the final region of the storage modulus under a large strain. The breaking strain of the CNT aggregate 100 was inferred to be 100% or less which is lower than silicon rubber (200% or less).

### (A Cyclical Test and Structural Observation Under a Large Strain Vibration)

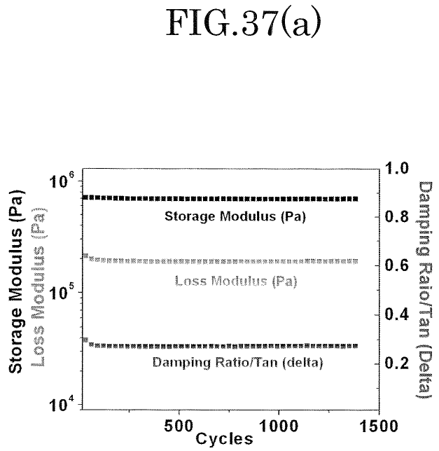

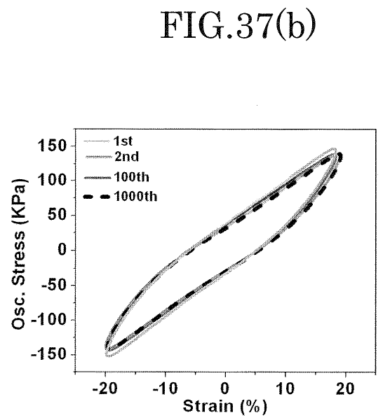

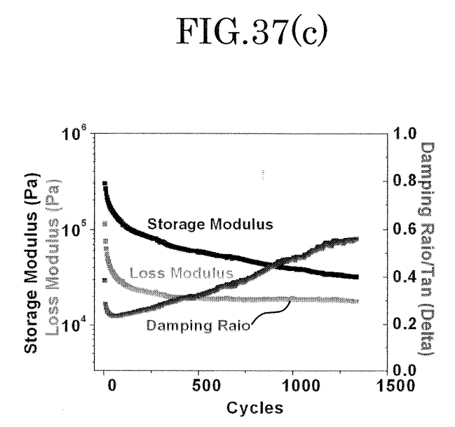

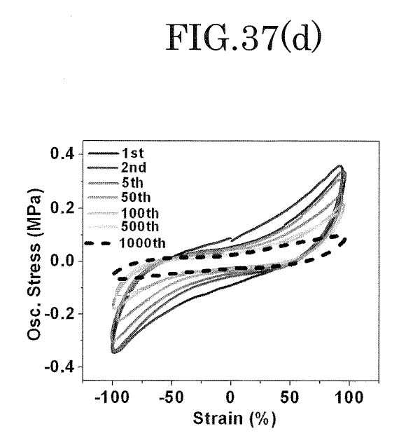

FIG. 37 shows a cyclical test and structural observation under a large strain vibration. FIG. 37 (a) shows viscoelasticity of the CNT aggregate 100 at a strain of 20%, and FIG. 37 (b) shows a stress—strain curve of a the CNT aggregate at different cycles at a strain of 20%. In addition, table 13 shows a storage modulus, loss modulus and damping ratio at a typical test cycle. The storage modulus, loss modulus and damping ratio after 1000 cycles stopped at changes within 10% compared to a first cycle.

TABLE 13

| Cycle x | 1 | 10 | 50 | 100 | 500 | 1000 |
|---|---|---|---|---|---|---|
| G′x (MPa) | 0.71415 | 0.7128 | 0.71037 | 0.70605 | 0.69444 | 0.6939 |
| G′x/G′1 | 1 | 0.99811 | 0.99471 | 0.98866 | 0.9724 | 0.97127 |
| G″x (Mpa) | 0.21192 | 0.19878 | 0.19401 | 0.19272 | 0.18858 | 0.18927 |
| G″x/G′1 | 1 | 0.938 | 0.91549 | 0.9094 | 0.88986 | 0.89312 |
| Damping Ratio | 0.29674 | 0.27887 | 0.27311 | 0.27296 | 0.27156 | 0.27287 |
| Tanδx/Tanδ1 | 1 | 0.93979 | 0.92037 | 0.91985 | 0.91513 | 0.91956 |

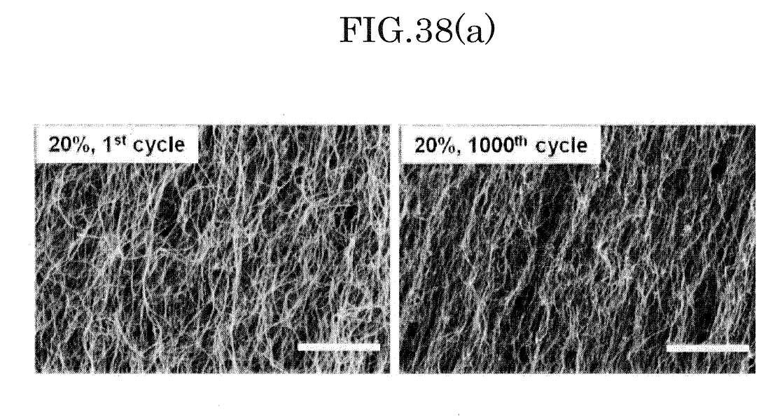

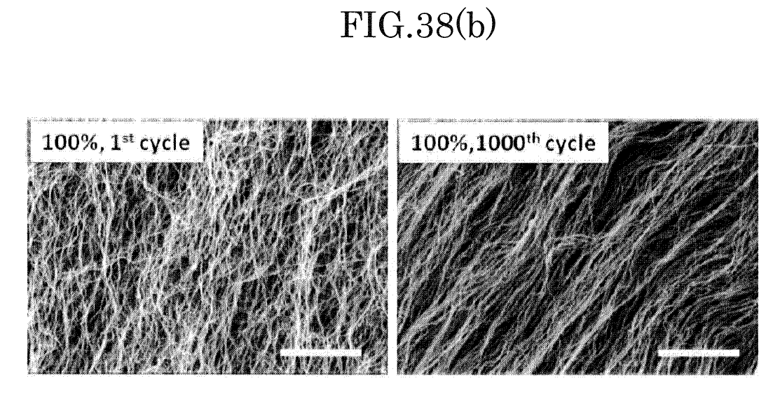

FIG. 37 (c) shows viscoelasticity of the CNT aggregate 100 at a strain of 100%, and FIG. 37 (d) shows a stress—strain curve of a the CNT aggregate at different cycles at a strain of 100%. Table 14 shows a storage modulus, loss modulus and damping ratio/tan at a typical test cycle. In addition, FIG. 38 (a) is a SEM image of the CNT aggregate 100 at a first cycle and 1000^{th} cycle under 20% of strain. FIG. 38 (b) is a SEM image of the CNT aggregate 100 at a first cycle and 1000^{th} cycle under 100% of strain.

TABLE 14

| Cycle x | 1 | 10 | 50 | 100 | 500 | 1000 |
|---|---|---|---|---|---|---|
| G′x (MPa) | 0.2976 | 0.23462 | 0.14536 | 0.11305 | 0.05924 | 0.03931 |
| G′x/G′1 | 1 | 0.78838 | 0.50023 | 0.37988 | 0.19905 | 0.1321 |
| G″x (Mpa) | 0.11446 | 0.06316 | 0.035 | 0.02761 | 0.01929 | 0.01892 |
| G″x/G′1 | 1 | 0.55181 | 0.30577 | 0.24118 | 0.16852 | 0.16529 |
| Damping Ratio | 0.3846 | 0.2692 | 0.2351 | 0.2393 | 0.32286 | 0.48102 |
| Tanδx/Tanδ1 | 1 | 0.69995 | 0.61128 | 0.6222 | 0.83948 | 1.25069 |

As is clear from FIG. 37 (a) to FIG. 37 (d) and table 13 and table 14, the CNT aggregate 100 showed relatively stable behavior in a test of 1000 cycles at 20% strain. However, the mechanical properties of the CNT aggregate 100 were clearly damaged in a test of 1000 cycles at 100% strain. The storage modulus, loss modulus and damping ratio after 1000 cycles at a strain of 20% stopped at changes within 10% compared to a first cycle. However, the storage modulus, loss modulus and damping ratio/tan after 1000 cycles at a strain of 1000% changed significantly in proportion to a first cycle. In addition, as is shown in FIG. 38 (a), the structure of the CNT aggregate 100 after 1000 cycles at a strain of 20% hardly changed compared to the first cycle. However, as is shown in FIG. 38 (b), a random network of the CNT aggregate 100 after 1000 cycles at a strain of 100% broke, the structure was highly orientated and hardly any contact regions were observed. This, it can be concluded, is a model whereby a contact region is an important factor to the mechanical properties of the CNT aggregate 100. In addition, this property decreased as orientation increased due to a decrease in [attachable and detachable] contact regions.

### (Fatigue Durability)

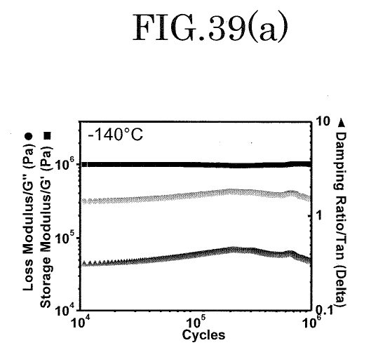

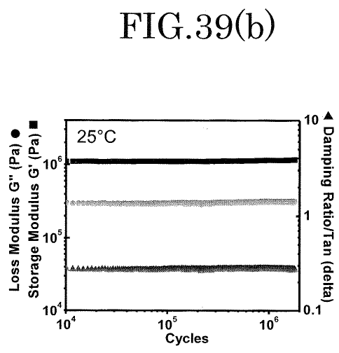

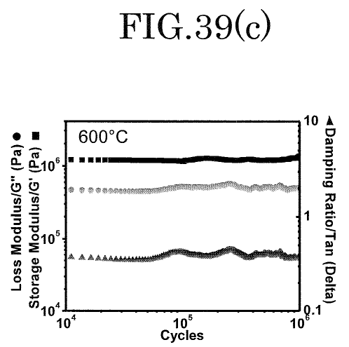

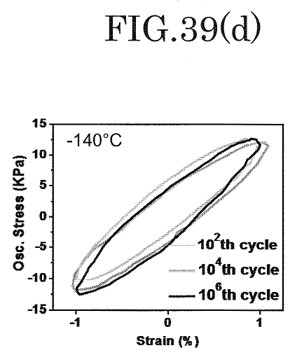

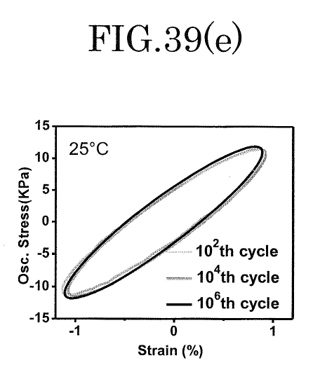

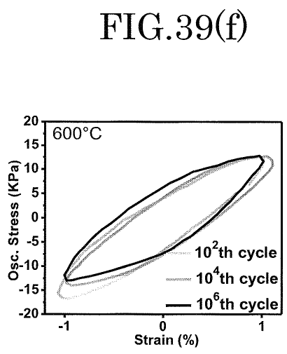

In addition, the fatigue durability of the CNT aggregate 100 in a temperature range of −140° C. or more and 600° C. or less was examined. FIG. 39 shows the results of repeated test at a strain of 1%, 100 Hz and 10⁶ cycles, FIG. 39 (a) shows the results at −140° C. FIG. 39 (b) shows the results at 25° C. and FIG. 39 (c) shows the results at 600° C. In addition, FIG. 39 (d) shows a stress-strain curve of a fatigue durability test at the 10²th cycle, 10^{4th} cycle and 10^{6th} cycle at −140° C. FIG. 39 (e) shows a stress-strain curve of a fatigue durability test at the 10²th cycle, 10^{4th} cycle and 10^{6th} cycle at 25° C. FIG. 39 (f) shows a stress-strain curve of a fatigue durability test at the 10²th cycle, 10^{4th} cycle and 10^{6th} cycle at 600° C. Tables 15 to 17 show a storage modulus, loss modulus and damping ratio at a typical test cycle.

TABLE 15

| Cycle x | | 100 | 1000 | 5000 | 10000 | 50000 | 100000 | 500000 | 1000000 |
|---|---|---|---|---|---|---|---|---|---|
| −140° C. | G′x | 0.99857 | 0.99296 | 0.98068 | 1.03032 | 0.95239 | 0.94986 | 0.96143 | 1.00998 |
| | G′x/G′1 | 1 | 0.99438 | 0.98209 | 1.03181 | 0.95376 | 0.95122 | 0.96281 | 1.01143 |
| 25° C. | G′x | 1.09791 | 1.09217 | 1.09447 | 1.09306 | 1.0955 | 1.0967 | 1.12069 | 1.1427 |
| | G′x/G′1 | 1 | 0.99477 | 0.99687 | 0.99558 | 0.99781 | 0.9989 | 1.02075 | 1.0408 |
| 600° C. | G′x | 1.28307 | 1.22124 | 1.1385 | 1.18746 | 1.16355 | 1.16281 | 1.23295 | 1.36525 |
| | G′x/G′1 | 1 | 0.95181 | 0.88732 | 0.92604 | 0.90685 | 0.90627 | 0.96094 | 1.06405 |

TABLE 16

| Cycle x | | 1 | 100 | 1000 | 5000 | 10000 | 50000 | 100000 | 500000 | 1000000 |
|---|---|---|---|---|---|---|---|---|---|---|
| −140° C. | G″x | 0.33731 | 0.33731 | 0.32896 | 0.31256 | 0.35678 | 0.30413 | 0.4392 | 0.35336 | 0.27884 |
| | G″x/G′1 | 1 | 1 | 0.97524 | 0.92661 | 1.05771 | 0.90163 | 1.30204 | 1.04757 | 0.82665 |
| 25° C. | G″x | 0.30446 | 0.30446 | 0.30314 | 0.30107 | 0.30055 | 0.29828 | 0.29813 | 0.30925 | 0.31531 |
| | G″x/G′1 | 1 | 1 | 0.99568 | 0.98889 | 0.98718 | 0.97972 | 0.97923 | 1.01574 | 1.03564 |
| 600° C. | G″x | 0.47582 | 0.47582 | 0.49004 | 0.41938 | 0.47944 | 0.40319 | 0.49401 | 0.48933 | 0.50163 |
| | G″x/G′1 | 1 | 1 | 1.02989 | 0.88139 | 1.0076 | 0.84736 | 1.03823 | 1.0284 | 1.05425 |

TABLE 17

| Cycle x | | 1 | 100 | 1000 | 5000 | 10000 | 50000 | 100000 | 500000 | 1000000 |
|---|---|---|---|---|---|---|---|---|---|---|
| −140° C. | Damping | 0.3378 | 0.3378 | 0.33129 | 0.31871 | 0.34628 | 0.31933 | 0.46238 | 0.36754 | 0.27609 |
| | Tanδx/Tanδ1 | 1 | 1 | 0.98074 | 0.9435 | 1.02509 | 0.94533 | 1.36879 | 1.08803 | 0.81731 |
| 25° C. | Damping | 0.27731 | 0.27731 | 0.27756 | 0.27509 | 0.27477 | 0.27228 | 0.27185 | 0.27595 | 0.27593 |
| | Tanδx/Tanδ1 | 1 | 1 | 1.0009 | 0.99198 | 0.99084 | 0.98186 | 0.98029 | 0.99508 | 0.99503 |
| 600° C. | Damping | 0.3523 | 0.3523 | 0.3812 | 0.34995 | 0.38356 | 0.32919 | 0.4036 | 0.37704 | 0.34906 |
| | Tanδx/Tanδ1 | 1 | 1 | 1.08204 | 0.99332 | 1.08874 | 0.93441 | 1.14561 | 1.07022 | 0.9908 |

The result of a fatigue durability test, as is shown in FIG. 39 (b) and FIG. 39 (e), showed that the CNT aggregate 100 has excellent fatigue durability at 25° C., and an approximately constant viscoelasticity and stress—strain curve even after 10⁶ cycles under a strain of 1%. In addition, as is shown in FIG. 39 (d) and FIG. 39 (f), the CNT aggregate 100 showed the same viscoelasticity and cycle properties even at −140° C. and 600° C., and the same fatigue durability was confirmed. Because fatigue durability in a currently existing viscoelastic material decreases due to internal heat at high temperatures and a loss of elasticity at low temperatures, the results of the CNT aggregate 100 were unanticipated. From these results, it is suggested that the viscoelastic properties of the CNT aggregate 100 are temperature invariant and includes a different mechanism in the above described temperature range.

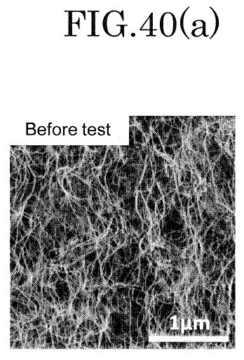

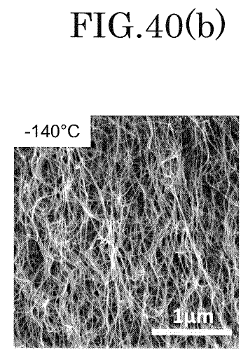

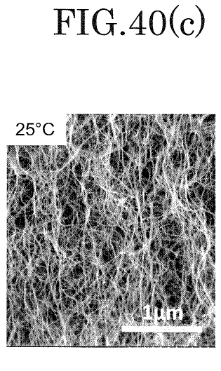

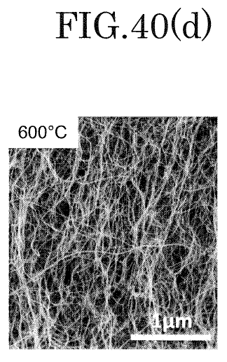

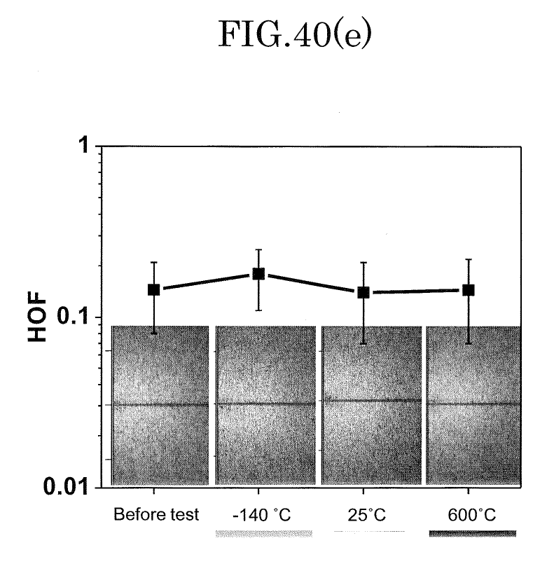

Furthermore, the microstructure of the CNT aggregate 100 before the fatigue durability test described above and after 10⁶ cycles was compared. FIG. 40 (a) shows the observation results of the microstructure of the CNT aggregate 100 using SEM images before the fatigue durability test and FIG. 40 (b) to FIG. 40 (d) show the results after 10⁶ cycles. FIG. 40 (b), FIG. 40 (c) and FIG. 40 (d) show the results at −140° C., 25° C. and 600° C. respectively. FIG. 40 (e) shows a calculation value of a Herman orientation coefficient before the fatigue durability test described above and after 10⁶ cycles. The inset image shows a 2-D Fast Fourier Transform.

As is clear from FIG. 40 (a) to FIG. 40 (e), the microstructure of the CNT aggregate 100 was invariant even after a long fatigue durability test and stability of mechanical behavior was maintained even under extreme temperature conditions. Here, the Herman orientation coefficient of the CNT aggregate 100 at each temperature before the fatigue durability test and after 10⁶ cycles were 0.15 before the test, 0.18 after the test at −140° C., 0.14 after the test at 25° C. and 0.14 after the test at 600° C.

The CNT aggregate 100 related to the present example of the present invention is constant and has no storage modulus and loss modulus temperature dependency at a wide range of temperatures and the damping ratio is also constant. The CNT aggregate 100 related to the present example of the present invention shows stable viscoelasticity without temperature dependency even at extreme temperatures and excellent shock absorbance.

### (Inference of a Loss Modulus)

Next, a loss modulus is inferred in order to refer to the validity of an energy dissipation model via opening and closing of a contact region. The loss modulus (G″) of a contact region is calculated by multiplying the energy per contact region for opening by the total of the all the contact regions and multiplying a configuration factor <cos θ> in order to explain a fraction orientated perpendicularly in a strain direction.

$${G}^{″} = \frac{{E}_{Dissipated}}{γγ ( \frac{2 π}{ω} )} \approx \frac{1}{γγ ( \frac{2 π}{ω} )} \cdot ( {\sum }^{N} {\int }_{ }^{l} {E}_{vdW} d l ) \cdot 〈 cos θ 〉$$

Van der Waals' adsorption energy per unit length for opening 2 CNTs, E_{vdW}, density of a contact region, N, length of a contact region, I=150 nm (obtained via a TEM) and shear strain and proportion are each γ and γ(·), angular frequency of a strain, ω, and an angle between a contact region and a perpendicular direction to a strain, θ. Van der Waals' adsorption energy, E_{vdW} is inferred to be 0.36 nJ/m as a value calculated from the combined energy two parallel cylinders which receive a Lennard-Jones potential. The density (4.5×10¹⁵/cm³) of a CNT contact region is inferred by applying a contact region density (2.12×10⁴/CNT) per CNT inferred from a concentration frequency (1/300 nm) obtained via a TEM image by a CNT density (4.24×10¹⁰/cm²) inferred from a CNT bulk density (0.009 g/cm³) and each CNT density (1.5×10¹³/cm³). Using these values, the calculated G″ was 0.51 MPa which closely matched an experimental value (0.3 MPa) which shows the energy dissipation produced from the open Van der Waals' mutual interactions at a contact region. This mechanism for dissipating energy is different to rubber which dissipates energy via molecular movement.

### (Measurement of an Attachable, Detachable Contact Region)

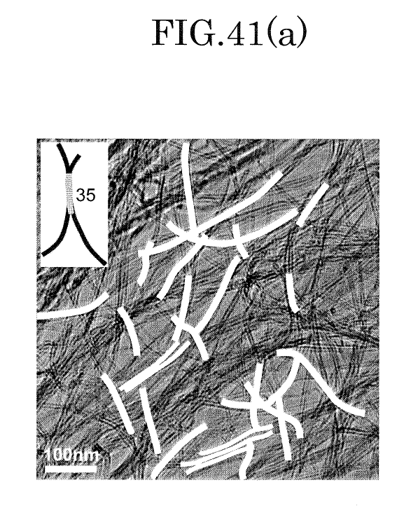

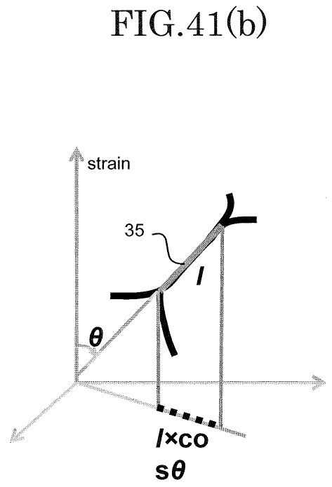

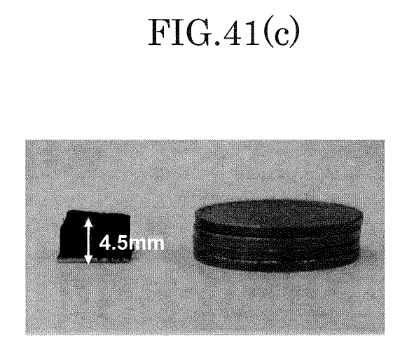

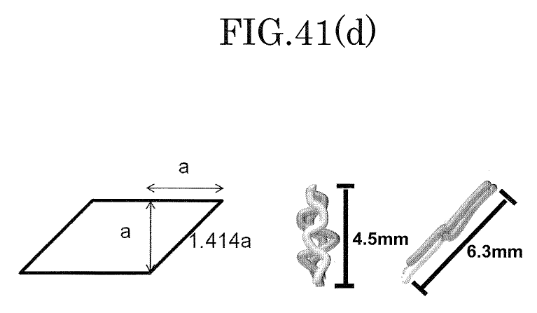

As described above, FIG. 41 measured a contact region from a TEM observation of a structure. FIG. 41 (a) is a TEM image of the CNT aggregate 100 which shows a contact region marked in white. FIG. 41 (b) is an exemplary diagram showing an orientation relationship between a contact region and strain. FIG. 41 (c) is a photograph of a CNT aggregate in a grown state. FIG. 41 (d) is an exemplary diagram of each CNT structure.

A TEM observation shows a contact region which is the structure between CNTs where each CNT contacts with many other CNTs the same as a three dimensional highway and where unlimited parallel contacts are formed. These contact regions are similar to the fixed cross links of rubber. However, they are attachable and detachable by opening and closing. As is shown in FIG. 41 (a), the average length of an attachable, detachable contact region experimentally measured to be isolated at 150 nm or less. Attachable, detachable contact region are randomly distributed in three dimensional space as is shown by the relationship between strain and orientation (FIG. 41 (b)).

As is shown in FIG. 41 (c), a CNT sample in a grown state was 4.5 nm and was strained to 100%. The CNT density is estimated by the following formula:

$${N}_{tube} = \frac{ρ}{α λ} = \frac{0.009 g \text{/} {cm}^{3}}{1.414 \times 1.5 \times {10}^{- 13} g \text{/} cm} = 4.24 \times {10}^{10} \text{/} {cm}^{2}$$

Here, the mass density of the CNT aggregate is ρ and mass per CNT length is λ. As is shown in FIG. 41 (d), α=1.141 was used in order to show a curve factor determined by the limitation of a strain considering a pass which forms a CNT curve. Each CNT is estimated to be 6.36 nm or less and the number of attachable, detachable contact regions per CNT is estimated by the following formula;

$${N}_{node / tube} = \frac{{l}_{tube}}{{l}_{node} + {l}_{strut}} = \frac{6.36 mm}{150 nm + 150 nm} \approx 2.12 \times {10}^{4} \text{/} tube$$

In this way, the density of contact regions is estimated by the following formula (contact region is comprised of a combination of CNTs);

$${N}_{node} = \frac{{N}_{node / tube} \times {N}_{tube}}{2} \approx 4.5 \times {10}^{15} \text{/} {cm}^{3}$$

(Dissipation of Energy from an Attachable, Detachable Contact Region)

In order to calculate a loss modulus, first a loss modulus is defined. In a loss modulus, total dissipation energy is seen as the sum of the same contact region and by estimating that elements having angles can be separated it is possible to reach an estimation (Formula (I) of the loss modulus below. Therefore, this formula is comprised from 3 elements. A prefactor shows the experiment conditions such as strain amplitude γ, strain rate γ(·) and angular frequency ω (FIG. 29 (b) obtained from the experiment conditions in which the loss modulus is acknowledged to be constant). The integration of 2 parts shows the total energy loss of the CNT aggregate 100 from an open process which assumes a contact region in each direction related to energy dissipation. Because only a contact region orientated perpendicularly to a strain direction participates in energy dissipation, a simple configuration factor <cos θ> is introduced in order to explain an average orientation perpendicular to a strain direction.

$${G}^{″} = \frac{{E}_{Dissipated}}{γγ ( \frac{2 π}{ω} )} \approx \frac{1}{γγ ( \frac{2 π}{ω} )} \cdot ( {\sum }^{N} {\int }_{ }^{l} {E}_{vdW} d l ) \cdot 〈 cos θ 〉 \qquad ( 1 )$$

Here, an angle between a contact region and a direction perpendicular to a strain is θ in

$$〈 cos θ 〉 = \frac{{\int }_{0}^{π / 2} cos θsin θ d θ}{{\int }_{0}^{π / 2} sin θ d θ}$$

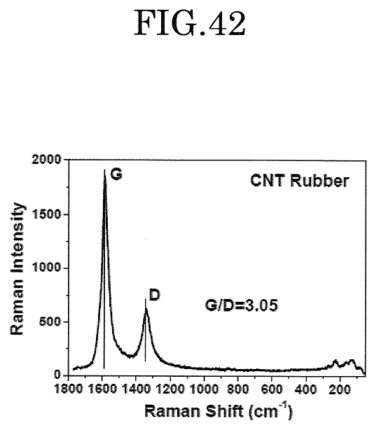

A Raman spectrum of a CNT aggregate is shown in FIG. 42. A Raman spectrum is measured using a 32 nm excitation wavelength. CNT linearity (crystallization) can be evaluated by a G/D ratio of the Raman spectrum.

A sharp G band peak is observed in the vicinity of a 1590 Kaiser and using this it is clear that a graphite crystal structure exists in the CNTs that form the CNT aggregate of the present invention. In addition, a D band peak derived from a defect structure is observed in the vicinity of a 1340 Kaiser.

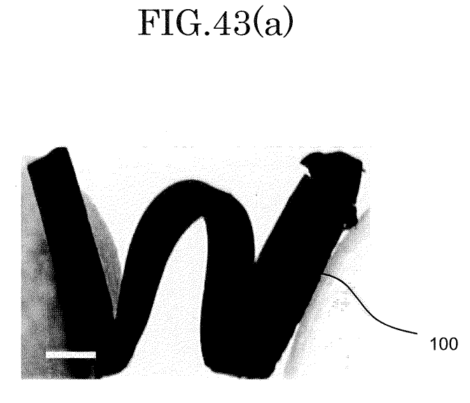

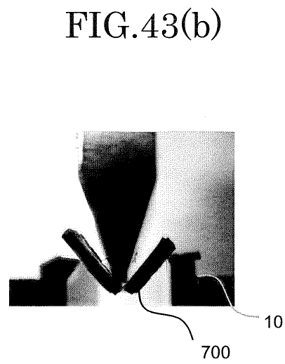

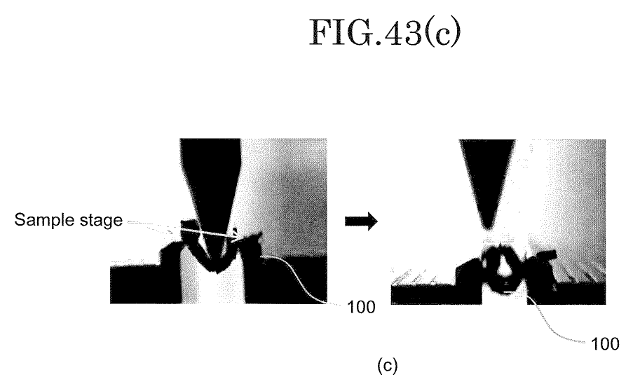

The stress, strain behavior of the CNT aggregate 100 related to the present example of the present invention is shown in FIG. 43 (a) and FIG. 43 (c). The CNT aggregate 100 could withstand three times the strain without breaking. However, a highly orientated CNT orientated aggregate 700 broke when a similar strain was added (FIG. 43 (b)).

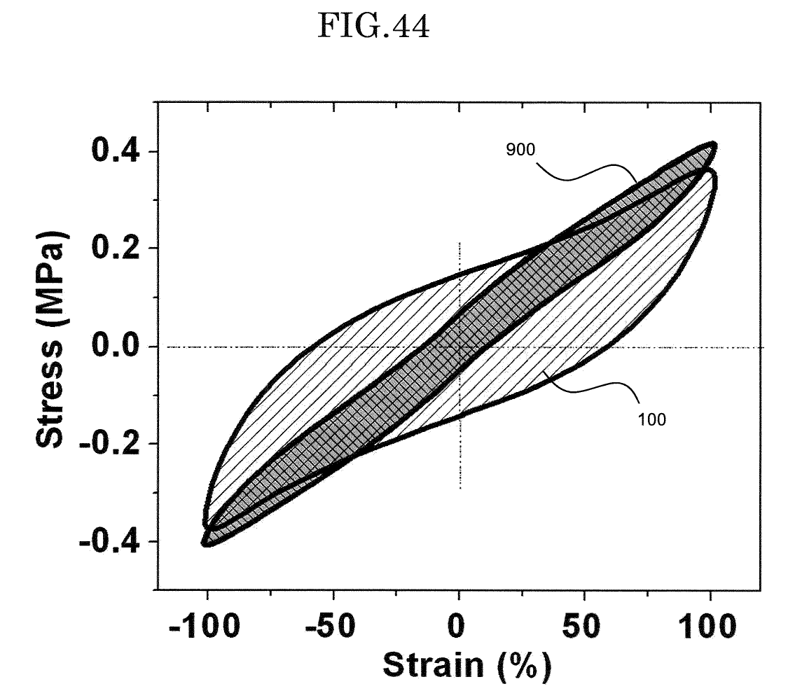

As is shown in FIG. 44, a high level of non-linearity and a closed hysteresis up to 100% strain is shown without a typical sudden change in the stress, strain behavior from a quantitative dynamic mechanical analysis (DMA), for example, viscoelasticity, energy dissipation and a changeable material such as silicon rubber. A large enclosed region of a hysteresis loop of the CNT aggregate 100 means that the CNT aggregate includes higher energy dissipation capabilities than silicon rubber.

The present invention provides a viscoelastic material which includes a CNT aggregate having the same properties of rubber or an elastomer. In addition, the present invention provides a CNT aggregate including a CNT aggregate showing similar properties as room temperatures even at higher and/or lower temperatures and excellent shock adsorption compared to a conventional silicon rubber or rubber containing CNTs.

1. A CNT aggregate formed from a plurality of CNT's, the CNT aggregate comprising:
(1) a storage modulus (G_{25° C.}′) at 25° C. obtained by a dynamic mechanical analysis in a 1 Hz frequency in shear-mode of 10⁴ Pa or more and 10⁹ Pa or less;
(2) a loss modulus (G_{25°}″) at 25° C. obtained by a dynamic mechanical analysis in a 1 Hz frequency in shear-mode of 10³ Pa or more and 10⁸ Pa or less;
(3) a damping ratio (tan δ(=G_{25° C.}″/G_{25° C.}′) at 25° C. obtained by a dynamic mechanical analysis in a 1 Hz frequency in shear-mode of 10⁻³ or more and 1 or less; and
(4) a distribution maximum of a pore diameter calculated using a BJH method from an adsorption isotherm of liquid nitrogen of the CNT aggregate being 50 nm or less.

2. The CNT aggregate according to claim 1, wherein a Herman orientation coefficient under a 100% shearing strain increases by 20% or more compared to a Herman orientation coefficient when no shearing strain is added.

3. The CNT aggregate according to claim 1, further comprising a strain having a roughly constant HOF in a shear strain region of 50% or more and 500% or less.

4. The CNT aggregate according to claim 1, further comprising a part having a Herman orientation coefficient of 0.01 or more and 0.4 or less.

5. A CNT aggregate formed by stacking a plurality of the CNT aggregates according to claim 1.

6. A layered product comprising the CNT aggregate according to claim 1.

7. The layered product according to claim 6 formed by arranging the CNT aggregate on a substrate.

8. The layered product according to claim 6 formed by arranging the CNT aggregate on and below a substrate.

9. A CNT aggregate formed from a plurality of CNT's, the CNT aggregate comprising;
a pore diameter calculated using a BJH method from an adsorption isotherm of liquid nitrogen with a distribution maximum of 50 nm or less;
the CNT aggregate including a storage modulus (G_{x° C.}′) existing in a temperature range of 100° C. or more and 1000° C. or less arranged with a ratio (G_{x° C.}′/G_{25° C.}′) of 0.75 or more and 1.5 or less between a storage modulus (G_{25° C.}′) at 25° C. obtained by a dynamic mechanical analysis in a 1 Hz frequency in shear-mode and a storage modulus (G_{x° C.}′) in a temperature range of 100° C. or more and 1000° C. or less; and
a loss modulus (G_{x° C.}″) existing in a temperature range of 100° C. or more and 1000° C. or less arranged with a ratio (G_{x° C.}″/G_{25° C.}″) of 0.75 or more and 1.5 or less between a loss modulus (G_{25° C.}″) at 25° C. obtained by a dynamic mechanical analysis in a 1 Hz frequency in shear-mode and a loss modulus (G_{x° C.}″) in a temperature range of 100° C. or more and 1000° C. or less.

10. The CNT aggregate according to claim 9, wherein the ratio (G_{x° C.}′/G_{25° C.}′) and the ratio (G_{x° C.}″/G_{25° C.}″) are 0.8 or more and 1.2 or less.

11. The CNT aggregate according to claim 9, wherein the ratio (G_{x° C.}′/G_{25° C.}′) and the ratio (G_{x° C.}″/G_{25° C.}″) are 0.85 or more and 1.1 or less.

12. The CNT aggregate according to claim 9, wherein the storage modulus (G_{25° C.}′) at 25° C. obtained by a dynamic mechanical analysis in a 1 Hz frequency in shear-mode are 10⁴ Pa or more and 10⁹ Pa or less.

13. The CNT aggregate according to claim 9, wherein the loss modulus (G_{25° C.}″) at 25° C. obtained by a dynamic mechanical analysis in a 1 Hz frequency in shear-mode are 10³ Pa or more and 10⁸ Pa or less.

14. The CNT aggregate according to claim 9, further comprising a part having a Herman orientation coefficient of 0.01 or more and 0.4 or less.

15. A CNT aggregate formed by stacking a plurality of the CNT aggregates according to claim 9.

16. A layered product comprising the CNT aggregate according to claim 9.

17. The layered product according to claim 16 formed by arranging the CNT aggregate on a substrate.

18. The layered product according to claim 16 formed by arranging the CNT aggregate on and below a substrate.

19. A CNT aggregate formed from a plurality of CNT's, the CNT aggregate comprising;
a pore diameter calculated using a BJH method from an adsorption isotherm of liquid nitrogen with a distribution maximum of 50 nm or less;
the CNT aggregate including a storage modulus (G_{x° C.}′) existing in a temperature range of −200° C. to 0° C. arranged with a ratio (G_{x° C.}′/G_{25° C.}′); 0.75 to 1.5 between a storage modulus (G_{25° C.}′) at 25° C. obtained by a dynamic mechanical analysis in a 1 Hz frequency in shear-mode and a storage modulus (G_{x° C.}′) in a temperature range of −200° C. to 0° C.; and
a loss modulus (G_{x° C.}″) existing in a temperature range of −200° C. to 0° C. arranged with a ratio (G_{x° C.}″/G_{25° C.}″); 0.75 to 1.5 between a loss modulus (G_{25° C.}″) at 25° C. obtained by a dynamic mechanical analysis in a 1 Hz frequency in shear-mode and a loss modulus (G_{x° C.}″) in a temperature range of −200° C. to 0° C.

20. The CNT aggregate according to claim 19, wherein the ratio (G_{x° C.}′/G_{25° C.}″) and the ratio (G_{x° C.}″/G_{25° C.}″) are 0.8 or more and 1.2 or less.

21. The CNT aggregate according to claim 19, wherein the ratio (G_{x° C.}′/G_{25° C.}′) and the ratio (G_{x° C.}″/G_{25° C.}″) are 0.85 or more and 1.1 or less.

22. The CNT aggregate according to claim 19, wherein the storage modulus (G_{25° C.}′) at 25° C. obtained by a dynamic mechanical analysis in a 1 Hz frequency in shear-mode are 10⁴ Pa or more and 10⁹ Pa or less.

23. The CNT aggregate according to claim 19, wherein the loss modulus (G_{25° C.}″) at 25° C. obtained by a dynamic mechanical analysis in a 1 Hz frequency in shear-mode are 10³ Pa or more and 10⁸ Pa or less.

24. The CNT aggregate according to claim 19, further comprising a part having a Herman orientation coefficient of 0.01 or more and 0.4 or less.

25. A CNT aggregate formed by stacking a plurality of the CNT aggregates according to claim 19.

26. A layered product comprising the CNT aggregate according to claim 19.

27. The layered product according to claim 26 formed by arranging the CNT aggregate on a substrate.

28. The layered product according to claim 26 formed by arranging the CNT aggregate on and below a substrate.
